(19) United States
(12) Patent Application Publication
(10) Pub. No.: US 2023/0261331 A1
(43) Pub. Date: Aug. 17, 2023

(54) A BATTERY MODULE AND A VEHICLE

(71) Applicant: ARRIVAL LTD., London (GB)

(72) Inventors: Douglas MORTON, London (GB); Murray SCHOFIELD, London (GB)

(21) Appl. No.: 18/014,206

(22) PCT Filed: Jul. 2, 2021
(86) PCT No.: PCT/GB2021/051687

§ 371 Date: Jan. 3, 2023

(30) Foreign Application Priority Data
Jul. 2, 2020 (GB) 2010194.5
Aug. 19, 2020 (GB) 2012958.1
Mar. 9, 2021 (GB) 2103252.9
Jun. 16, 2021 (WO) PCT/GB2021/051519

(51) Int. Cl. H01M 50/519; H01M 50/213; H01M 50/271; H01M 50/249; H01M 50/258; H01M 50/51; H01M 10/42; B60L 50/64; B60L 58/21; H01M 50/358; H01M 10/613; H01M 10/625

(52) U.S. Cl. CPC H01M 50/519; H01M 50/213; H01M 50/271; H01M 50/249; H01M 50/258; H01M 50/51; H01M 10/425; B60L 50/64; B60L 58/21; H01M 50/358; H01M 10/613; H01M 10/625; H01M 2220/20; H01M 2010/4271

(57) ABSTRACT

A battery module is provided for a vehicle that can operate as part of a battery pack that includes a number of battery modules. The vehicle has a chassis in which the battery pack is installed. During use, the battery module delivers power to the vehicle over a substantially low profile, printed circuit board (PCB) flexible electrical conductor. Thus, it is possible to install the battery module in the chassis of a vehicle having a floor that is substantially low.

### TECHNICAL FIELD

This disclosure relates to a battery module, a battery pack, and a vehicle. This disclosure further relates to systems and methods for assembling the battery module, the battery pack, and the vehicle, including robotic production.

We use the term ‘vehicle’ in this specification expansively to cover anything that can move or transport people or goods, e.g. over road, rail, air or sea; it includes manually driven vehicles; vehicles with SAE (J3016) Automation levels 0-5; it includes drones. It includes cars, shuttles, trucks, vans, buses, trains, trams, boats, hovercraft and aircraft. Zero emission electric vehicles are an important focus.

### BACKGROUND

A conventional electric vehicle typically connects in series several (typically four) battery modules, each producing 90V-100V nominal. The low voltage battery modules are connected together in series by a cable harness, and packaged into a large, sealed battery pack that outputs around 350V-400V.

The high voltage of around 350V-400V is hence only generated at the latest possible point that it can be generated. There is a bias in the automotive sector away from connecting battery modules to produce a high voltage at any earlier stage, because this would increase the electrical hazards that are encountered during production and servicing. Generating high voltage at the latest possible point reduces the cost of production of the battery modules, as well as their assembly to form battery packs, and installation in vehicles.

The battery pack is typically installed in the chassis or the roof of a vehicle. The weight and size of the battery packs influences the selection of the location of the battery pack, which influences the design of the vehicle exterior and interior.

Investment in the vehicle harness contributes significantly to the cost of the electric vehicle. Materials with low resistivity are selected to reduce the resistive losses, which enhances the efficiency of the vehicles, generating less heat, thus enhancing the vehicle range. A compromise is to be found between the weight of the vehicle harness, and the reduced resistive losses that are achieved by using cables with a high cross-sectional area.

The automotive sector is undergoing a transition towards increased autonomation, with a demand to simplify components so that they can be easily produced and assembled. This extends to the battery pack and its components, allowing assembly of vehicle electronics. Vehicle harnesses typically have a complex shape, and include electrical terminals that are difficult for a robot to grip and install. There is a demand to produce simple battery modules connected by a simple harness, to speed up this transition towards robots performing the installation of vehicle electronics.

Reference is made to PCT/GB2021/051519, the contents of which are incorporated by reference.

### SUMMARY OF THE INVENTION

This invention is defined in the appended set of claims. One example implementation is by the Arrival® system. The Arrival system includes battery modules, battery packs formed from a number of battery modules, vehicles, and fleets of vehicles.

As a first aspect, there is provided a battery module for a vehicle. The battery module is configured to operate as part of a battery pack that includes a number of battery modules. The battery module is configured to deliver power over a substantially low profile, printed circuit board (PCB) flexible electrical conductor. As a second aspect, there is provided a battery pack comprising a number of battery modules, each battery module being configured according to the first aspect. As a third aspect, there is provided a vehicle comprising a number of battery modules, each battery module being configured according to the first aspect. As a fourth aspect, there is provided a fleet of vehicles, in which each vehicle includes a number of battery modules, each battery module being configured according to the first aspect. Some optional features include the following:
The vehicle battery module is configured to generate at least 300V output at maximum charge.
The battery module is configured to be electrically connected in parallel with at least two other substantially similar battery modules to form the battery pack.
The battery module is configured to include an array of rechargeable cells and monitoring and control systems configured to enable the battery module to operate using autonomous monitoring and control; and to be electrically connected to further battery modules, to form a complete battery pack.
The battery module is configured to include an array of rechargeable cells and monitoring and control systems configured to enable the battery module to operate using autonomous monitoring and control; and to be electrically connected to further battery modules, to form a complete battery pack.
The battery module is configured to operate as part of a battery pack that includes multiple, identical such battery modules, in which each battery module has a size that conforms to a regular size interval scale and is part of a family of other types of components with sizing that also conforms to the same size interval scale.
The battery module includes multiple components configured for robotic installation or assembly into the device or system by virtue of being positioned in the device or system in a regular, rectilinear grid or installation pattern.
The battery module is configured for robotic installation or assembly to the battery pack by virtue of having a shape that is optimised for robotic installation or assembly.
The battery module includes multiple cylindrical form-factor rechargeable cells, wherein the battery module includes a base on which the rechargeable cells are positioned, the base being configured to provide a structurally rigid support for the cells.
The battery module is configured provide thermal cooling for the cells.
The battery module including a number of cells that are oriented with the same polarity orientation.
The battery module includes a single outer shell or lid that is configured to enclose an array of rechargeable cells and seal against a rigid base of the module, and the battery module being configured to be electrically connected to further, substantially similar, battery modules, to form a complete battery pack.
The battery module is configured to be inserted, either individually or when part of a battery pack, into a void sitting over a substantially flat chassis base of the vehicle.
The battery module including a number of rechargeable cells configured to generate, at a pair of output terminals, an output voltage.
The battery module including an internal isolation switch system, configured to isolate all cells from one or both of the output terminals.
The battery module is configured wherein at least some of the cells are connectable in series to form a string of cells, and the module includes a switch that is configured to either connect two or more cells in series or to bypass those cells.
The battery module is configured to have a layer construction in which, sitting over battery cells, are one or more separate layers with components or systems that enable the battery module to manage its internal operation, each layer occupying substantially the entire width or cross-section area of the battery module.
The battery module is configured to deliver high voltage output directly into the high voltage power bus of a vehicle.
The battery module is configured to electrically engage with a conductor that is integrated into a vehicle component or other vehicle structure that has a purpose in addition to conducting power, such as a structural component or panel.
The battery module is configured to operate as part of a battery pack that includes multiple, identical such battery modules, in which each battery module is provisioned with modular software components that monitor and control battery systems.
The battery module including modular software components that include (i) an application layer and (ii) a basic software layer, or middleware layer, that insulates or separates the application layer from hardware specific features of the battery module and presents a standardised interface to the application layer.
The battery module including modular software components that are configured to enable the battery module to operate autonomously, and individual modular software components are configured to exchange data with modular software components on other battery modules to provide a distributed architecture.
The battery module is configured as part of a data-network that establishes a network of modules.
The battery module is configured to include an internal performance monitoring and management sub-system that is configured to autonomously manage the battery module and reports data to an external BMS.
The battery module is configured to autonomously negotiate with other modules to determine power or performance compatibility.
The battery module configures itself or otherwise self-initialises to operate with the network when it is added to the network or is turned on.
The battery module (i) is itself verified or authenticated, using a secure protocol, by a sub-system in the device that the battery module is installed in and (ii) each battery module verifies or authenticates a sub-system in the device that the battery module is installed in.
The battery module is a vehicle component configured to operate on a vehicle data network, and where the component treats the vehicle data network as an untrusted one and all communications from and to the component using the vehicle network are encrypted, and the component does not accept commands from other components without verification or authentication.
The battery module is configured to have ingress protection of at least IP 65.
The battery module is configured to include an air pressure equalisation vent configured to enable air pressure equalisation inside the module to ambient or external air pressure whilst maintaining ingress protection.
The battery module including gas escape vents in the case or lid, and in which one or more labels cover the gas escape vents in normal use, and the labels are configured to release to enable pressurised gases, arising from cell failure, inside the module to escape from the battery module.
The battery module is configured to perform decentralised monitoring or control.
The battery pack comprises a number of battery modules that are connected in series and/or parallel.
The battery pack includes one or more printed circuit board (PCB) flexible electrical conductor configured to connect the battery modules.
The battery pack having a monitoring or control architecture that is decentralised over each of the number of battery modules.
The battery pack including a battery management system that is distributed across each individual battery module and is also in a master BMS that is external to all battery modules, so that each individual battery module is able to galvanically isolate itself, and the master BMS is also able to independently galvanically isolate any battery module.
The battery pack including multiple, identical battery modules, in which each battery module is configured for robotic installation or assembly to the battery pack by virtue of having a shape that is optimised for robotic installation or assembly.
The vehicle including a number of battery modules installed in a chassis of the vehicle.
The vehicle having a floor that is substantially low.
The fleet of vehicles is configured wherein an operator of the fleet has defined one or more sets of performance and range requirements it has for the vehicles in the fleet, and those requirements have been used when selecting the number of battery modules to be included in each vehicle in the fleet.

### BRIEF SUMMARY OF THE DRAWINGS

Implementations of the Arrival HVBM system are shown in the accompanying drawings, in which:

FIGS. 1A-1H illustrate a single battery module, the Arrival HVBM, with FIG. 1A providing a perspective view, FIG. 1B providing a perspective view with part cut away to reveal internal components, FIG. 1C providing an exploded view showing a multi-layer structure that is optimised for robotic production, FIG. 1D providing an example arrangement of electrical contacts of the battery module including threaded terminals, FIG. 1E providing an example arrangement of electrical contacts of the battery module including ring terminals, FIG. 1F providing a top view of the electrical contacts of the battery module, FIG. 1G providing a top view of a layer Flex PCB within the battery module that connects the cells, and FIG. 1H providing a perspective view of a base plate of the battery module which illustrates air cooling of the battery module;

FIGS. 2A-2C illustrate a battery pack formed of a number of battery modules arranged linearly and connected by a flexible printed circuit board (Flex PCB), with FIG. 2A providing a perspective view, FIG. 2B providing a top view, and FIG. 2C providing a perspective view of a portion of the battery pack showing a battery module connected to the Flex PCB connector;

FIG. 3 provides a perspective view of a battery pack formed of a number of battery modules arranged in a two dimensional grid, the battery modules being connected by a number of Flex PCBs;

FIGS. 4A-4D illustrate the Flex PCB which connects battery modules of the battery pack, with FIG. 4A providing a top view of an end of the Flex PCB which is configured to connect to a battery module, FIG. 4B providing a cross section view of the Flex PCB installed in the battery pack, FIG. 4C providing a cross section view of the layers of a Flex PCB, and FIG. 4D providing a schematic view of an edge connector between the Flex PCB and a battery module; FIGS. 5A-5F illustrate components within a battery module, with FIG. 5A providing a schematic of showing electrical connections between components of the battery module, FIG. 5B providing a schematic showing monitoring functionality of the battery module, FIG. 5C providing a schematic demonstrating isolation switches of the battery module, and FIGS. 5D-5F illustrating cell bypass switching of a battery module;

FIGS. 6A-6D illustrate electrical connections within a vehicle that includes a battery pack formed from a number of battery modules, with FIG. 6A providing a schematic diagram of a vehicle which includes a high voltage battery system comprising a number of battery modules, FIG. 6B illustrating a possible arrangement of the battery module with respect to other components of the vehicle, FIG. 6C showing a battery pack formed of a number of battery modules and a Flex PCB including high voltage and low voltage cables, and FIG. 6D providing a schematic of the battery module as part of the a high voltage network and a low voltage network;

FIGS. 7A-7F illustrate a production technique of the lid of the battery module, providing progressive views of plastic being injected into a mould;

FIGS. 8A-8B illustrate a lid of the battery module, with FIG. 8A providing a view of the lid exterior, FIG. 8B providing a view of the lid interior;

FIGS. 9A-9H illustrate a production technique of the battery pack, with FIG. 9A providing an exploded view of the battery pack, FIG. 9B providing a flow diagram explaining the details of the production process, and FIGS. 9C-9H providing progressive views of assembly of the components of the battery pack;

FIGS. 10A-10D illustrate vehicles arranged to including a battery pack, with FIG. 10A providing a top view of a vehicle platform installed with a battery pack, FIG. 10B providing a perspective view of the vehicle platform in a robotic production environment, and FIGS. 10C-10D showing another vehicle being installed with a battery pack formed from a different number of battery modules; and

FIGS. 11A-11D illustrate data connections between a vehicle and a server, with FIG. 11A providing a schematic view of the hardware, FIG. 11B providing a flow chart explaining registration of the vehicle with the server, FIG. 11C providing a flow chart explaining registration of the battery module with the server, and FIG. 11D providing a flow chart explaining authentication of the battery module with the server.

### INDEX OF FEATURES SHOWN IN THE DRAWINGS

| Reference | |
|---|---|
| numeral | Description of item |
| 100 | HVBM |
| 110 | Lid of the HVBM |
| 112 | Label of HVBM |
| 114 | HVBM specification information |
| 116 | Recess of lid (shape prevents damage to flex connector) |
| 120 | Removable cover of recess (permits access to terminals) |
| 130 | Base plate of the HVBM |
| 132 | Holes of base plate which accommodate fasteners. |
| 140 | Fasteners (e.g., screws, bolts). |
| 151 | Input/Output of a component (e.g., HVBM). |
| 152 | Memory of the component (e.g., HVBM). |
| 153 | Control of the component (e.g., HVBM). |
| 154 | Data communication bus of the component (e.g., HVBM). |
| 155 | HVBM connector interlock loop |
| 160 | HVBM internal components |
| 160a | Connection board |
| 160b | HV board |
| 160c | Control board |
| 161 | PCB |
| 162 | Dielectric separator |
| 163 | Balancing flex |
| 164 | Power flex |
| 165 | Upper cell carrier |
| 166 | Cells |
| 167 | Lower cell carrier |
| 170 | HVBM terminal (connectable to Flex PCB terminal 310) |
| 181 | HV cell string (formed of cells 166) |
| 182 | Sensors |
| 183 | Smart controller (e.g., performed by PCB 161) |
| 184 | Primary switching |
| 185 | AND gate outputting to 184 with inputs from 183 and 155. |
| 186 | Secondary switching |
| 187 | Galvanic isolator |
| 188 | AND gate outputting to 187 with inputs from 183 and 155. |
| 200 | Battery pack |
| 210 | Rows of battery modules (e.g., upper row and lower row) |
| 250 | Battery pack connector (e.g., upper and lower connectors) |
| 260 | Cooling plate assembly |
| 261 | Upper plate |
| 262 | Lower plate |
| 263 | Cooling circuit |
| 264 | Connectors |
| 270 | Battery pack cover (e.g., upper and lower covers) |
| S100 | Robofacturing process (e.g., assembly of battery pack) |
| S110 | Assemble cooling circuit |
| S120 | Attach plates |
| S130 | Attach rows of battery modules |
| S140 | Attach HVBMs using Flex PCB |
| S150 | Attach cover |
| S160 | Assemble any more rows |
| 300 | Flexible printed circuit board (Flex PCB) |
| 310 | Flex PCB terminal (connectable to HVBM terminal 170) |
| 320 | High voltage power cables |
| 330 | Low voltage power cables |
| 340 | Interlock loop cables |
| 350 | Flex PCB bus connectors |
| 400 | Vehicle/Skateboard Chassis |
| 451 | Input/Output of a device (e.g., vehicle). |
| 452 | Memory of the device (e.g., vehicle). |
| 453 | Control of the device (e.g., vehicle). |
| 454 | Data communication bus of the device (e.g., vehicle). |
| 455 | Vehicle data signal |
| 500 | BMS/Master BMS |
| 550 | High voltage network |
| 555 | System high voltage interlock loop (optional) |
| 560 | Integrated motor drive |
| 570 | Electric vehicle charging system |
| 600 | Server (e.g., cloud service) |
| 651 | Input/Output of a server (e.g., cloud service). |
| 652 | Memory of the server (e.g., cloud service). |
| 653 | Control of the server (e.g., cloud service). |
| 654 | Data communication bus of the server (e.g., cloud service). |
| S10 | Communication between 400, 600. |
| S20 | Communication between 100, 400, 600. |
| S30 | Authentication process performed by 100. |
| S40 | Authentication process performed by 400. |
| S50 | Authentication process performed by 600. |
| 1000 | Robotic production environment (e.g., a microfactory) |
| 1001 | Robot 1 |
| 1002 | Robot 2 |

### Overview of this Disclosure

In this overview, we give a high-level walk-through of the Arrival battery module system, before going on to provide a detailed description, the detailed description being supplemented by further detailed description.

The Arrival system uses a vehicle battery pack made up of a number of battery modules that are modular, scalable, and designed for robotic assembly—key enabling attributes for the Arrival system.

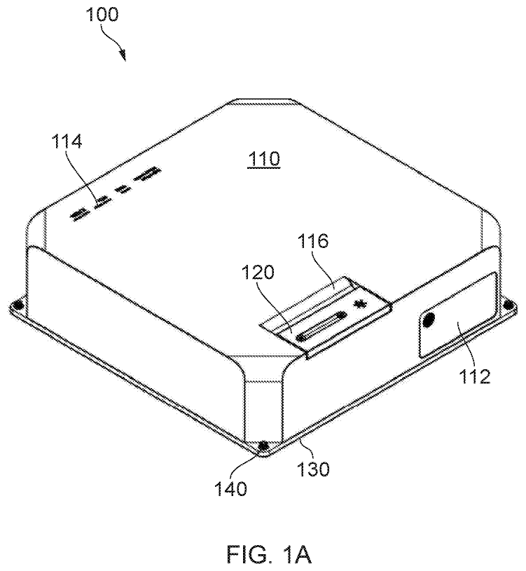

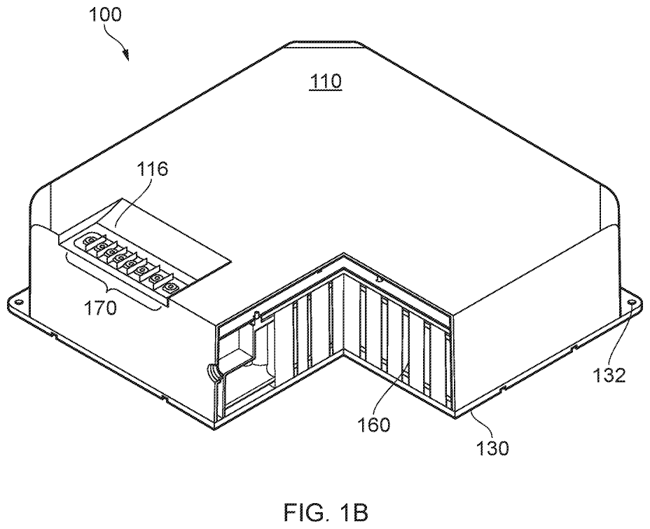

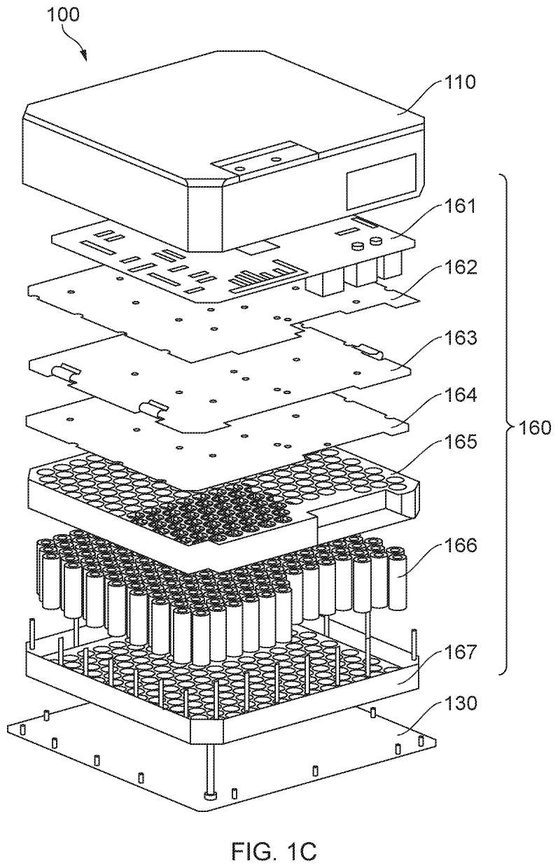

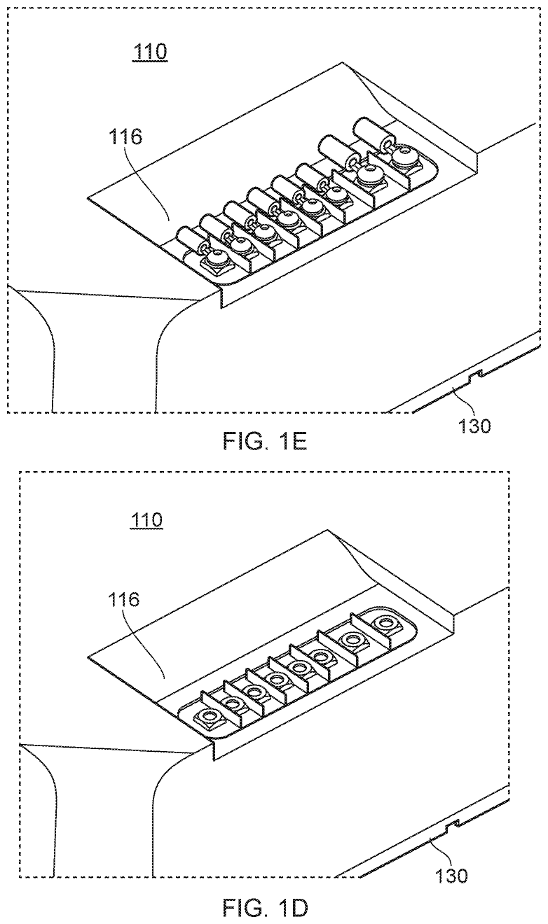

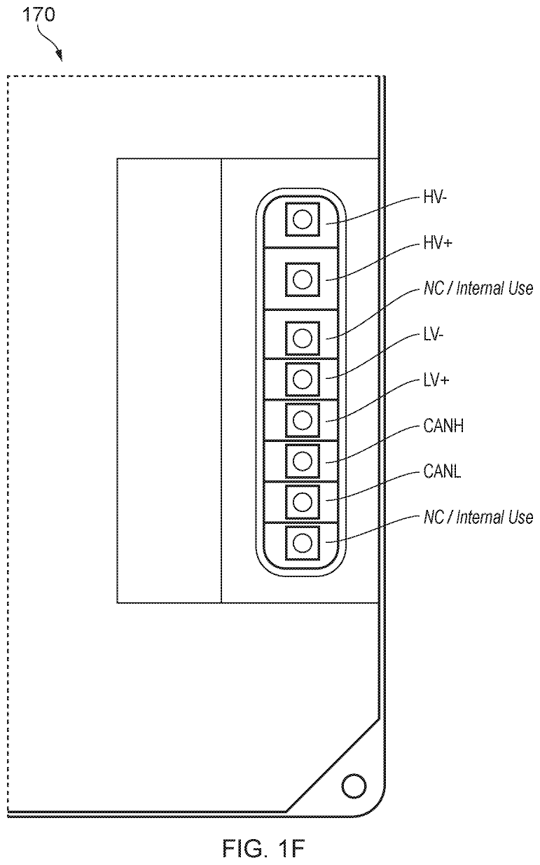

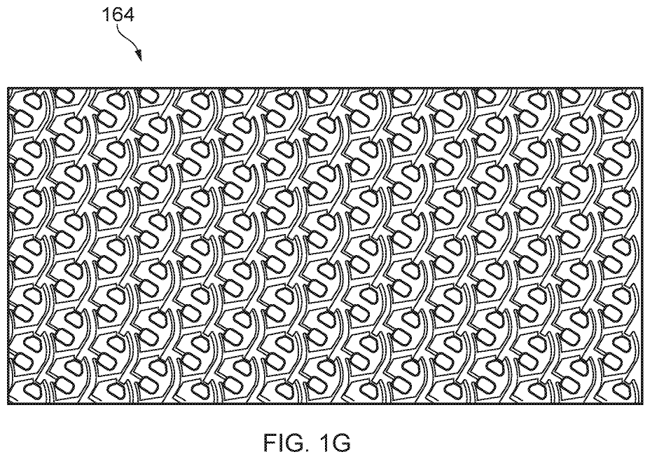

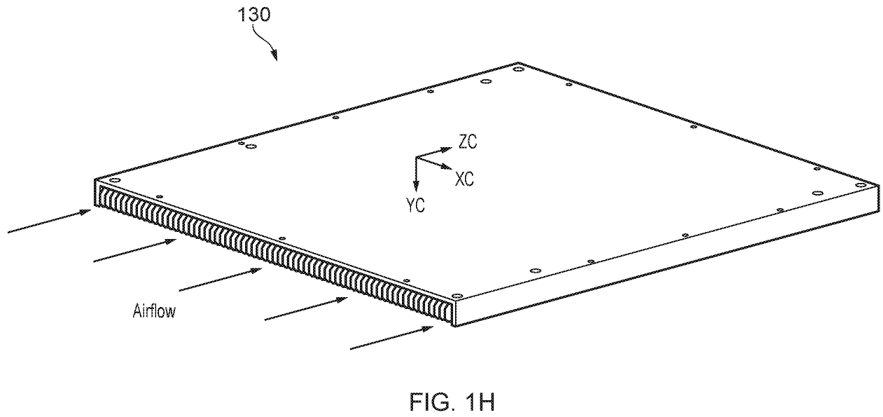

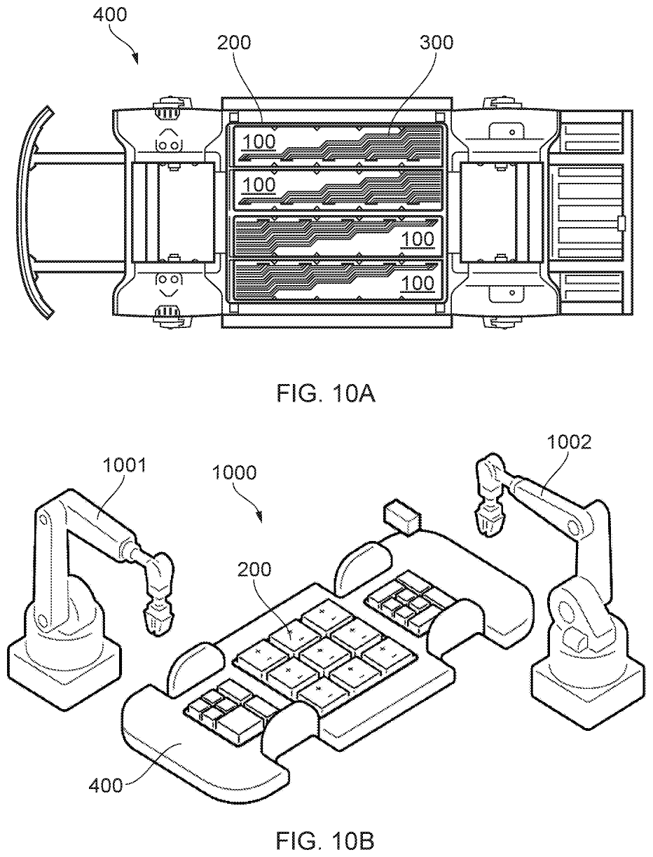

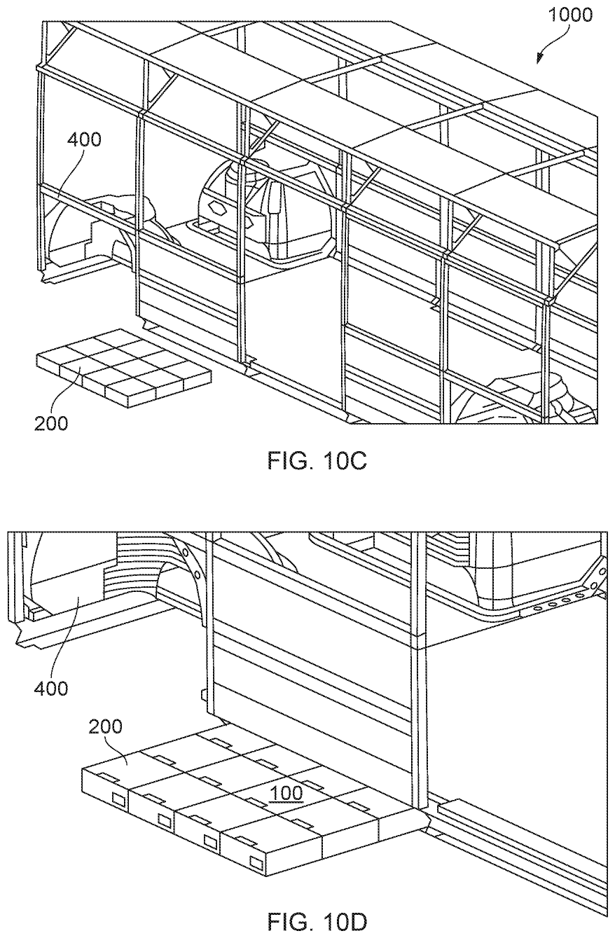

In one implementation, these modules are High Voltage Battery Modules (HVBMs): Arrival's High Voltage Battery Module or HVBM is designed as a self-contained battery module with internal safety systems and an isolated high voltage output of 350V to 400V nominal. Each HVBM is capable of operating as an independent or autonomous unit and of receiving charge, e.g., during regenerative braking and charging from an external power source. FIG. 1A shows an Arrival HVBM; this battery module includes 204 individual 21700 Li-Ion cells arranged in a 102S2P configuration. Each cell in a HVBM generates 3.63V (nominal) and 4.2V (max), has 5 Ah capacity, stores 18.2 Wh. Each HVBM provides a high output voltage (ranging from 428V with 100% SOC down to 255V at 0% SOC), facilitating low output current, low weight harnessing, and the capability to power High Voltage components using one module. More modules in parallel increases energy storage/range. Two HVBMs can be connected in series to deliver approximately 800V. The module is designed for efficient robotic production. It is designed for efficient robotic installation in a vehicle: an array of these modules can be connected together in any arbitrary number, since they are parallel connected. HVBMs are in robust packaging designed for robotic handling (e.g., designed with easy to grip surfaces; are not individually heavy, weighing under 20 Kg; are compact, with dimensions: 350×350×100 mm). FIGS. 10C-10D show an array of twelve modules being slid into the side of the Arrival Bus (see Section J of PCT/GB2021/051519). HVBMs can not only provide power for vehicle traction, but can also be used for domestic and industrial energy storage, and as part of a renewable energy system.

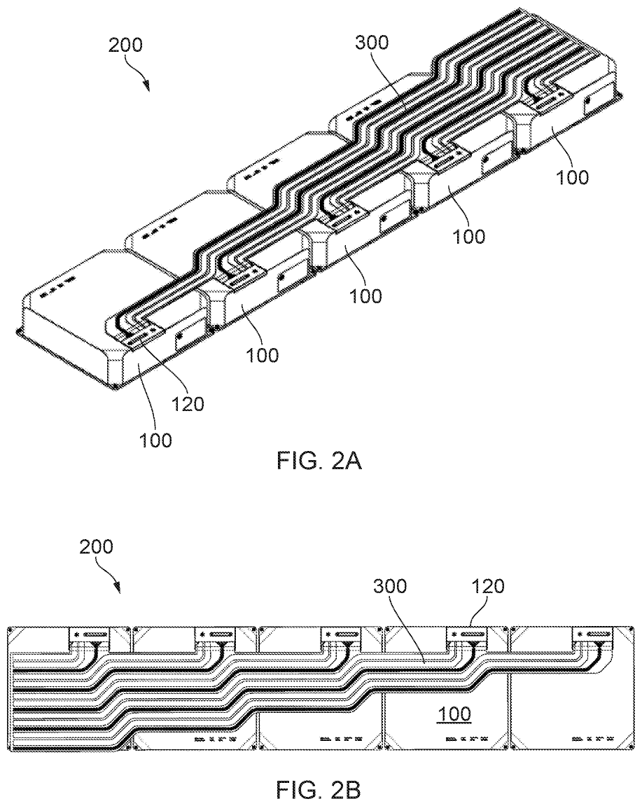

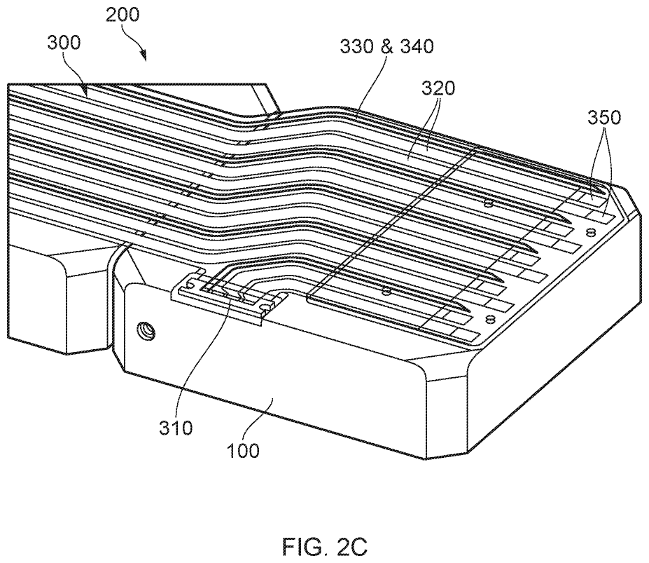

Because the HVBM is a self-contained, modular device, and each HVBM outputs at the voltage required by the vehicle's DC bus (e.g., 400V), HVBMs are connected together in parallel and also connected to the high voltage bus using a flexible, thin PCB-based connected called Flex which is designed to be robotically handled and installed into a vehicle. Because the Flex PCB conductor is flat, light and flexible, it can be handled and installed robotically far more easily than conventional electrical cabling. FIG. 2A shows a group of five HVBMs connected together using this flexible, thin PCB conductor.

The HVBM approach leads to easy scalability: more HVBMs can be parallel connected using Flex connections to give whatever battery pack capacity is needed for a specific vehicle. For conventional series connected battery modules, this straightforward scalability is not possible. Because the HVBM is both modular and also scalable without significant changes to the overall battery pack architecture, an automated Vehicle Builder system (see Section D of PCT/GB2021/051519) can automatically create a build definition for vehicles with entirely different numbers of HVBMs and battery pack capacities, since it requires typically just extending the length of the array of parallel-connected HVBMs used to deliver a required pack capacity. The Robofacturing system (see Section E of PCT/GB2021/051519) in the Arrival Microfactory (see Section F of PCT/GB2021/051519) can then readily build different vehicles, with very different battery pack capacities, all at the same time, without any need to re-configure the Microfactory layout or its operations, since it is fundamentally merely a question of adding in the required number of HVBMs into a given vehicle and connecting them appropriately.

This ability to efficiently customise to a specific requirement is one of the defining attributes of the Arrival system and the HVBM is one of the enabling technologies that makes it possible.

The features disclosed apply irrespective of battery chemistry: whilst current implementations use Li-ion cells, the same principle applies equally well to solid-state batteries, such as Lithium-metal batteries and Lithium-sulfur batteries. Solid-state batteries are inherently safer and lighter than Li-ion batteries; the Arrival battery module is designed to be readily stackable for storage, easily and safely manually carried, and readily robotically installed into a battery pack, even with conventional Li-ion cells. These advantages will be even greater with a battery module that uses light and stable solid-state batteries.

There are advantages flowing from making the battery module a high voltage module (i.e. the battery module output matches the device's main DC bus voltage—typically 300V to 400V for a DC bus driving traction motors for a vehicle). But the principle of a self-contained, battery module, capable of operating as an independent or autonomous unit that forms a part of a larger battery pack, is not limited to the module delivering a high voltage; it applies also to modules that are not high voltage, e.g. modules that need to be series-connected to deliver the required DC bus voltage.

In the further detailed description, which forms part of this disclosure, we focus on specific features of the Arrival Battery Module, organised into five main groupings:
Group A: Core Battery Module Principles
Group B: Battery Module Physical Structure features
Group C: Battery Module internal component features
Group D: Battery Module and the complete power system, including BMS and the battery
Group E: Battery Module Operational Features

Group A: Core Battery Module Principles
Feature 1. Battery module generates an output at a 300V+ DC bus and is connected
Feature 2. Battery module operates as an autonomous module in a battery pack

Group B: Battery Module Physical Structure Features
Feature 3. Battery module with standard grid sizing
Feature 4: Modular components installed using the same regular, rectilinear grid or installation pattern
Feature 5. Battery module configured for robotic assembly
Feature 6. Battery module that sits on a rigid base plate that in turn sits on a liquid cooled plate
Feature 7. Battery module in which all rechargeable cells have the same polarity orientation
Feature 8. Battery module that has its own cover, and connects to other similar modules to form a battery pack
Feature 9. Battery module that slides into chassis void

Group C: Battery Module Internal Component Features
Feature 10. Battery module with internal isolation switch
Feature 11. Battery module with a bypass series switch
Feature 12. Battery module with layered component architecture

Group D: Battery Module and the Complete Power System, Including BMS and the Battery Pack
Feature 13. Battery module with flexible PCB power cable
Feature 14. Battery module that delivers HV direct to the HV bus
Feature 15. Battery module that connects to integrated power cables
Feature 16. Battery pack including battery modules and a BMS

Group E: Battery Module Operational Features
Feature 17. Battery module implementing Plug and Play software components
Feature 18. Battery module with decentralised autonomy, operating in a distributed architecture
Feature 19 Battery module with performance reporting
Feature 20. Battery module that autonomously negotiates with other battery modules
Feature 21. Battery module with crypto-network
Feature 22. Battery module that self-initialises
Feature 23: Battery module with ambient pressure equalisation vent
Feature 24: Battery module with gas escape vents
Feature 25: Battery module with internal monitoring or control systems

### DETAILED DESCRIPTION

The Arrival system uses a vehicle battery pack made up of a number of High Voltage Battery Modules (HVBMs); HVBMs are modular, scalable, and designed for robotic assembly—key enabling attributes for the Arrival system. HVBMs connect to the high voltage bus using a flexible, thin PCB-based connected called Flex.

1. Fundamentals: HVBM is a High Voltage, Parallel Connected Battery Module, Enabling Modularity and Scalability

Arrival's High Voltage Battery Module or HVBM is designed as a self-contained battery module with internal safety systems and an isolated high voltage output of 350V to 400V nominal. Each HVBM is capable of operating as an independent or autonomous unit and of receiving charge, e.g., during regenerative braking and charging from an external power source. The HVBMs can not only provide power for vehicle traction, but can also be used for domestic and industrial energy storage, and as part of a renewable energy system.

FIGS. 1A-1H illustrate a battery module 100 including a housing (110, 120, 130) and fixing means 140. The housing comprises a lid 110, a cover 120, and a base plate 130.

The lid 110 surrounds electrical components housed within the HVBM 100. The lid 110 includes a label 112 that specifies identity information. The identity information 112 includes a name of the HVBM 100, wherein each HVBM 100 is assigned a unique name. The identity information may further include attribute information that provides details of how the HVBM 100 is configured. The identify information includes at least one of text, numerals, and a machine readable code (such as a bar code, QR code, microchip). Security is enhanced by providing identity information that is encrypted. The lid 110 is configured to provide specification information 114, the lid 110 being printed with text 114 that specifies attributes of the HVBM 100.

The lid 110 includes a recess 116 that accommodates electrical terminals 170. The cover 120 is configured to cover the electrical connectors. The cover 120 is removed to access the electrical connectors. The provision of a cover 120 is not essential, although it does enhance the safety of the HVBM 100 by preventing the electrical contacts from being contacted by accident.

The base plate 130 has a plurality of holes to accommodate the fixing means 140. The base plate 130 has a flat base so that the HVBM 100 can be brought into contact with a surface onto which the HVBM 100 is to be secured. The base plate 130 has a flat top, onto which are placed the electrical components, which are enclosed by the lid 110.

The fixing means 140 is configured to attach the base plate 130 to the surface onto which the HVBM 100 is to be secured. As an example, the base plate includes a number of holes 132 which are configured to accommodate fasteners 140 (e.g. screws, bolts). The battery module 100 is typically attached to a cooling plate, which regulates the temperature of the HVBM 100 during use. A nut and bolt fixing means is typically used to secure the HVBM 100 to the surface.

The housing is generally cuboid in shape. The shape of the HVBM 100 allows a plurality of HVBMs 100 to be placed in a grid arrangement. Furthermore, the shape of the HVBM 100 enhances compatibility with air cooling and/or liquid cooling.

The base plate 130 is flat, having a generally rectangular shape, smoothed at the corners and edges, which enhances the conduction of heat from the base plate 130 into the surface in which the HVBM 100 is secured. The lid 110 has a general profile of an octagonal prism, and when installed is set back slightly from the edges of the base plate 130, which enhances the convection of heat from the HVBM 100 into air surrounding each HVBM 100. A further effect of the generally chamfered appearance of the lid 110 is to facilitate access to the fixing means 140, so that the HVBM can be installed or removed from the surface.

The housing is black in colour, because a black body can more efficiently radiate heat to its surroundings, allowing the HVBM 100 to cool during use. This effect is observed by the lid 110 radiating heat into air surrounding the HVBM 100. This effect is observed by the base plate 130 radiating heat into the surface in which the HVBM 100 is secured.

The HVBM 100 is a self-contained electrical component, having internal safety systems and isolated output capable of providing power for vehicle traction as an independent unit.

Interior features 160 of the battery module 100 include a printed circuit board (PCB) 161, a dielectric separator 162, a balancing flex 163, a power flex 164, an upper cell carrier 165, a plurality of cells 166, and a lower cell carrier 167. The PCB 161 includes the input/output (I/O) unit 152, the memory 152, and the control 153. The PCB 161 monitors voltages, current and temperatures and controls the isolation contactors. FIG. 1G illustrates the power flex 164 in more detail.

2. The Significance of the Module being High Voltage

Each HVBM outputs approximately 350V to 400V since it is designed for use in a vehicle with a 400V DC bus and other load components. A number of HVBMs are connected in parallel to form a 350V-400V battery pack suitable for a vehicle; for example, for a small Arrival car, five HVBMs are connected in parallel. A vehicle can continue to operate safely, even if several HVBMs fail; range would typically be compromised, but normal vehicle operation would otherwise remain possible. Individual HVBMs can be removed and replaced rapidly for efficient servicing.

In earlier systems that connect multiple battery modules to form a 350V-400V battery pack, each module would typically output 90V-100V and four of these modules would then be series connected to output about 350V-400V: the assumption, or technical bias, that has informed this approach, is that individual power modules should each, to maximise safety, be significantly below the 400V needed by the vehicle DC bus. A short digression: The choice of a 400V DC power bus is in turn required because the motors generally chosen for electric vehicles operate at approximately 400V; whilst one could opt for a lower voltage motor, that would in turn require high current and hence bulkier, heavier and more costly power cabling; likewise, a 700V-800V motor and related power bus could be used; that would mean thinner, cheaper power cables, but more expensive power isolation contactors and other components designed for a 800V system. The typical compromise that has been reached in low or zero emission vehicles is to opt for a 350V-400V system (motors, DC power bus and final battery pack output). So for example the Tesla Model 3 has four battery modules, each delivering about 90V-100V, all series connected into a large, sealed battery pack that gives a final DC output of 350V-400V, powering one or more 350V-400V motors.

The Arrival HVBM turns the conventional approach on its head: instead of generating the 350V-400V output at the latest possible point, it is generated at the earliest point—namely at each individual module. So each module generates a 350V-400V high voltage nominal output (equally, if the vehicle in which the Arrival HVBM uses say a 800V or 1200V system, then each HVBM can itself be configured to generate 800V or 1200V as appropriate). Modules can then be parallel connected in any desired number to give the range or power required for the specific vehicle. High voltage means a significantly lower current, which minimises cable/wire/bus-bar/track gauge within the module and between the module and ultimate point of use. So we have a modular and readily scalable battery architecture with inherent performance advantages.

FIGS. 2A-2C illustrate a battery pack 200 formed of a number of battery modules 100 arranged linearly and connected by a flexible printed circuit board (Flex PCB) 300. The HVBM 100 is arranged in a battery pack 200 comprising a number of HVBM. The battery pack 200 is configured to exchange electrical current with an electrical device such as a vehicle. To enhance capacity, the Flex PCB 300 connects the HVBM 100 in parallel. This delivers a scalable and highly redundant distributed system.

FIG. 3 illustrates a battery pack 200 formed of a number of battery modules 100 arranged in a two dimensional grid, the battery modules 100 being connected by a number of Flex PCBs 300.

3. The HVBM Delivers Flexibility, Scalability and Easy Customisation to Vehicle Design

We had earlier described how the conventional vehicle design paradigm locked in certain vehicle attributes: if you have designed a large 350V-400V battery pack made up of say four series connected battery modules, each producing 90V-100V, then the fixed dimensions and power profile of that battery pack essentially constrain its use into the vehicles of very similar dimensions and power requirements as the parent vehicle: if that parent vehicle is a medium sized car, then the battery pack can only feasibly be used in other medium sized cars, and not, for example, in a large bus. The Arrival HVBM architecture is however completely flexible: the module is relatively small (e.g. 350 mm square), relatively light (e.g. under 20 kg with Li-ion cells; solid state cells will be lighter still) and can be combined in any number of ways—at the limit, just a single module, but for a small city car, perhaps a grid of ten in-line modules; for a larger car, or one that needs a longer range, perhaps a grid of twenty modules in a 2×5 array (two along the width, five along the length for a top row; and then the same for a lower row, sitting underneath). For a small van, a grid of 6×7 modules might be adequate; for a large van, a grid of 6×10 modules might be needed.

This yields considerable flexibility when designing new vehicles: Perhaps a major parcel delivery company needs to purchase some new zero emission vans that need a daily 100 mile range between charges and a small proportion that need 250 mile range between charges; Arrival vans can be custom designed (e.g. using Vehicle Builder) and custom built (using Robofactoring in a Micro-factory) with differing numbers of HVBMs—e.g. some have a sufficient number of HVBMs to cover 250 miles between charges, and the rest have far fewer HVBMs (and are hence lighter and cheaper) sufficient for just a 100 mile range. A conventional vehicle producer might have at most one or two different sizes of battery available to customers (e.g. a standard range battery and a long range battery), but the HVBM approach enables the customer to select any arbitrary number of HVBMs, to perfectly meet their needs.

Since the battery pack is the single most expensive item in a vehicle, and also the heaviest, the ability for a customer to choose exactly the number of HVBMs needed for their vehicle(s), and to have different battery packs in different vehicles, enables the customer to optimise across all relevant factors (initial cost, residual value, total cost of ownership, range, performance, recharging costs, recharging times etc.). This is especially valuable to a fleet operator, such as a delivery company or ride-hailing/e-taxi company. The Arrival software-based and highly automated vehicle design system (Vehicle Builder) is flexible enough to automatically configure the layout and all power/data connections required for any arbitrary number of HVBMs selected by the customer; Robofactoring and Micro-factories are flexible enough to put into production the vehicle; efficient customisation to meet a purchaser's exact requirements is possible.

And as the needs of that purchaser evolve, the vehicles can be adapted as required: for example, if more long range vans are needed, then vans that previously only had sufficient battery pack capacity for a 100 mile range can, because of the wholly modular and self-contained design of the HVBM, have further batteries added during maintenance, without requiring replacing the entire battery pack, or indeed replacing the entire van with a long range variant.

The highly modular Arrival HVBM system therefore offers far greater flexibility than earlier battery modules and battery packs in enabling the specific cost, range, power and lifetime needs of customers to be met, and for their evolving needs to be met as well.

Similarly, for a small bus, a grid of 100 HVBMs in a 5×20 arrangement might be suitable; for a long bus, a grid of 150 HVBMs, in a 5×30 arrangement, might be needed. But because of the highly modular Arrival HVBM system, it becomes straightforward to design and production even relatively low volumes of buses that have the exact number of batteries that are optimal for the intended range/power requirements of the customer.

We will look now at HVBMs in more detail. Multiple battery modules are connected in parallel for the required pack capacity, providing power for vehicles with a 400V High Voltage DC Bus—i.e. each HVBM outputs 400V. They can also provide power for 800V HV systems (e.g., with a pair of series connected HVBMs, each outputting 400V, or where each individual HVBM outputs 800V). This modularity delivers a scalable and highly redundant distributed system; modules can be added or removed for different capacity battery packs, so that battery pack capacity can be optimised for range, cost and lifetime simply by connecting more of fewer HVBMs in parallel.

Each individual HVBM operates as a modular, independent unit; that means that each unit has to be designed to provide safe handling, despite the fact that it could deliver 400V (or more). Each HVBM therefore includes its own internal contactors (e.g., driven by PWM) to allow each module to safely provide power as an independent unit (e.g., a unit that determines for itself if it should be switched off, independently of other units), with no reliance on other modules. To enhance safety, each HVBM includes internal contactor health monitoring, which is achieved by providing sensors configured to monitor the performance of the internal contactors of the HVBM. Each HVBM includes a pre-charge circuit which is activated prior to connecting to the DC bus to prevent a potentially dangerous current inrush.

Because each HVBM is a modular, independent power unit, that provides high redundancy, this minimises downtime and maximises vehicle design flexibility. It also makes it much easier to re-use these HVBMs in other contexts; for example, if a vehicle using these HVBMs is involved in a serious accident, then it becomes much easier for a salvage company to safely remove the HVBMs and install them in another vehicle. More generally, it becomes much easier to use these HVBMs wherever a rechargeable energy source is needed; for example, racks of these HVBMs could be used for domestic or commercial electrical energy storage as a ‘second life’ after they have been used for vehicle traction power, or as a ‘first life’.

HVBMs currently use Li-ion cells; these can be in any format, such as cylindrical, prismatic or pouch. As solid state batteries becomes more widely available, their enhanced power to weight ratio and inherent safety make them an especially attractive battery technology to be used in HVBMs.

A note on terminology; the smallest power unit in a battery pack is the individual rechargeable cell; these come in various formats, such as the widely used cylindrical 18650 format Li-ion rechargeable cells (which is 18 mm in diameter and 65 mm in length) and the 21700 format Li-ion rechargeable cells (which is 21 mm in diameter and 70 mm in length). Rechargeable cells are connected together in a series/parallel arrangement to form a battery module; for example, in a conventional battery module, twenty cells, each with a nominal 3.7V, could be joined together in series to form a module; each module has a pair of output terminals and in this example, the output terminal gives a nominal output of 74V. Forty of these cells could be made up of 2 parallel connected groups of cells, with each group being a series connected string. Again, the nominal output at the module's pair of output terminals is 74V. The output terminals of the module are either connected to the load or connected to further similar modules to form a battery pack; typically, conventional modules are connected in series to ramp up the voltage to the required level. In the example above, a conventional hybrid car might use a 150V system, in which case two 74V modules are series connected to form a battery pack and it is this battery pack that is connected to the DC power bus of the vehicle to deliver this output. For a conventional pure electric vehicle, typically running a 350V-400V system, then five of these modules would conventionally be series connected to form a battery pack delivering approximately 370V.

4. HVBM Requirements

We will look now in more detail at the HVBM product requirements. Each HVBM includes, in one implementation, 204 individual 21700 Li-Ion cells, such as LGM50U cells, arranged in a 102S2P configuration. Each cell in a HVBM generates 3.63V (nominal) and 4.2V (max), has 5 Ah capacity, stores 18.2 Wh. Each HVBM provides a high output voltage (ranging from 428V with 100% SOC down to 255V at 0% SOC), facilitating low output current, low weight harnessing, and the capability to power High Voltage components using one module. More modules in parallel increases energy storage/range. Two HVBMs can be connected in series to deliver approximately 800V.

Current monitoring, cell voltage monitoring, cell balancing, temperature monitoring, isolation contactors and solid state switches as well as a HVIL (high voltage interlock) safety system are contained within each HVBM. Each HVBM's autonomous ability to switch its own output off and on, and to enter or emerge from sleep mode, allows a vehicle to cope with modules in differing states of charge, as well as adding many safety features.

The cells in a HVBM are constantly live, but can be disconnected from the HVBM module's output by means of internal electromechanical, PWM controlled contactors. No separate PDU (power distribution unit) is required (these are large and expensive, so eliminating the PDU saves weight and cost); instead, a completely non-mechanical, external PDU, i.e. a Master BMS (MBMS), can control the HVBM in a low-cost, reliable way.

Internal fusing provides short circuit protection to the modules and no separate junction box with fuses is needed. Direct HV output from the modules to the vehicle main DC Bus is possible: Each HVBM can be controlled with just a single Master BMS (MBMS) or BMS that controls all HVBMs in battery pack, in a low-cost, reliable way. This allows each HVBM module to provide power selectively in order to optimise overall battery pack power output, thermal management and module longevity.

We can summarise some key requirements/attributes of the HVBM as follows:
Each HVBM operates completely independently from other HVBMs in the network
Each HVBM has the capability to connect/disconnect itself to and from the network, but should only do so, without being instructed, for safety reasons
Each HVBM can itself switch on/off, including under load (solid state switching)
Each HVBM does not hold the non-safety related strategy for HV network connection/disconnection and gets switching requests through a CAN/Ethernet connection from the BMS
Each HVBM includes redundant networking capability, which prevents or reduces the risk of the HVBM from being disconnected from the network.
Each HVBM control board is powered-on by the master BMS and cannot power itself on from itself—i.e. from the cells in the related HVBM
Each HVBM has no functionality and is open circuit when no LV power is applied—i.e. the LV power to power-up the control board can only come from the external BMS.
Each HVBM monitors its connector status through a connector interlock
Each HVBM does not monitor the system HVIL
Each HVBM does not monitor isolation resistance
Balancing connections: connected to cell pairs using a spot-welded flex PCB
Balancing-to-PCB connections: Flexible balancing PCB is directly connected to the main PCB via a latched connector
Cell mounting: rigid bonding to a baseplate using isolating (3.42 KV isolation), thermally conductive adhesive (TC-2002)
Cell positioning: Cell carriers position cells on the base plate
Cell-to-cell connections: spot-welding to flexible power PCB (into a 102s2p configuration)
Connector Interlock: A connector cap provides connector interlock capability
Connector protection: Shorting risks are avoided and voltage creepage distances maintained by a plastic module connector housing
Internal grounding: The main PCB is grounded to the module base plate.
Module connector configuration: The main module connector comprises bolted connections
Mounting configuration: The module is capable of being mounting upside down (used for example in the twin row or double-decker configuration), and resistant to loading in all configurations.
Number of cells per module: The HVBM consists of 204 Cells
PCB mounted: The PCB is rigidly mounted on the cell carriers
PCB serviceability: The main PCB is removable and serviceable
Power-to-PCB connections: Flexible power PCB is directly connected to the main PCB using a bolted connection
Pressure equalisation: The main PCB is removable and serviceable
Protection of internals/sealing: a lid encloses, protects and seals battery internals and enables stacking of multiple HVBMs on top of each other, and provides flame resistance with UL94.0 VO plastics. The lid is black in colour for effective and predictable heat dissipation.
Venting: The lid vent gases safely in the event of a thermal runaway
Capacity: 10 Ah
Energy Stored: 3.7 kWh
Open Circuit Stabilised Voltage: 375 v (Nominal) 306 v (Min) 428 v (Peak)
Maximum Current: 15 A (Continuous) 30 A (5 minute) 80 A (10 s Pulse)
Internal Monitoring: Output Voltage Sensor, DC Bus Voltage Sensor, Current Sensor
Additional Internal Functions: Cell Balancing, Internal Fuse
Internal Contactors: 3× High Voltage Contactors 40 A Rated
Pre Charge Capability: 240 or 300 Ohm Internal Pre Charge Circuit
Connector: Bolted terminals suitable for use with cables or Arrival Flex™ (see later).
Ingress protection: IP 65
Automotive Safety Level: ISO26262 ASIL C
Unique, traceable ID
First life: traction battery for a vehicle; second life: any energy storage

The HVBM has the following electrical interfaces:
CAN connection: 2 pins
Ethernet connection: 2 or 4 pins
Low voltage supply: 2 pins
Connector Interlock: 1 pin
HVIL: 1 pin
HV Power: 2 pins
Ignition: 1 pin
RS232 connection: 2 pins

HVBM Safety Specification Requirements:
Maintain HV power availability: The module provides predictable available power to the system with 20% accuracy (TBD).
Maintain HV power availability: Vehicle/System level available power fade rate does not exceed 1% of Nominal available power/sec or more than 10% by step every 10 sec. Nominal is referenced at the in situ measured temperature and with: SOC>20% in discharge; SOC<80% in charge
Prevent cell related Thermal Incidents or harmful gases emissions: The module monitors the SOA of the cells.
Prevent cell related Thermal Incidents: Any exit of SOA on trajectory to TI (thermal incident) is reported repeatedly through CAN as a safety issue alongside with a request to disconnect from the network.
Prevent cell related Thermal Incidents: After 100 sec of having notified the SOA exit on trajectory to TI through CAN, and if not required before by the system, the module switches off the power network.
Prevent cell related Thermal Incidents: The HVBM does not allow switching on again unless all stored faults have been erased using the appropriate service mode by a power user.
Prevent Electric Shocks: When HVBM connector disengagement is detected, the module immediately switches off.
Prevent Electric Shocks: When a crash CAN message is detected, the HVBM immediately switches off.
Prevent Emission of harmful gases: Any exit of SOA on trajectory to Smoke emission is reported repeatedly through CAN as a safety issue alongside with a repeating request to disconnect from the network.
Prevent Emission of harmful gases: After 100th sec of having notified the SOA exit on trajectory to Smoke emission through CAN, and if not required before by the system, the module switches off the power network.
Prevent Emission of harmful gases: The module does not allow switching on again unless all stored faults have been erased using the appropriate service mode by a power user.
Prevent non cell related Thermal Incidents: The module monitors the SOA of its components.
Prevent non cell related Thermal Incidents: Any exit of SOA on trajectory to triggering any undesired irreversible and dangerous heat release is notified through CAN repeatedly, then the module shall switch off immediately regardless of SG1.
Prevent non cell related Thermal Incidents: When the HVBM connector disengagement is detected, the module immediately switches off.
Prevent non cell related Thermal Incidents: The module does not allow switching on again unless all stored fault have been erased using the appropriate service mode by a power user.

5. HVBM Design Specifications

The HVBM units are each grid based components: essentially square with truncated edges and dimensions: 350×350×100 mm. and weight of under 20 Kg so that they can be readily moved and installed (both manually and by robotic effectors). The HVBM internal design is robust. It uses the baseplate as both the main structural element and air and/or liquid cooling surface. The advantage of cooling the base of the cells is the high thermal conductivity through the cell axis (25× higher than in the radial direction).

Each HVBM has a plastic enclosure or lid (PC/ABS) that provides an environmental seal for the module (IP65) and makes it straightforward to handle, store and transport for vehicle assembly and servicing. The lid includes an array of pressure relief vent holes that allow high pressure gas to escape and hence not build up inside the HVBM to dangerous levels; the array of holes is covered with an adhesive label arranged to balloon out and eventually de-bond at sufficiently high gas pressures. In addition to the pressure relief vent holes, there is a pressure equalisation hole that enables the pressure inside the HVBM to equalise to ambient external air pressure; it includes an air permeable, liquid impermeable barrier.

As shown in FIG. 1C, internal parts of the HVBM are designed in horizontal layers to allow both rapid, vertical robotic assembly. For example, the main PCB 161 forms one complete layer that can be lowered vertically into a HVBM. The layered architecture facilitates not only initial production, but also later removal and upgrades: for example, where new technologies can be incorporated into the PCB (e.g., new technologies to improve fast charge and reduce ageing), then the entire old PCB can be lifted out of the HVBM and a new, upgraded PCB layer 161 added in. Similarly, if cells in an HVBM need replacing, then the layers in the HVBM sitting over the cells can be lifted out and a new array of cells inserted in their place.

External Dimensions: Max. 350 mm×350 mm×100 mm (height dimension of 110 mm can vary dependent on heat sink design for different duty cycles)

Cooling: Air Cooling Option (16 mm finned Heatsink as Baseplate); Liquid Cooling Option (6 mm Flat Plate as Baseplate). The HVBM is capable of delivering heat transfer to an external cooling/heating system of 14.1 W/degC.

Mass: 18.5 kg (205 Wh/kg)(302 Wh/litre)

6. Thermal Performance of the HVBM

Two cooling strategies can be applied to the HVBM: air cooling and liquid cooling. In both cases the heat is rejected via the base of the batteries, through a heat sink or a cold plate 130, as shown in FIG. 1H. Air cooling may be considered for lower duty applications whereas liquid cooling can handle higher continuous power. The battery temperature is a trade-off between aging, efficiency and energy use. Allowing the batteries to work at warmer temperatures increases their efficiency, and by default less energy for cooling is needed. However, they will age faster and may not reach the aging targets that are set. In the end, the choice of cooling strategy is a vehicle decision and should consider power demand, cost, implementation, interaction with other thermal systems etc. However, these guidelines here to make that decision easier from a thermal point of view.

The HVBM includes intumescent material used on internal surfaces. Instead, or in addition, the HVBM is configured to be stored in a container that includes intumescent material on internal surfaces.

An HVBM can be configured for convenient handling and storage. This is achieved, for example, by providing a HVBM with one or more external handles. Instead, or in addition, the HVBM is configured to be stored in a storage container. The storage container is configured to store one or more HVBMs. The storage container includes an internal liquid cold plate. The storage container includes a gas pressure relief valve. The storage container has internal surfaces coated with intumescent material. The internal surfaces of the storage container have a shape configured to receive one or more HVBMs. The storage container has one or more external handles. For example, the storage container has a briefcase style.

7. Cooling Strategies

Liquid Cooling

For applications with higher continuous power demand, liquid cooling is recommended. Generally, the liquid consists of a water/glycol mixture which has better thermal properties than air, ensuring a higher heat transfer rate from the HVBM. The baseplate of the HVBM (aluminium of 6 mm thickness) will usually sit directly on the cold plate (with thermal conductivity paste in between). Alternatively, liquid cooling channels can be provided directly inside the baseplate of the HVBM. FIG. 1B illustrates interior components 160 of the HVBM 100 in thermal communication with the base plate 130.

Air Cooling

FIG. 1H illustrates air cooling of the battery, for which air is forced through a plate finned heat sink. Battery cooling with air requires driving cycles to have low power sequences which allows the battery to cool down, or continuous low power output which ensures that the temperature does not rise too quickly. In general, however, the HVBM is expected to change in temperature as it is being discharged.

8. Flex™ Power Cable

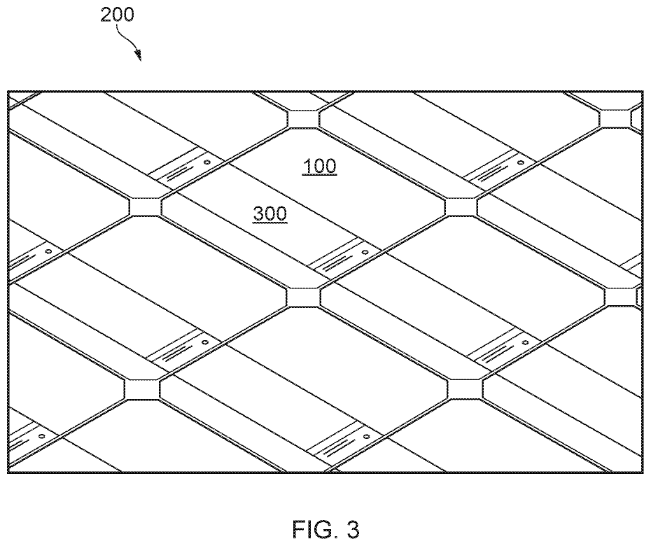

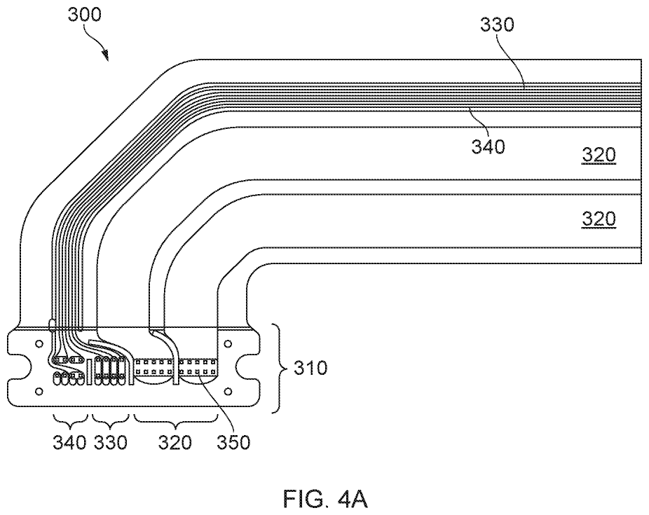

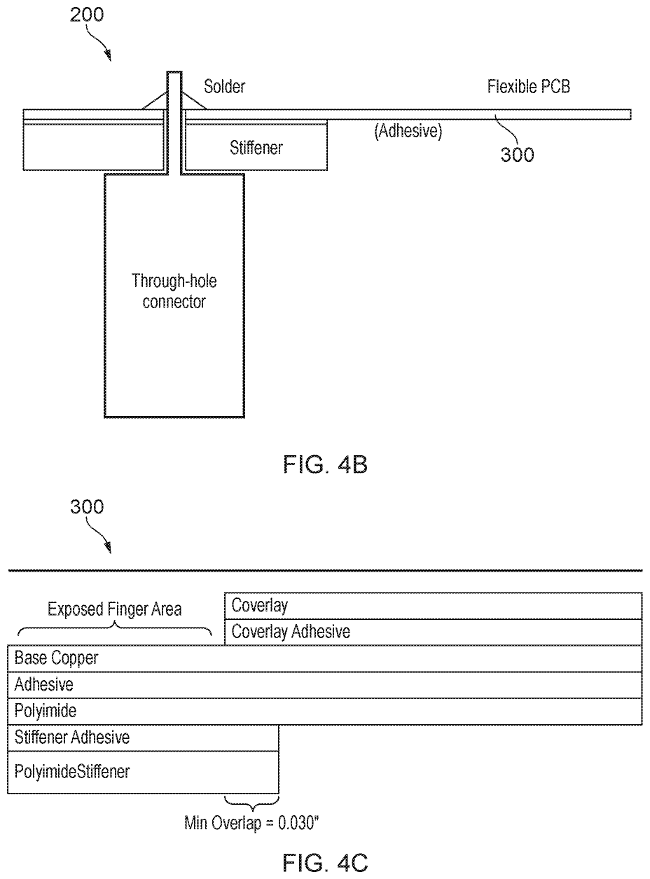

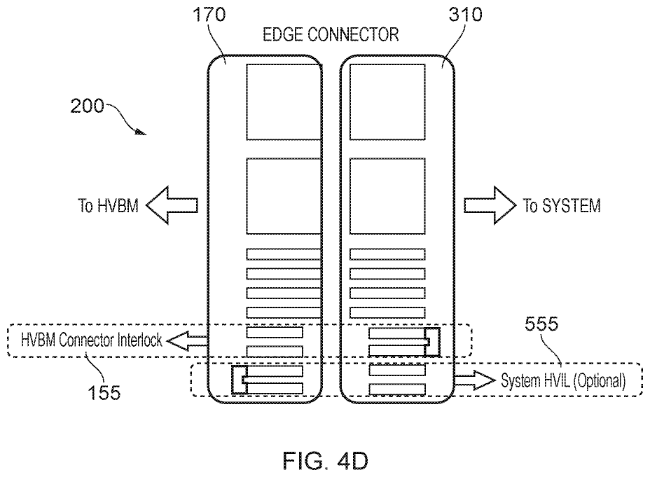

FIGS. 4A-4D illustrate the Flex PCB 300, which demonstrates how the HVBMs 100 are connected within the battery pack 200. Vehicle design employing Flex 300 could make use of a flat cable harness with integrated sensors, the production and assembly of which can be fully automated, including pick-and-place of connectors and components, enabling a distributed architecture. Within each HVBM battery module 100, cells can be connected together using a Flex 164 (see FIG. 1G) which incorporates control electronics on a single piece. High current capable flexible PCBs could be used within the Arrival traction inverter and IDU—eliminating bus bars and cable assemblies, allowing the circuit to be folded into the space available. Historically more expensive than cable, the higher volume utilisation of flexible circuits in recent years and the introduction of continuous reel to reel production have brought the cost down to a level where the decision can be made on relative merits of Flex versus conventional technologies such as cable harness.

Flex PCB (164, 300) is a conductor (usually copper) sandwiched between two polymer insulators, usually orange Polyimide (Dupont trade name Kapton). The process starts with laminating copper to a polyimide baselayer, and then etching the copper to create the PCB tracks. We then mechanically cut holes (stamping or laser) in a polyimide coverlay, and then carefully align this to the etched baselayer with adhesive in between, and press with heat. Alternatively, we can use a green photo-imagable coverlay instead which is dispensed as a liquid over the etched copper baselayer. The polymer is cured with ultraviolet light and washed off leaving holes. This technique avoids the need to carefully align the coverlay. It is also possible to expose these holes after lamination by ablating the insulation using a laser, although this is usually a slow process. For electromagnetic shielding we have used a conductive film called Tatsuta, coloured black with graphite, which is laminated to the outside. After everything is laminated together, the outside profile is cut by laser, knife, or stamping. Flex (164, 300) has many advantages over a conventional cable harness:

Streamlined Mechanical and Electrical Design
Flexible positioning of components, connectors, devices, sensors and tracks
Combined power, signal, data, low voltage power and so forth, all on one platform
Free choice over routing and connectivity across the PCB
Splicing, bus, daisy chain configuration
Integrated sensors, devices, laminated bus bars and connectors
Local features such as selective shielding where required, reinforcement, bonding

Minimised Weight and Reduced Size of the Total Package
Increase flexibility in performance and packaging
Minimal bulk, tight bend radius compared with cable
Inherently low profile; smaller connectors
Significant (order of magnitude) weight saving compared with equivalent cable harness including connectors

Production and Reliability
Increased reliability and yield rate compared with cable solution
Reduced manual cable assembly errors
Decrease assembly time
Reduced rework and re-inspection, and zero scrap (no wastage from offcuts)
Tool-free process offers flexibility for bespoke automated design and rapid iteration

Automated Process
Robotic handling of harness
Robotic pick and place of components (connectors, devices and sensors)
Eliminate wiring labour; no crimp terminals or wire assemblies

Performance
Improved thermal dissipation (high surface area). Temperature stability
Flat surface, bonding: eliminating rattles and creating rigid area for auto-coupling
Impedance control, minimal signal loss

Flex Features

FIG. 4A illustrates a Flex PCB 300 including electrical contacts 310, high voltage power cables 320, low voltage power cables 330, and interlock loop cables 340. The HV power cables 320 include HV bus connectors 350. Furthermore, the LV power cables 330 and 340 include similar connectors. The electrical contacts 310 illustrated are configured to connect to connect to the terminal of a HVBM 100 within the battery pack 200. Flexible PCBs are highly versatile and can incorporate a wide range of features and combine multiple functions into a single component.

Heat sink: Thermally conductive heat sinks can be laminated to flex circuits to dissipate heat away from sensitive components. Below left is pictured three layer flex with copper selective wire bond Nickel/Aluminium assembly and heat sink bonding.

Overmoulding: Connector boots, sealing, strain relief can be achieved with low pressure moulding (such as of thermoplastic elastomers, TPE), compression moulding (eg silicone rubber), injection (eg liquid silicone rubber) or cold cast (for example two part resin). Embedding electronic circuitry within the cable assembly is a cost effective alternative to on-board electronics. Most often referred to as ‘smart cables’ these embedded devices can solve many packaging challenges. Below left is pictured a two layer flex with overmold and wire attach.

Shielding: Where electromagnetic or electrostatic interference is an issue, shielding can be integrated into the Flex to reduce noise and control the impedance of signal lines. The most cost effective approach (and coincidentally the one which provides the most flexible construction) is to use silver polymer screens encapsulated with a screen-printed or photo-imagable covercoat. Metallised shielding films promise lower cost and greater flexibility than copper. Shielding can also be achieved with a layer of copper. Adding additional copper layers and etching them to create a cross hatch pattern allows more flexibility than standard copper-clad layers. Solid copper layers may increase the cost of the FPC and increase its bend radius (and consequently a reduction in failure risk).

Stiffeners: Bonded rigid layers are added where additional support is required, such as areas of component assembly or underneath exposed traces that will be plugged in for connection. Common stiffeners include polyimide and FR4 (regular glass-reinforced epoxy PCB material). Wire assembly: In certain applications a combination of flex or rigid circuit with traditional wire may be a more economical design.

Flex Attachment Method:

Wires, connectors, components, battery cells and so forth can be attached to the flexible PCB using a number of common methods, including:
Solder
Ultrasonic weld
Laser weld
Rivet
Lamination for attachments
Nickel tab to Copper flex pad
Nickel tab to Aluminium bus bar
Aluminium bus bar to battery cell
Connector (eg zero insertion force ‘ZIF’ type)

The card edge connector used for Arrival device connectivity utilises a PCB as one half of the connector. With the aid of a stiffener or as a rigid-flex, the harness can form the male contact, with the female receptacle on the device. Alternatively, the receptacle can be mounted on a reinforced flexible PCB, or on a separate PCB which is attached to the harness. Alternatively, bolted connectors can be used.

Flex assembled on top of five HV battery modules. Power PCB at the end shown as outline:

Through-Hole Connector

FIG. 4B provides a cross-section view through the Flex PCB 300 connected to the through hole connector of the HVBM 100. The stiffener through-hole Molex PowerEdge connector to the battery module is mechanically supported by the FR4 stiffener. Electrical connection is by solder of the through-hole connector pins directly on to the exposed pads via apertures in the coverlay insulation on the flexible PCB. The cross-section view illustrates the low profile of the Flex PCB 300, which has a low thickness by virtue of the high voltage that it conducts. For example, it is possible to provide a Flex PCB 300 having a total thickness of around 150 μm thick. The Flex PCB 300 includes layer of conductive material (e.g., copper), having a thickness (e.g., around 25 μm, around 50 μm, around 70 μm) selected based on the current that is to be conducted. Taken in combination with each HVBM 100 being low in height (e.g., 100 mm), this results in a battery pack 200 having a low profile. This in turn allows the battery pack to be installed in a chassis 400 of a vehicle having a floor that is substantially low. Furthermore, this allows a chassis 400 to be provided that is substantially flat, simplifying customisation of the vehicle interior.

Flex Termination

FIG. 2C shows a portion of the battery pack 200, with copper pads of the electrical contacts 310 shown exposed via apertures in the coverlay insulation. Solder paste is applied, the power board is located in position and the joint is heated and the solder reflows. Solder evidence is visible through plated vias in the power board. Alternatively, conductive adhesive (silver epoxy or z-axis anisotropic) is used.

Flex Battery Cell Attachment

FIG. 1G provides an image of cell attachment flexible PCB 164, for 18650 cells in automotive application. This piece was designed for 4 A continuous with max 50° C. allowable temperature rise. The copper measures 70 μm thick which is consistent with 2 oz gauge copper; alternatively 3 oz (105 μm thick) may be used. Total thickness including adhesive and two insulating layers of PEN is measuring at 270 μm. The max dimensions of the exposed pads are: Rectangular=5*7 mm; Crescent=5*7.5 mm.

Vehicle design employing Flex connector could make use of a flat PCB cable harness 300 with integrated sensors (e.g. using high speed surface mount techniques), the production and assembly of which can be fully automated, including pick-and-place of connectors and components, enabling a distributed architecture. Arrival HVBMs can be connected together using a Flex connector 300 which incorporates control electronics on a single piece. High current capable flexible PCBs could be used within the Arrival traction inverter and IDU-eliminating bus bars and cable assemblies, allowing the circuit to be folded into the space available.

Types of Flexible PCB

Single Sided (SS) Flex
Single conductive layer
Flexible substrate laminated with copper, etched with tracks, and sandwiched with coverlay for protection

Single Sided Flex with Double Access
AKA ‘back bared’ flex; flexible insulation layer is skived open using laser to allow for dual access to the single coper layer

Double Sided (DS) Flex
Two conductive layers, one on each side of the flexible insulator substrate
Copper plated though-holes can be used to make electrical connections between the two layers

Multi Layer Flex
Combination of several single sided or double-sided circuits with interconnections, shielding and surface mounted devices.
Laminations can be limited to local areas where they are required
Up to circa 20 layer is possible

Rigid Flex
Multiple flexible circuit inner layers selectively attached together using an epoxy pre-preg bonding film incorporating a rigid board externally, or
internally (or both)
Interconnected through plated thru-holes
Four, six, eight layers

Polymer Thick Film (PTF)
Conductor printed onto a polymer base film
Typically low-power applications at slightly higher voltages

Flex Rack Widths

| | 1 | 2 | 3 | copper thickness (oz) |
|---|---|---|---|---|
| 20 Amperes | 35 | 70 | 105 | copper thickness (μm) |
| Temp rise, 10 deg C. | 18 | 9.5 | 6.5 | track width (mm) |
| Temp rise, 24 deg C. | 11 | 5.5 | 3.6 | track width (mm) |

| | 2 | copper thickness (oz) |
|---|---|---|
| 100 Amperes | 70 | copper thickness (μm) |
| Bottleneck | 23 | track width (mm) |
| Sustainable run | 138.4 | track width (mm) |
| (Calculated) | 56.6 | track width (mm) |

Bend radius: Allow at minimum 6-12 times material thickness or 3 mm minimum static.

FIG. 4C shows a cross-section view of a PCB, which is formed from a number of layers, including a coverlay layer, a base copper layer, a polyimide layer, and a polyamide stiffener layer. These layers are joined together by adhesive. An electrical contact is provided by an exposed finger area, for which the coverlay layer is removed to reveal the base copper layer.

Stiffener: Bonded rigid layer(s) can be added to the outside of a flex where additional support is required, for example areas of component assembly or underneath exposed traces that will be plugged in for connection (such as card edge). Common stiffener materials include FR4 (regular glass-reinforced epoxy PCB material) and Polyimide.

While the present invention has been described with reference to embodiments, it is to be understood that the invention is not limited to the disclosed embodiments. The present invention can be implemented in various forms without departing from the principal features of the present invention. The scope of the following claims is to be accorded the broadest interpretation so as to encompass all such modifications and equivalent structures and functions.

9. HVBM Architecture

FIG. 5A illustrates a HVBM 100 containing the following components:

1. Cells 1660:—The actual energy storage elements which contain the electrochemical energy of the HVBM

2. Inner casing:—Composed of the lower and upper plastic cell carriers, holding the cells together

3. Outer casing:—Composed of the lid and lower cold plate, ensuring the thermal interface and seal of the HVBM from the environment

4. Cell connection Board 160a: PCB connecting all the cells together in a given series/parallel arrangement and embedding the cell balancing circuit

5. Interface board:

a. HV Board 160b: (a section of the) PCB containing all the HV power components between the cells and the HVBM external connection

b. LV Control Board 160c: (a section of the) PCB containing the control electronics monitoring the module and communicating with external systems

The architecture relies on three subsystems:
Cells monitoring: Measuring cells voltage and temperatures
HV control, including contactors and precharge circuit to switch the HV output on/off as well as HV measurement and current sensing
LV controls, comprised of the MCU with all the supporting components and a HW watchdog, the power supplies, the flash memory, the communication chips, IsoSPI and CAN. The LV inputs are protected and filtered using: a fuse; TVS; EMI filter and reverse polarity protection.

The HVBM is connected to the BMS and other HVBMs on the communication channel. The HVBM will receive switch on/off requests and provide status/faults information, as well as broadcast estimated available power to the network for the BMS to use.

In this example, the cell connection board 160a, the HV board 160b, and the control board 160c all form part of the PCB layer 161 shown in FIG. 1C. As an alternative, the functionality of the cell connection board 160a is performed by the balancing flex 163 and power flex 164, while the functionality of the HV board 160b and the control board 160c is performed by the PCB layer 161.

10. HVBM Operating Modes

The HVBM has the following operating modes:

OFF—Sleep mode: The HVBM is switched off the power network, only monitoring CAN wake up signal.

Off—Standby: The HVBM is switched off the power network, monitoring switch requests and providing status information.

ON—Precharge: The HVBM connects the precharge circuit to the power network to prevent current inrush.

ON: The HVBM is connected to the power network and delivering power (charge and discharge). Status is continuously updated and streamed on the communication network.

Service mode: The HVBM is operating in service mode only when the vehicle is stationary, providing overridden access to all functionality for power users to test.

11. HVBM Self-Monitoring Functions

Each HVBM 100 is capable of estimating its own operating state/status, each HVBM 100 being configured to actively monitor individual cell voltages; actively monitor discharge and charge current; actively monitor and provide an estimate of individual cell State of Charge (SOC); actively monitor and provide an estimate of the module State of Charge (SOC); actively monitor and provide an estimate of instantaneous available power; actively monitor and provide an estimate of total available power; actively monitor and provide an estimate of module remaining capacity; actively monitor and provide an estimate of module remaining energy; communicate state data with the external BMS; actively measure/estimate the temperature distribution within the module; aggregate and communicate temperature data to the external BMS.

Each HVBM 100 is capable of estimating its own State of Health, each HVBM 100 being configured to actively monitor individual cell resistance; actively monitor individual cell capacitance; actively estimate and monitor individual cell State of Health (SOH); actively estimate and monitor the HVBM's State of Health (SOH); actively estimate and monitor contactor State of Health (SOH); and communicate State of Health data with the external BMS.

Each HVBM 100 monitors its data connections, each HVBM being configured to actively monitor the connector interface with the HV bus; actively monitor connector connection status and the interface with the HV bus; and communicate connector status with the external master BMS (a BMS internal to each HVBM may also be used instead of an external master BMS (MBMS), or to compliment the external master BMS). The HVBM 100 is configured to monitor its own connector status through the connector interlock. HVBM 100 generally has to be able to monitor all its internal safety parameters to ensure it can operate without generating hazards.

Each HVBM 100 collects data, each HVBM 100 being configured to calculate and collect module statistical data; calculate and collect relevant component data; calculate and collect relevant warranty data; communicate collected data with the external MBMS or an internal BMS, if one is used.

Weld Detection: Several voltage sensors in the system allow the module to be aware if a contactor weld occurs using a special start up and shutdown routine.

Voltage Measurement: Voltage is measured on every cell and at the output of all cells. Voltage is also measured on the DC Bus to allow effective pre-charging prior to connecting to the DC bus and enhanced safety algorithms. The voltage sensor is placed after the contactors, nearer to the external circuit, in order to be able to measure external voltage, compare to the sum of the cells voltage for the precharge and main switch management. The voltage sensor is meant to be used as a cross check with the sum of cells voltage and therefore has to be accurate to within about 1V. The sum of cells voltage is accurate at worst to 0.4V.

Current Measurement: Current is measured on a module level. This allows accurate power flow mapping around the battery. The current sensor is Hall Effect based to avoid having to do unit by unit calibration, limit heat dissipation and avoid having to have an additional isolation barrier compared to a classic shunt sensor.

Internal Pre-charge: The internal pre-charge circuit uses PTC resistors to prevent current inrush when turning on voltage output. The precharge circuit is comprised of a third contactor which could be of a much lower current rating and a couple of PTCs, limiting the current and preventing overheating if the precharge is used too often. Also the resistance of the PTC can be estimated in situ from the HV and cells voltage sum measurement, as well as from the current sensor, giving an indication of the PTC temperature.

Cell Monitoring: For every pair of cells the temperature is calculated and the current and voltage is measured. This allows a highly accurate determination of SOC, SOH, and capacity.

Cell Balancing: Cells are balanced inside the module independently of other modules. This allows the battery to maintain optimal capacity throughout its life. Each HVBM monitors all of its cells and runs an algorithm to assess and manage self-balancing. The HVBM can passively discharge individual cells to self-balance.

Contactors: There are two contactors: one on each HV line, for safety reasons, in order to fully isolate the HV circuit from the vehicle. They are a 450 v 40 A rated contactor, on the output of each HVBM. One is on the negative output of the module and one on the positive output. This ensure that the module can achieve galvanic isolation from the vehicle in its off state. It has an additional advantage in that the battery module is safe for handling and transport because there is no external voltage present. The contactors are ultimately meant to be driven through PWM to spare energy in continuous mode, the driver supports up to about 1 kHz of PWM operation.

FIG. 5B provides a schematic of hardware of a HVBM 100 configured to perform the above functionality.

12. Master BMS

The master BMS (MBMS or simply BMS) is the interface from the battery pack to the rest of the vehicle. It automatically discovers and manages connected battery modules. The BMS operates completely independently from HVBMs in the network; uses a separate CAN Network for communicating with the EVC and the HVBMs; gathers information and data from HVBMs to compute. Battery level status and the BMS monitors the HVBM connectors status using HVIL loop(s).

BMS Specification:
100×200 mm grid sized component (conforms to the grid size architecture
8×CAN networks for up to 72 battery modules (more with CAN-FD)
Low voltage power control for modules
Communicates with isolation monitor
Automatic module discovery and management
Data analysis for state of charge and available power
Ethernet/CAN vehicle network interface and gateway
Manages over the air updates for battery modules
ASIL-D, ISO 26262 functional safety
Is black in colour for effective and predictable heat dissipation.

The BMS Reports the High Level Status Functions Values (HLSF) of the Aggregated Battery Pack as Follows:
Available power in charge in kW (every second)
Available power in discharge in kW (every second)
SOC in % (every second)
NAC—Number actively connected modules to the network (contactors and MOSFET enabled) (every second)
SOA status including: safety flag level (Normal Operation, Caution, Warning, Safety Critical) (every second) Min/max range (every second)
The BMS broadcasts the connector locking status of all the HVBM on the network, providing the module number and the connector status (0 for disengaged or 1 for engaged) accordingly.
The BMS broadcasts the state of health of the aggregated pack, for energy (SOHE) in % and for power (SOHP) in %, every 10 min or every time the value changes by more than 1% compared to the previously broadcasted value, whichever of the two happens first.

13. HVBM is Fault Tolerant and has an Internal Isolation Switch

The HVBM has a fault tolerant architecture: Within the battery module, (i) an integrated current sensor protects against over current conditions and (ii) cell wire bonding allows a fuse action for safety. Internal temperature sensors enable battery management to protect cells and optimise for efficiency and longevity. A ruggedised, shock proof and ingress protected enclosure with an integrated metal cooling plate, reduces the risk of penetration.

FIG. 5C illustrates an example implementation of the safe high voltage battery module in an electric vehicle, showcasing several modes of control and redundancy. Cells 166 are combined into a string 181 using (i) wire bonding which acts as a fuse in the event of an over-current condition, or (ii) Flex connectors. The condition of cells 166 is monitored using sensors 182, including temperature, voltage and current. The smart controller 183 maintains an understanding of the condition, state of health and state of charge of each cell 166 of the cell string 181 and can share this data with the vehicle 400.

The cell string 166 output primary switching is handled (in this example) by an IGBT 184: a high efficiency and fast-switching type of transistor. The IGBT 184 can vary the module output using pulse width modulation (PWM) for variable output, pre-charging onto the HVDC system, and inter-module balancing. The IGBT 184 is controlled principally by the smart controller 183, which through the use of an AND gate 185 also requires a suitable interlock signal. A constant signal voltage originating outside of the battery module 100 and conducted through a combined hybrid connector comprises an interlock loop 155 which is used to control and override the internal switches 184. This secondary switching 186 level ensures a connection to the vehicle 400 and is independently from the on-board systems to reduce the risk of fault contamination. Decoupling the HVBM connector 170 breaks the interlock loop 155 and disables output of the battery module 100; this interlock loop 155 can also be utilised to disable all other connected battery modules 100 and systems using the same interlock loop 155.

Where galvanic isolation is required and to prevent leakage current through semiconductor switches, a contactor or relay 187 can be used. This is operated by the smart controller 183 and is switched after the solid state devices, greatly reducing the risk of contactor welding as no current is switched. A further AND gate 188 results in galvanic isolation based on the signals received from the smart controller 183 and the interlock loop 155. In the event of contactor component failure, the smart controller 183 can monitor the weld detection feedback, disabling output of the battery module 100 and reporting the fault to the vehicle systems.

The use of a touch-safe connector and a robust, ingress protected ‘double insulated’ module enclosure offer a final level of protection for handling and maintenance.

Internal switches between the cell bus and the terminal output isolates the module, greatly improving safety for handling, transport and installation, as well as enabling ‘smart’ switching of the battery module. The internal switches can be triggered by a data signal 455 from the load, such as the electric vehicle on board controller 453.

An internally switched terminal output enables a module to behave as a pulse width modulated power inverter. Three modules can be used together to power a three phase AC induction motor, removing the need for an external power inverter and its associated efficiency losses. Modules can be pre-charged onto the HVDC system by PWM switching the terminal output. Module PWM switching reduces the requirement for low temperature variation (ΔT) across the module and between modules in an array.

Module enclosure can be shock proof and ingress protected giving greater flexibility for installation location, storage and handling. Integrated module cooling features further simplify installation.

14. HVBM has a Bypass Series Switch

Series cell bypass switching circuit: This feature relates to a system for switching battery cells within a series array, whereby specific cells can be disconnected from the array and bypassed such that the remaining array continues to deliver power at a reduced voltage. The battery array is a number of series connected batteries, each with an individual isolation and bypass circuit; such a system can be used as part of or in conjunction with a parallel array, in for example series-parallel or parallel-series.

The switchable cell bypass circuit array affords incremental terminal voltage control for output and for recharging as well as capacitance pre-charging of the HVDC system. The module can present a terminal voltage which is less than the sum of all of the cells by isolating a subset of cells from the array. This allows the module to match the terminal voltage to an input voltage, facilitating balancing between modules of different SOC, and charging from an input voltage which is lower than the sum of the cells. The terminal voltage can be adjusted in increments of constituent cell voltages; as this novel architecture allows for cells at dissimilar SOC, the adjusted voltage can be highly granular, especially with large cell arrays.

During charging, cells can be removed from circuit upon reaching maximum voltage, allowing for rapid ‘constant current’ charging of the module until all cells are fully charged, switching to slower ‘constant voltage’ only after all cells have reached saturation voltage and been switched back in to the array.

The circuit can be configured to switch cells between series and parallel configuration, maintaining constant power output at incrementally variable voltage. The circuit can be configured to output multiple concurrent voltages from a single cell array, delivering for example HV for main load and LV for auxiliary systems.
Output full string DC voltage or at reduced DC voltage
Output AC alternating current (multi-step square wave)
Capacitance pre-charge of HVDC system by ramping up terminal voltage
Match other modules at different SOC by matching terminal voltage
Output multiple concurrent voltages from a single module
Charge at full string voltage or at reduced voltage to match input
Charge from variable voltage input

Each cell can be individually disconnected from the array, allowing measurement of open circuit voltage (OCV) for more accurate SOC determination. Cell duty can be managed by isolating individual cells from the series array, balancing all cells to equal state of charge (SOC) in any state of health (SOH). True lossless balancing can be achieved—a significant advancement over the state of the art. This technique is especially well suited to high voltage arrays where a large number of ‘boost’ transformers would be required to achieve active balancing. Software level battery management provides an opportunity for many intelligent control algorithms to be used to maximise cell life and capacity without hardware changes.

Multiple modules with different SOCs can be used simultaneously without the need for pre-balancing. Unlike in the state of the art, the module is not limited by the weakest cell, and the full capacity of each and every cell can be utilised—both in charging and discharging—regardless of age, temperature and health condition. This reduces requirement for low temperature variation (ΔT) across the module and between modules in an array.

It also provides an opportunity for precise data gathering on individual cells, for data analysis, batch performance analysis, and battery management algorithm improvements, and for “boost mode”. This incorporates variable cell redundancy, with higher reliability achieved through isolating faults or cell failures.

Example switching devices include but are not limited to transistor, FET, MOSFET, IGBT, thyristor, relay or vacuum tube. One signal line and two MOSFETs are used to switch out and bypass individual cells in series. Circuit design leverages conventional cell balancing chip to read voltages and control switching matrix.

FIG. 5D illustrates a bypass for a cell. Each cell is connected to a ‘double throw’ switch which is controlled by a switchable signal. When the signal is high, the switch closes the circuit through the cell, connecting the cell in series. When the signal is low, the switch opens on the cell closing the bypass loop and isolating the cell.

FIG. 5E illustrates a number of cells of the HVBM. These cells are connected in series, each with a ‘double throw’ switch, controlled by a switchable signal. In this example, Cell 2 has been bypassed delivering a reduced string voltage equal to VV+=VVCC1_+VVCC3_+VVCC4_. By over-specifying the number of cells required to deliver the string voltage (in this case by 4:3), one cell can be switched out in turn, sharing the workload between all cells. By varying the duty of each cell (the ratio of time each cell is in use compared to the time the cell is in bypass), this technique can be used to balance the charge between cells. For example, cells with a higher state of charge (SOC) can be used for a greater portion of time than cells with lower SOC; bringing all cells closer to equilibrium. This same technique can be used to take care of cells with lower state of health (SOH) or which have a higher temperature.

FIG. 5F illustrates cells connected in parallel, which serves to increase current; the principle of the switching circuit is not affected by the quantity of cells connected in parallel. The switch must be capable of carrying the full string current. Several cells are arranged in series, summing to the total string voltage. Each series cell is individually controllable with a dedicated switching signal.

FIG. 5F further illustrates an implementation of the cell switching principle using P and N channel transistors as switches. P channel transistors are normally closed—i.e., are conducting, whereas N channel are normally open, i.e., not connected. This means that all cells are bypassed until switching signal is received. One switch signal per cell simultaneously switches both transistors, connecting the cell into circuit.

15. Lid Connectors to the Flex Power Conduits

The lid includes connectors to which the flexible power conduits are attached, to enable each HVBM to be connected to other HVBMs in the battery pack. The connectors are provided in the recess, with the production method above explaining how molten material is injection moulded to form a housing having an optimal finish and structural integrity.

FIGS. 1D-1E illustrate examples of the terminals 170 of the HVBM 100. The provision of the HVBM electrical contacts in a recess 116 serves to accommodate corresponding electrical contacts of a power cable 300, such as the Flex power cable. The recess 116 has an increased radius of curvature compared to the other edges of the HVBM housing, which serves to protect the power cable 300, by ensuring that the power cable is not bent out of shape. Furthermore, the selection of the shape of the HVBM housing 110 means that the assembly of a battery pack 200 by robots is more easily achieved. Before being installed, the recess 116 accommodates a cover 120, which protects the electrical contacts 170 of the HVBM 100.

In addition to the recess that includes the HVBM electrical contacts, the HVBM housing may include additional recesses that accommodate and protect the Flex power cable. As an example, an additional recess is provided opposite the recess that includes the electrical contacts, which facilitates a Flex PCB that is arranged to cross the top face of the HVBM lid. As a consequence, the radius of curvature is increased on both sides of the HVBM lid, and so the Flex PCB is protected at both edges of the HVBM housing that the Flex PCB encounters. Thus, disclosure is provided of one or more recess configured to receive the Flex PCB (e.g., a recess is provided that includes terminals configured to be connected to corresponding terminals of the Flex PCB).

FIG. 1F illustrates the electrical contacts 170 of a HVBM 100. The 2 NC pins are used for detecting the connector cap is in place. These should be used to bolt down a cap. Thus, the HVBM includes a connector cap configured to perform integrity monitoring. In addition to providing high voltage power via the HV+ and HV− pins, HVBM is configured to provide low voltage power via the LV+ and LV− pins. Safety is enhanced by monitoring the power output from these pins. Disclosure is provided of a HVBM that includes high voltage power monitoring. Disclosure is further provided of a HVBM that includes low voltage power monitoring. The action of bolting down the cap should connect these 2 pins together electrically as well as securing the cap in place. This allows the module to switch OFF if there is no cap present.

16. Detecting a Loosening Connector

There is a primary requirement to maintain reliable connections for HVDC networks. Also, because there are so many HV connectors in the system (20-100 depending on the vehicle platform), that drives the requirement for a reliable connection even higher. But a loose HVDC connector is a hazard, so the system has to monitor the HV connectors status and take the relevant actions when they get disconnected. The system therefore monitors all the HVDC connectors and can act to prevent arcing, overheating and electric shocks from loose contacts. It can suppress current flow through a connector that gets disconnected by switching off the relevant part of the circuit. When a connector starts to disengage, the current flowing through it has to be brought to zero to avoid producing an arc. When the connector starts to disengage, the current flow is brought to zero or as close to it as possible to avoid connection (over)heating. When the connector is fully disconnected, depending on the situation/connector type, it may be recommended to bring the voltage to a low value within a reasonable time (typically below 60V within a few seconds) to avoid electric shocks.

As a particular application, we will look at the HVBM—Flex PCB (FPC) connection.

The HV connector is a PowerEDGE type connector, male on the module side and female on the FPC side or a bolted connector. In a typical vehicle application, there is going to be an array of modules connected together through the system FPC in a parallel arrangement.

In this case, it is not a safety concern for one module to get disconnected without warning as this is not going to cut off the system level power. Therefore, the module can and should stop providing current when a connector loosen, signalling this to the system (master BMS in this case).

FIG. 4D illustrates a module edge connection between a HVBM 100 and a Flex PCB 300. The battery pack 200 includes an electrical terminal 170 of the HVBM and a corresponding electric terminal 310 of the Flex PCB 300.

The edge connector includes a HVBM connector interlock 155. The Module interlock loop 155 for detecting and disconnecting the module 100 with the loose connector instantly.

Optionally, the edge connector includes a system high voltage interlock loop 555. The system optional HVIL loop 555 is configured to detect the connector getting disconnected. It is optional, because the battery module 100 will have taken action already, and the system can figure out which module 100 is being disconnected based on which battery module is sending an error message or dropping off the communication line.

17. Overall System Architecture

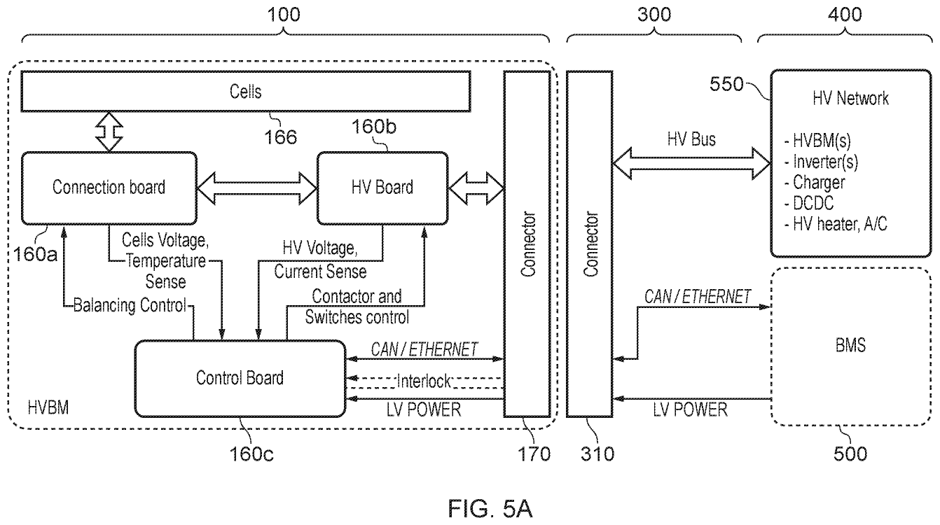

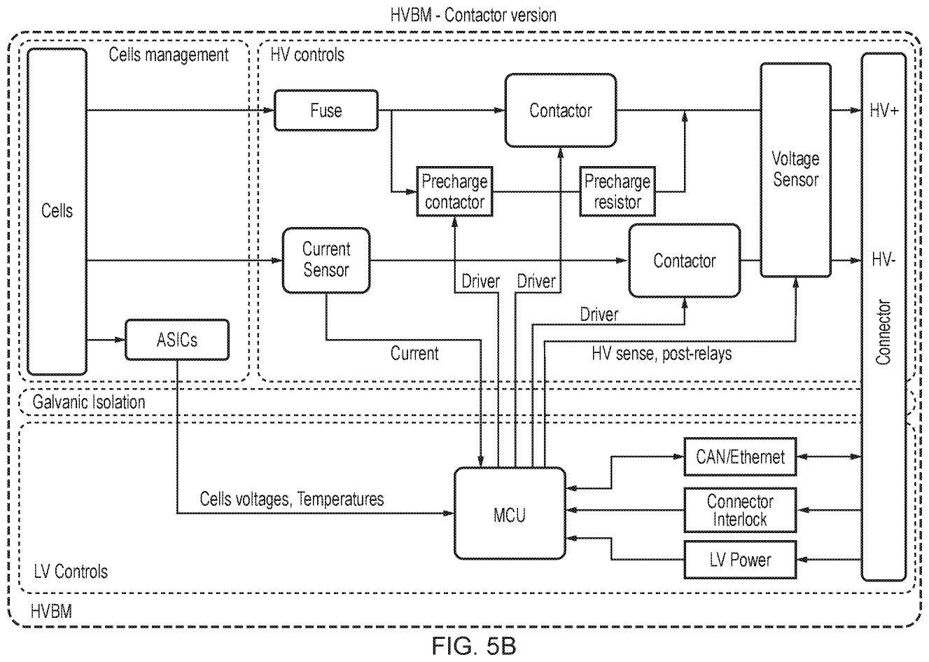

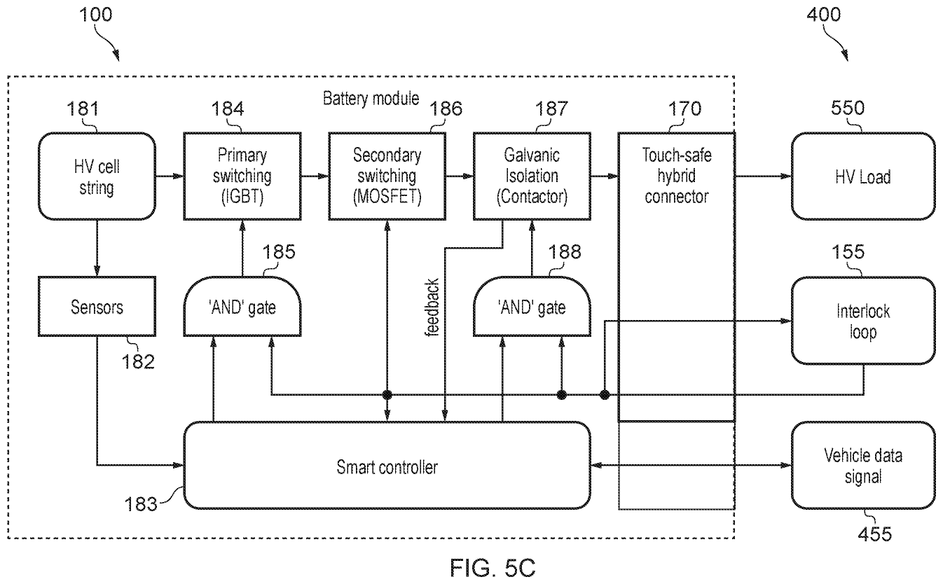

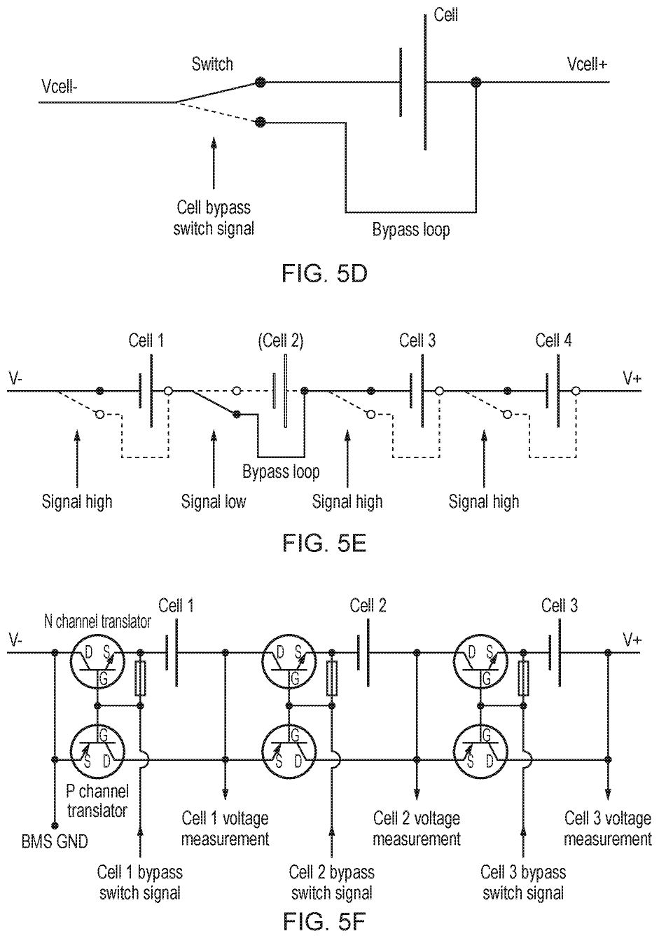

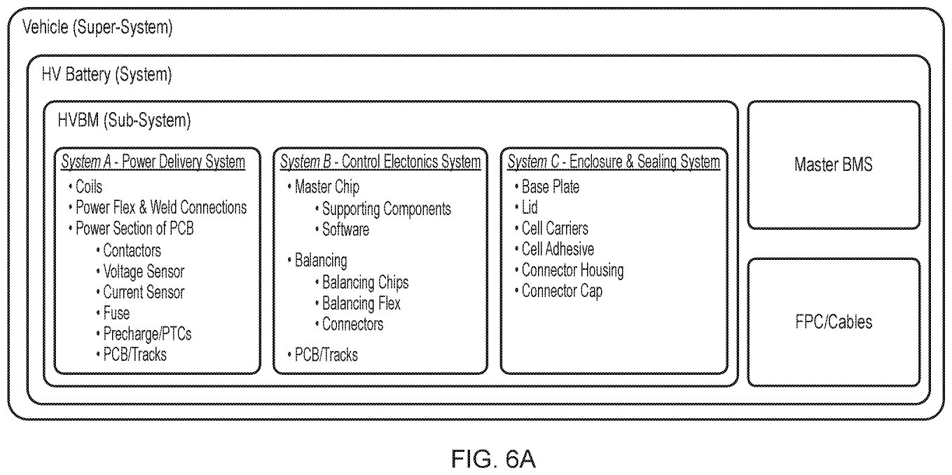

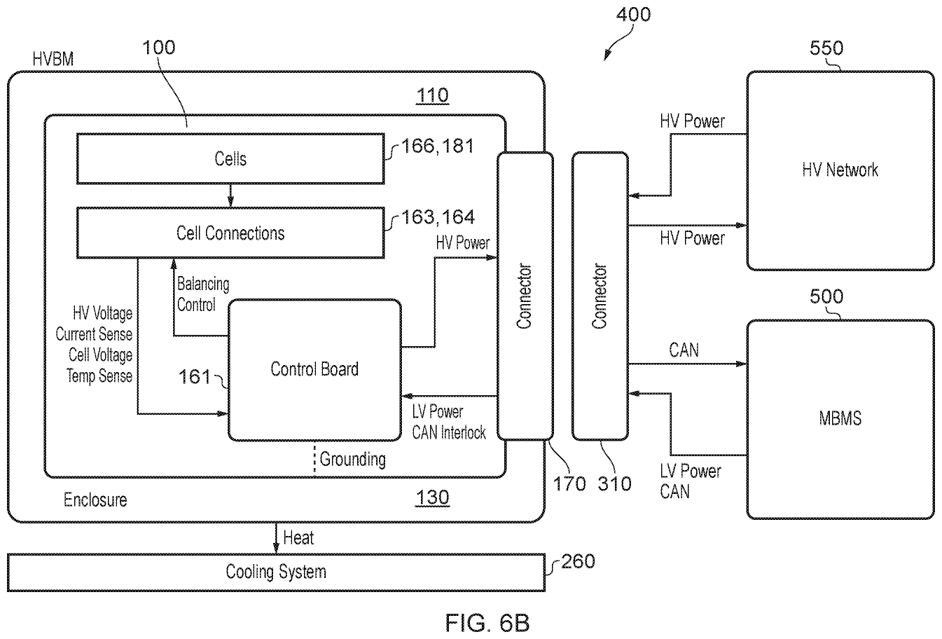

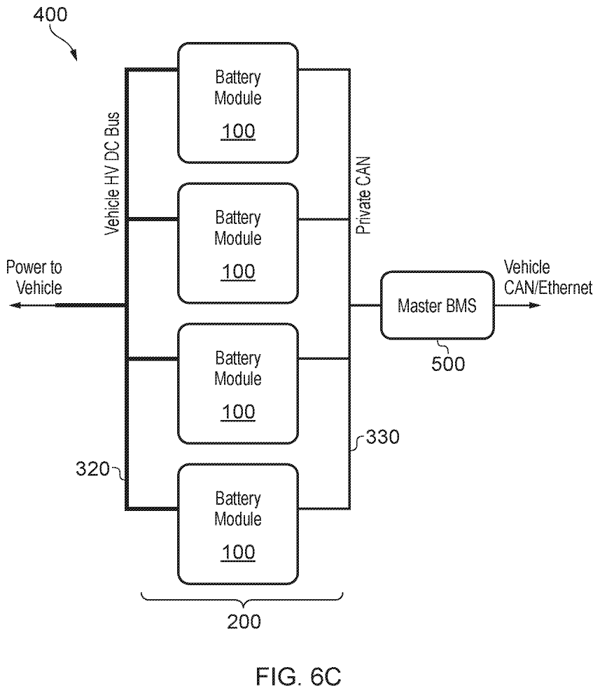

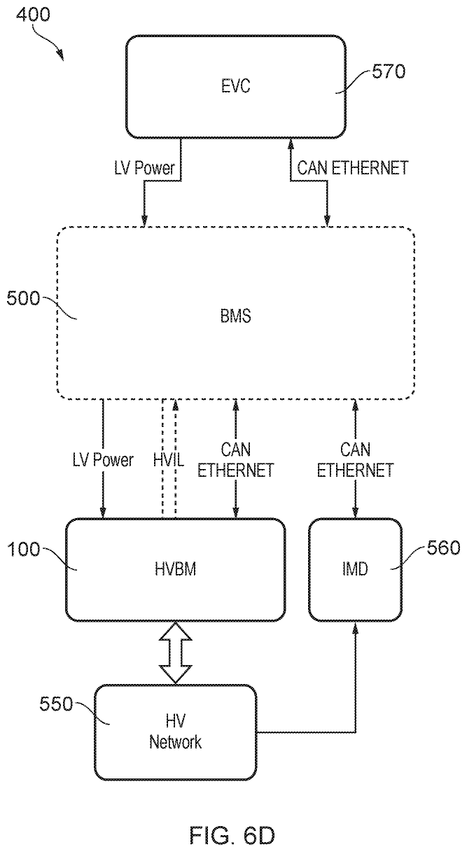

We have in preceding sections looked in detail at the HVBM and the BMS. We will now look more broadly at the entire power system. FIGS. 6A-6D illustrate electrical connections within a vehicle (super-system) 400 that includes a high voltage battery pack (system) 200 formed from a number of battery modules (sub-system) 100.

FIG. 6C shows a number of HVBMs 100 connected in parallel to form a battery pack 200 of a vehicle 400. The Flex PCB 300 includes high voltage power cables 320 and low voltage power cables 330. The high voltage power cables contribute to a vehicle high voltage direct current bus 320 configured to provide high voltage power to the vehicle. The low voltage power cables contribute to a private controller area network (CAN) bus 330, which connect to the master BMS 500.

FIG. 6D shows that the HVBMs 100 are connected to a CAN, LV input (8V to 30V) and HV outputs. The private CAN network connects to the BMS 500; the BMS 500 monitors the performance and state of each HVBM 100 in the battery pack 200 and can instruct each HVBM 100 to turn off and on, and connect or disconnect from the DC bus, enter or emerge from sleep mode. The BMS 500 communicates to the vehicle via CAN or Ethernet.

The vehicle 400 includes an electric vehicle charging (EVC) system 570 configured to communicate with the BMS 500 via CAN or Ethernet, and provide low voltage power to the BMS 500. The BMS 500 is configured to supply low voltage power to each HVBM 100 of the battery pack 200. The HVBM 100 provides high voltage power to a high voltage network 550. The vehicle 400 includes an integrated motor drive (IMD) system 560 configured to receive high voltage power from a high voltage network 550 and communicate with the BMS 500 via CAN or Ethernet.

The Overall System has the Following States:
Switched off mode. The HV Power System does not work. There is no energy provision, no information exchange.
Standby mode. The Master BMS PCB is powered. Information exchange keeps going at the relevant interfaces. HV Power Modules are disconnected from the HV bus.
Normal working mode. HV Power connected. The HV Power System operates normally. Energy provision and consumption are performed according to control commands and embedded control algorithms.
Fault mode. Energy provision is not performed, the Master BMS PCB is powered but HV Power Modules are disconnected from HV bus. Fault message is transmitted via information interface.

The Main Components of the HV Power System are:

Master BMS: PCB that implements control algorithms for operation of the HV Power modules (HVBM), providing interaction via CAN bus with other vehicle devices.

HVBM (n counts): smart HV Power Modules with PCB inside each module. HVBM PCB implements measurement and control functions of Cell Block voltage, current and temperature, providing communication to Master BMS via CAN bus.

Connectors: interface slots to connect information exchange networks, LV supply and power terminals.

18. Lid Production and Connector Design

In order to protect the safety-critical electronic components inside the HVBM, and to facilitate safe storage, handling, and installation of individual HVBMs, each individual HVBM is packaged in an outer shell or lid that is configured to enclose the array of rechargeable cells and the safety-critical electronic components inside each HVBM. The lid is made using a four gate valve system injection moulding system. Using 4 valves to flow the molten plastic allows a more even distribution of plastic at the same temperature, so it prevents curing at different rates, which could otherwise lead to defects. It is possible to sequence the flow through the 4 gates to keep the front of the molten plastic at the same temperature. Timing the flow sequence allows control of any defects to occur in places that are less prominent. Minimising defects is important because the lid provides structural integrity, since HVBMs may be stored on top of one another; it also provides flame resistance, containing any thermal runaway event.

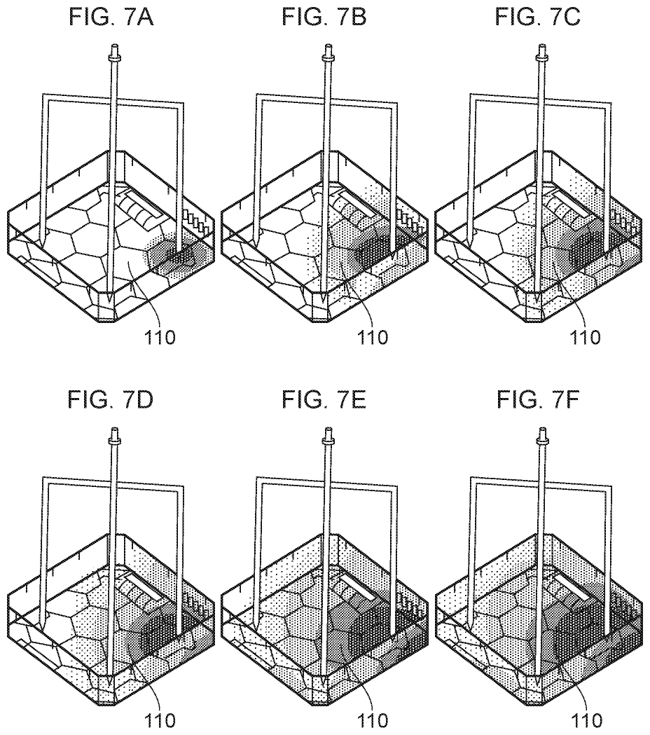

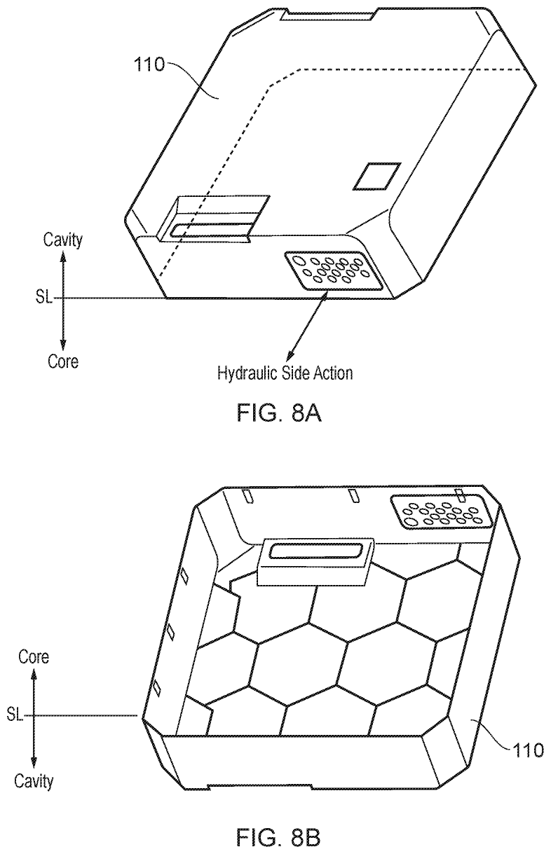

In general terms, the outer shell or lid is formed by injection moulding of molten material via a plurality of gate valves, each gate valve being sequenced to control curing of the material. FIGS. 7A-7F show the injection moulding of molten material into a mould that confers the shape of the outer shell or lid 110 of the HVBM. This results in the outer shell 110 as shown in FIGS. 8A-8B.

The injection moulding process begins with a single gate valve of the plurality of gate valves providing molten material into the mould. This molten material spreads out within the mould, cooling as heat is dissipated to the external environment, which results in curing of the material. When the molten material encounters a feature, the direction in which the molten material spreads out is changed by the feature. As an example, the HVBM includes a recess having an opening, which is formed by the molten material separating into two separate flows which surround the opening, and rejoin once the opening has become completely surrounded by molten material.

When the separate flows rejoin to make a single flow, this results in a defect of the cured material, due to the flows being at different temperatures. This results in a weld line, which is more visible when a finer surface finish is obtained. The injection of molten material is controlled by sequencing additional gate valves, so that they inject molten material in a sequence ensuring that the two separate flows rejoin to make a single flow at a chosen location, and at a high temperature. Preferably the temperature of the separate flows is as similar as possible. To improve the appearance of weld lines, the melt front temperature is kept high, and it is found that four valve gates helps to achieve this.

When the flow of the molten material reaches another of the gate valves, that gate valve begins injecting molten material into the mould. The gate valves are sequenced to inject molten material at a rate that provides the best possible finish for the finished product, thus preventing visual defects such as weld lines, flow lines and sink marks being located on visual surfaces. The sequencing of the gate valves ensures that the flow of molten material occurs at a consistent rate, and so cools at a consistent rate.

Sink marks are a further defect that is prevented by making use of a plurality of gate valves. The above image shows the housing from above and below. A lower surface of the housing includes ribs, which act to stiffen the top of the lid, so that the housing is configured to support itself, without additional support being provided by internal components of the HVBM. The pattern of ribs is designed to avoid assembly collision with the lid supports and components on the BMS PCB that protrude significantly from the top surface. The pattern of ribs changes such that the ribs exist around where the balancing flex connectors exist in the assembly to avoid risk of the ribs colliding with the connectors. The ribs are illustrated in a hexagon arrangement, which confers strength to the surface. The ribs on the underside of the one or more recess act to strengthen the one or more recessed section, which acts to significantly reduce the risk of the lid experiencing a bowing effect when the sealing lip interfaces with the connector housing gasket

A reduction of sink marks is achieved by decreasing the thickness of ribs on the interior of the housing. The housing has a number of ribs, which have a thickness in the range of 1.2 mm to 1.67 mm. It is found that ribs having a lower thickness, such as 1.2 mm minimise the sink marks that are found on the top outer face of the HVBM housing. It is possible for the thickness of the ribs to be subsequently increased, after the HVBM top outer face has formed, thus minimising sink marks while enhancing strength of the housing.

As a consequence, the structural integrity of the HVBM outer shell or lid is enhanced. Examples of how the sequencing of flow of injected material enhances production of the HVBM housing includes: a reduction of shear stress; a reduction of volumetric shrinkage; a consistent density; a consistent cooling temperature to achieve a consistent finish; reduced welding lines; selected location of welding lines; reduced sink marks; and reduced warpage. For each of these examples, the sequencing of flow of injected material is modelled along the x-axis, y-axis, and z-axis, thus enhancing structural integrity in all directions. The lid is black in colour for effective and predictable heat dissipation (other components in the Arrival system are also black in colour, for the same reason).

19. Battery Pack Assembly

The HVBM production process flow is implemented, in whole or part, using robofacturing within a micro-factory. Similarly, the battery pack and other components of the vehicle are produced within the micro-factory by robofacturing.

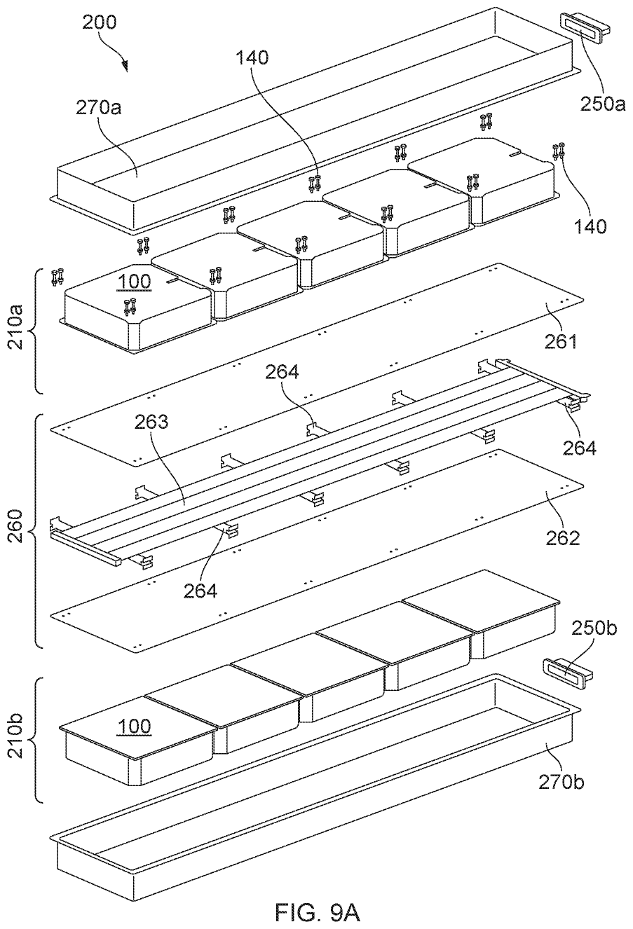

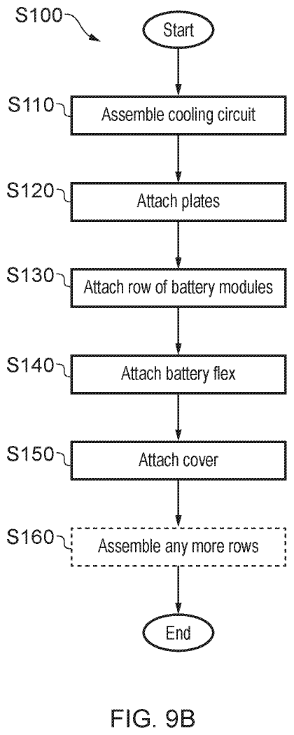

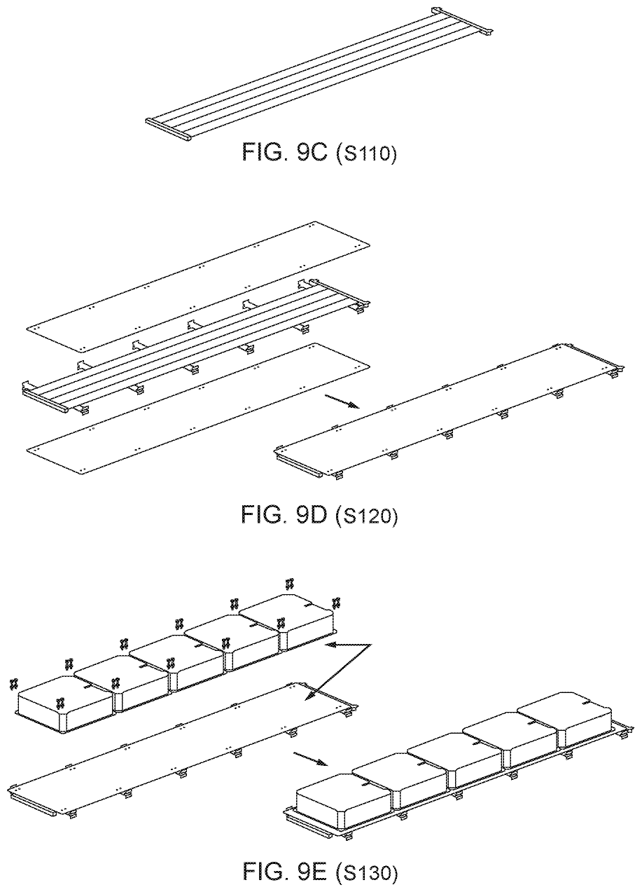

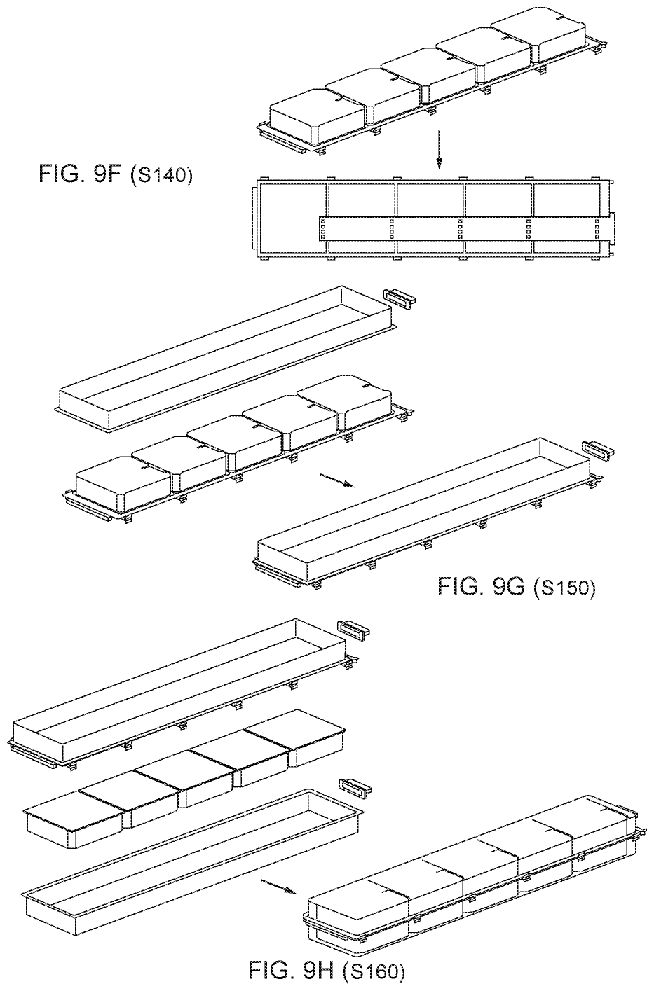

A small car might use a battery pack with a top row of 5 parallel connected HVBMs sitting over a bottom row of inverted 5 parallel connected HVBMs. FIGS. 9A-9H illustrate a production technique of such a battery pack 200, with FIG. 9A providing an exploded view of the battery pack, FIG. 9B providing a flow diagram explaining the details of the production process, and FIGS. 9C-9H providing progressive views of assembly of the components of the battery pack;

FIG. 9A shows an exploded view of the battery pack 200 which includes a plurality of battery modules 100, a plurality of battery module fasteners 140, a plurality of electrical connectors 250, a cooling plate assembly 260, and a housing 270. The plurality of battery modules includes a top row of battery modules 210a and a bottom row of battery modules 210b. The battery modules of each row 210 are electrically connected to one another by a flexible Printed Circuit Board (Flex PCB) 300, and electrically connected to the rest of the vehicle via a battery pack connector 250. Bespoke dimensions of the Flex PCB 300 are configured to the specific vehicle being designed.

The cooling plate assembly 260 is provided between the row of battery modules 210 and the bottom row of battery modules 1130b. The cooling plate assembly 260 comprises a cooling plate top sheet 261, a cooling plate bottom sheet 262, a cooling circuit 263, and a plurality of T-slot connectors 264. The battery pack is held together by the battery module fasteners 140.

FIGS. 9B-9H Illustrate a Production Method S100 of the Battery Pack:
In a first step, cooling tubes of the cooling circuit 263 are assembled to form a manifold (S110, FIG. 9C), which is achieved, for example, by brazing.
In a second step, the manifold 263 and T-Slot connectors 264 are assembled to the upper and lower cooling plates 261, 262 (S120, FIG. 9D), thus forming the cooling assembly 260. This is achieved for example by brazing, adhesives or screws.
In a third step, the top row of battery modules 210a is connected to the cooling assembly base plate 261 (S130, FIG. 9E). To achieve this, a thermal interface paste is applied to the top of the cooling plate 260, and then the top layer of battery modules 210a is bolted to the cooling plate 260. A plurality of module fasteners 140 (e.g., nuts and bolts) attach the components of the cooling plate 260.
In a fourth step, an electrical connection is provided between the battery modules 100 of the battery pack (S140, FIG. 9F). This is achieved by connecting a Flex PCB 300 cable to each of the battery modules in the row 210a.
The Flex PCB 300 is shown connecting 5 HVBM of the platform in a ‘tram-line’ configuration. A bespoke Flex PCB 300 is produced for the specific configuration of HVBM 100, so that all electrical connections of the Flex PCB 300 line up with the electrical connections of each HVBM 100 in the battery pack 200. This simplifies assembly, as once the HVBM are in place, they can be electronically connected by forming the electrical interface with the rest of the vehicle.
The Flex PCB (interconnect Flex) 300 provides the sole electrical interface between the HVBM and the rest of the vehicle. The Flex 300 performs high voltage power distribution to a load, as well as low voltage power distribution to components such as the battery management system.
In a fifth step, a housing 270a is applied to the battery pack (S150, FIG. 9G). The end of the Flex PCB 300 is attached to the electrical connector 250a. The top cover 270a is attached to the base plate using screws or removable urethane adhesive.
In a sixth step, the procedure is repeated for the bottom row of battery modules 210b (S160, FIG. 9H). Thus, the bottom row of battery modules 210b is connected to the cooling assembly base plate 260 by the plurality of module fasteners 140 (e.g., nuts and bolts) (S130, FIG. 9E), then the electrical connection is provided between the battery modules 100 of the battery pack (S140, FIG. 9F), then the housing 270b is applied to the battery pack (S150, FIG. 9G). If a bottom row of battery modules 270b is not provided, then this procedure is not performed.
The production of a bespoke battery pack 200 for the specific vehicle is simplified because shared components are connected by applying shared techniques. The assembly of these components by robots enhances safety, so that engineers have reduced exposure to the high voltage of the HVBMs.

Various other battery pack sizes are available, such as:

20 Module Pack (2×10 HVBM Grid)

Capacity: 74 kWh

Range: 100 km to 120 km

Charge Time (22 kW): 3 hrs 50 mins

Fast Charge Power: 80 kW

30 Module Pack (2×15 HVBM Grid)

Capacity: 111 kWh

Range: 150 km to 180 km

Charge Time (22 kW): 5 hrs 30 mins

Fast Charge Power: 120 kW

40 Module Pack (2×20 HVBM Grid)

Capacity: 148 kWh

Range: 200 km to 240 km

Charge Time (22 kW): 7 hrs 10 mins

Fast Charge Power: 170 kW

FIGS. 10A-10D illustrate a vehicle platform 400 including a battery pack 200. FIGS. 10A-10B illustrate the installation of a battery pack in a skateboard platform of an Arrival Car (see Section J of PCT/GB2021/051519). FIGS. 10C-10D illustrate the installation of a battery pack in a chassis of an Arrival Bus (see Section K of PCT/GB2021/051519).

FIG. 10A shows the chassis 400 into which the vehicle battery pack 200 has been installed. FIG. 10B shows the vehicle platform 400 in a robotic production environment 1000, the ‘microfactory’, which includes a number of robots (1001, 1002) configured to install components of the vehicle such as the battery pack 200. The battery pack 200 illustrated by FIG. 10A depicts an example of a battery pack 200 for which twenty battery modules 100 are arranged in a 4×5 grid. The battery pack 200 illustrated by FIG. 10B depicts an example of a battery pack 200 for which the HVBM 100 are arranged in a 3×3 grid.

FIGS. 10C-10D show another robotic production environment 1000, in which an array 200 of twelve battery modules 100 is slid from the side into the chassis or skateboard platform of the Arrival Bus (see Section J of PCT/GB2021/051519). HVBMs can not only provide power for vehicle traction, but can also be used for domestic and industrial energy storage, and as part of a renewable energy system.

20. HVBM Sends and Receives Data Over a Crypto-Network

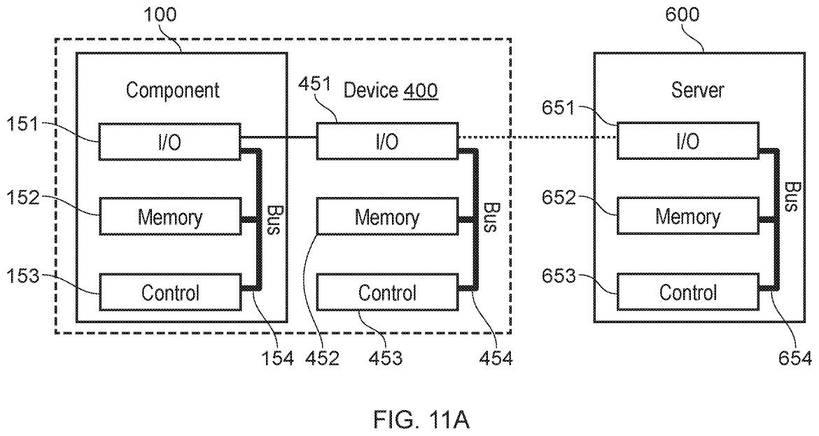

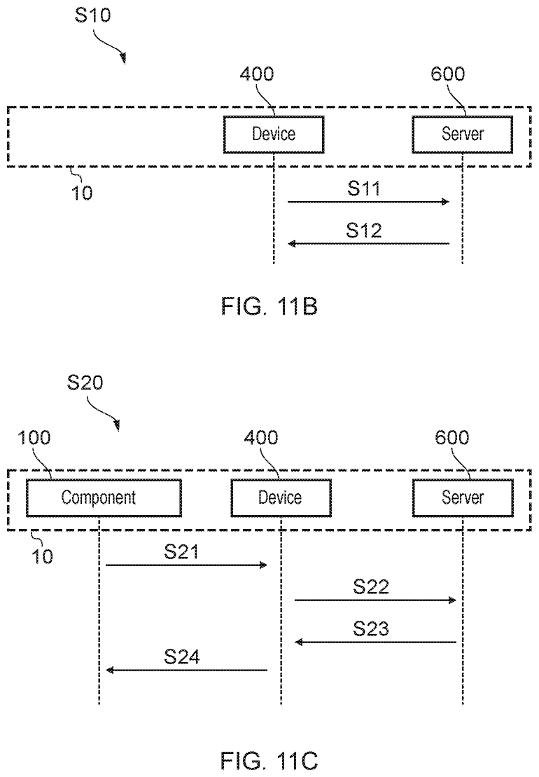

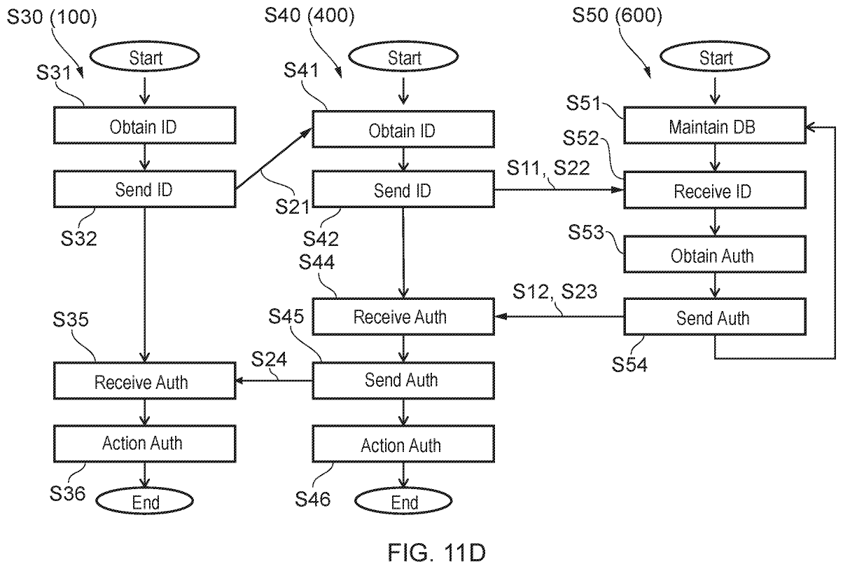

Following Plug and Play principles of the Arrival system and components, once an Arrival component is plugged into an Arrival vehicle, device or system, it will start functioning easily and automatically without configuration or modification of the existing system. As mentioned above, this is fully applicable to HVBM and its functioning once it is plugged into an Arrival vehicle. At that, cyber security requirements might be conflicting with the task of providing Plug and Play functionality for vehicle components. FIGS. 11A-11D illustrate data connections between a vehicle and a server.

Modern vehicles are cyber-physical systems, i.e. engineered systems that are built from, and depend upon, the seamless integration of computational algorithms and physical components, and cyber security vulnerabilities could impact safety of life.

Multiple authorities and regulations all over the world cover vehicle cyber security to ensure that systems are designed free of unreasonable risks to vehicle safety, including those that may result due to existence of potential cyber security vulnerabilities. It is thereby required to continuously enhance vehicle cyber security to mitigate cyber threats that could present unreasonable safety risks to the public or compromise sensitive information such as consumers' personal data. The Arrival system envisages a unique approach to cyber security of Arrival vehicles and vehicle components as described below.

The conventional approach is based on a vehicle network being treated as a trusted environment, whilst everything outside the vehicle is treated as untrusted. The Arrival system, instead, treats the vehicle network as an untrusted one. Thereby, all communications between components using the vehicle network are encrypted, and components do not accept commands from other components without verification or authentication. As a result, vehicles and vehicle components are prevented from an unauthorized use, and personal data as well as valuable analytics or diagnostics data of the vehicle are prevented from an unauthorized access. The Arrival cyber security approach is described in more detail below.

System Arrangements

FIG. 11A provides a schematic view of the hardware used to connect the devices. A device 400 (eg. a vehicle) is a member of a connected system. The device 400 includes a number of components 100, such as HVBMs. Each component 100 (eg. HVBM) is configured to communicate with the device 400 (eg. the vehicle). The server 600 (e.g. provided by a cloud service) is configured to communicate with the device.

The component 100, the device 400, and the server 600 have corresponding architectures that facilitates their communication. The component comprises an input/output unit (I/O) 151, a memory 152, and a control 153, each of which is configured to communicate via a bus 154. Similarly, the device 400 comprises an input/output unit (I/O) 451, a memory 452, and a control 453, each of which is configured to communicate via a bus 454. The server comprises an input/output unit (I/O) 651, a memory 652, and a control 653, each of which is configured to communicate via a bus 654. Each of the component 100, the device 400 and the server 600 includes a processor that functions as the control. The I/O 151 of the component is configured to communicate with the I/O 451 of the device. The I/O 451 of the device is configured to communicate with the I/O of the server 651.

The memory 152 of the component includes identity information. The identity information includes a unique name of the component. The identity information may further include attribute information that provides details of how the component is configured. The identify information includes at least one of text, numerals, and a machine readable code (such as a bar code, QR code, microchip). As an example, the identify information includes a blockchain that enhances traceability by tracking how each component has previously been deployed. Security is enhanced by providing identity information that is encrypted. The identity information stored by the memory may also be presented by a label attached to the housing of the component.

Provision of the I/O 151 and the memory 152 as part of each component allows each component to serve as an independent unit that can be transferred from one device to another device. As an example, the HVBM includes an I/O 151 and a memory 152. The memory 152 of the device stores identity information of the device, together with identity information of one or more components (eg. HVBM) that have been registered. For each electrical component (eg. HVBM), the memory of the device stores an indication of whether that specific component (eg. HVBM) is authorised to be used by the device. The memory of the server stores a database that specifies whether electrical components (eg. HVBM) have been authorised for use. Each individual device 400 and each individual electrical component 100 (eg. HVBM) is stored on the database 652 of the server 600.

The control 653 of the server is configured to retrieve information from the database 652, and update the database 652. Accordingly, the control 653 of the server is configured to determine whether the device 100 and the electrical component 400 is authorised. Furthermore, the control 653 is configured to update the authorisation of whether the device 100 and the electrical component 400 is authorised.

The server 600 is remote from the device 400. The server 600 is considered a “cloud server”, because functionality of the server is distributed via the internet across a number of servers. The provision of a cloud server 600 enhances resilience, preventing vulnerability to the performance of an individual server. Furthermore, the distributed nature of the cloud server across a number of locations facilitates communication between the cloud server 600 and a mobile device 400, and is particularly beneficial to enhancing communication between the cloud server and a large number of distributed devices. As an alternative, the server 600 is a specific individual server.

Registration & Authorisation

FIG. 11B provides an overview of a communication method S10 used by the system 10 to establish whether the device (eg. vehicle) is authorised. In step S11, the device 400 transmits the identification information of the device 400 to the server 600. In step S12, the device 400 receives confirmation of whether the device 400 is authorised for use.

FIG. 11C provides an overview of a communication method S20 used by the system 10 to establish whether the device (eg. vehicle) is authorised to use the component (eg. the HVBM). In summary, identification information is passed from the component 100 to the device 400 to the server 600 (S21, S22), and then authorisation information is passed from the server 600 to the device 400 to the component 100 (S23; S24). In step S21, the component 100 registers identification information with the device 200. In step S24, the electronic device 400 confirms to the component 100 whether it is authorised to be used by the electronic device 400. In step S23, the device 400 transmits the identification information of the component 100 to the server 600. In step S24, the device 400 receives confirmation of whether the component 100 is authorised to be used by the device 400.

FIG. 11D provides further detail of the authentication method. The registration and authentication process is illustrated from the perspective of the component (left, S30), the device (centre, S30), and the server (right, S50).

Regarding the method (S30) from the perspective of the component 100:
In step S31, the control of the component obtains the identity information (ID) from the memory of the component.
In step S32, the control instructs the I/O of the component to send the identity information (ID) to the I/O of the device (S21), wherein upon receipt of the ID information by the device, the ID information is stored in the memory of the device. As a consequence, the component is considered to be registered by the device.
In step S35, the I/O of the component receives authorisation information (Auth) from the I/O of the device (S24).
In step S36, the control of the component actions the authorisation information. If the component is authorised, then operation of the component is permitted. If the component is not authorised, then operation of the component is restricted.

Regarding the method (S40) from the perspective of the device 400:
In step S41, the control of the device obtains the identity information (ID), from the memory of the device, wherein the ID information relates to the device itself (S10), or the component (S20).
In step S42, the control instructs the I/O of the device to send the identity information (ID) to the I/O of the server (S11, S22).
In step S44, the I/O of the device receives authorisation information (Auth) from the I/O of the server (S12, S23).
In step S45, the I/O of the device sends the authorisation information (Auth) to the I/O of the component.
In step S46, the control of the device actions the authorisation information. With respect to authorisation of the device (S10), if the device is authorised, then operation of the device is permitted, whereas if the device is not authorised, then operation of the device is restricted. With respect to authorisation of the component (S20), if the component is authorised, then operation of the component is permitted, whereas if the component is not authorised, then operation of the component is restricted.

Regarding the method (S50) from the perspective of the server 600:
In step S51, the control of the server maintains the database (DB) stored by the memory of the serve, which associates identity information (ID) with authorisation information (Auth), for both components and device.
In step S52, the I/O of the server receives the identity information (ID) from the I/O of the device (S11, S22).
In step S53, the processor of the server retrieves the authorisation information (Auth) that corresponds to the identity information (ID) from the memory of the server. The processor updates the database (DB) to record that it has been accessed. Furthermore, for the situation in which the identity information (ID) corresponds to a component that is associated with by a device (S20), the processor updates the database (DB) to record the association between the component and the device.
In step S54, the I/O of the server sends the authorisation information (Auth) to the I/O of the device (S12, S23). The server returns to S51 and continues to maintain the database (DB).

Each component 100 operates independently, by establishing whether its safety requirements have been satisfied. Each vehicle 400 verifies individual components, with this verification being based on receipt of an authorisation information by an external server 600. Each component 100 has monitoring means to determine whether it can be operated safely, which includes the component 100 checking its authentication status with the device 400 in which the component is installed.

A threshold of confidence determines the level of functionality that can be performed by the component 100. A consequence of a device 400 or a component 100 being restricted is chosen by the owner (eg. the operator of a fleet of vehicles), with consequences limiting the level of functionality based on security and safety requirements.

The threshold of confidence is based on internal factors of the component, and also environmental factors that the component is exposed to. For example, if components 100 are changed, or if the vehicle 400 is moved to an unusual location, this indicates that the component should be more skeptical of its external environment. Accordingly, bespoke security levels can be selected, while ensuring compliance with safety regulations. As an example, the HVBM 100 is configured so that if it is not authenticated, then it will operate with reduced functionality, allowing the vehicle 400 to be safely controlled, rather than abruptly stopping functionality while the vehicle 400 is in motion.

Restrictions of functionality that are technically feasible include:
operation of the device/component being completely prevented,
operation of the device/component being reduced, and
a central alarm being triggered allowing a remote user to intervene in operation of the device/component.

Depending on the applicable requirements, the Arrival cyber security approach can involve different solutions and levels of security. Another solution within the Arrival cyber security approach is as described below.

All Arrival components, including HVBMs 100, can comprise a hardware security module (HSM) for verification or authentication. In contrast to this, a conventional approach provides single HSM in a vehicle. The Arrival cyber security approach can further provide for a distributed verification or authentication for some or every Arrival component of a vehicle before the component is permitted to be fully operational. The distributed verification or authentication envisages that several components, modules and/or systems (hereinafter—components) of the vehicle external to a component subject to the verification or authentication shall verify or authenticate the component. In such a way, the vehicle security is increased with the increase of the number of components of the vehicle involved into the verification or authentication (hereinafter—an authentication base). This aspect of the Arrival cyber security approach is highly flexible: different components 100 of a vehicle 400 can be included into the authentication base, and the authentication base can include different numbers of the vehicle components, depending on an environment, circumstances and/or requirements. In case of successful verification or authentication, the components of the authentication base can jointly generate an encryption key which is transmitted to the verified or authenticated component to enable said component to take part in the encrypted communication with the rest components of the vehicle using said key.

Thereby, the Arrival cyber security approach can implement the Shamir's Secret Sharing algorithm where a secret (the key) is divided into parts, giving each participant (each component of the authentication base) its own unique part. With the Arrival cyber security approach, it is possible to set a minimum number of parts (components of the authentication base) required to reconstruct the original secret (to generate the key). In such a way, a security level of the vehicle system can be set and varied.

Furthermore, the Arrival cyber security approach envisages a two-way verification or authentication: in parallel to the above-described procedure, each Arrival component shall verify or authenticate a vehicle, a device or a system that the component is installed in before the component is permitted to be fully operational. In line with the above disclosure, to verify or authenticate the vehicle the installed component shall verify or authenticate several components, modules and/or systems of the vehicle.

All verification or authentication procedures described above can be implemented with HSMs integrated in Arrival components. Besides, if a vehicle includes components or modules without integrated HSMs, such as conventional vehicle modules, the distributed verification or authentication can still be achieved. For example, a register of such conventional modules can be distributed among several components of the vehicle serving an authentication base for the conventional modules, so that the verification or authentication of the conventional modules can be conducted by several component of said authentication base, for example, in a blockchain-like manner.

Furthermore, the Arrival cyber security approach envisages binding a component to an intended installation such as specific vehicle. A component can be intended for usage in specific installation such as specific vehicle and thereby can be pre-configured or bound to said installation or vehicle. The component bound to the installation will be disabled in the event of removal from intended installation. In order to enable the component bound to a first installation to operate in another (second) installation, it is required to properly un-bind the component in advance, before removal from the first installation.

A newly produced Arrival component can be bound to the first installation it is plugged in as a result of the first successive verification or authentication procedure of this component. Correspondingly, every Arrival component can be bound to an authorized installation such as specific vehicle and a proper un-binding can be required before removal of the bound component from the authorized installation to enable the component to operate in another installation. At that, every Arrival component including bounded components and a whole Arrival vehicle can be configured to have service mode in which the component is fully operational in any installation, including unauthorized ones. Service mode is required for easy and uninterrupted service of Arrival vehicles and components. Still, the service mode shall have a set of limitations such a limited time of the service mode, a maximum range of movement of a vehicle in the service mode, etc.

### FURTHER DETAILED DESCRIPTION

In the following sections, we will focus on specific features of the Arrival Battery Module, organised into five main groupings:
Group A: Core Battery Module Principles
Group B: Battery Module Physical Structure features
Group C: Battery Module internal component features
Group D: Battery Module and the complete power system, including BMS and the battery
Group E: Battery Module Operational Features

This further detailed description forms part of the description. Disclosure is provided of any of the following features being taken in combination with any of the features that have already been introduced above, or as disclosed by the drawings.

Group A: Core Battery Module Principles

Feature 1. Battery Module Generates an Output at a 300V+ DC Bus Voltage and is Connected in Parallel to Other HVBMs to Form a Battery Pack

The conventional approach is for a vehicle battery module to produce 90V-100V nominal, and to series connect these battery modules to reach the required output voltage (e.g. 350V-400V) and to then package these modules into a large, sealed battery pack that outputs 350V-400V. The 350V-400V is hence only generated at the latest possible point it can be generated.

The Arrival HVBM 100 turns this approach on its head: instead of generating the 350V-400V output at the latest possible point, it is generated at the earliest point—namely at each individual battery module 100. Arrival's HVBM is a battery module that outputs approximately 350V to 400V nominal when it is designed for use in a vehicle with a 400V DC bus and other load components. A number of HVBMs 100 are connected in parallel and not series to form a 350V-400V battery pack 200; for example, for a small Arrival car, ten HVBMs could be connected in parallel. For a van, twenty modules could be connected in parallel. The highly modular Arrival HVBM system offers far greater flexibility than earlier battery modules and battery packs in enabling the specific cost, range, power and lifetime needs of customers to be met, and for their evolving needs to be met as well. For example, the conventional vehicle design paradigm locks in certain vehicle attributes: if you have designed a large 350V-400V battery pack made up of say four series connected battery modules, each producing 90V-100V, then the fixed dimensions and power profile of that battery pack essentially constrain its use into the vehicles of very similar dimensions and power requirements as the parent vehicle: if that parent vehicle is a medium sized car, then the battery pack can only feasibly be used in other medium sized cars, and not, for example, in a large bus. Yet with the Arrival HVBM, the same battery module could be used on its own, e.g. to power a small motorbike, or assembled into a pack of 10-20 battery modules for a car, or 100+ modules for a bus.

In the Arrival system, a customer e.g. of a van, might specify a battery pack with range that can be met with 40 HVBMs; another customer for the same type of van might specify a battery pack with range that requires 60 HVBMs. Because the HVBM 100 is both modular and also scalable without significant changes to the overall battery pack 200 architecture, the automated Vehicle Builder system can automatically create the build definition for both types of vans since it requires typically just extending the length of the array of parallel-connected HVBMs used; the Robofactoring system in the Arrival Microfactory can then build both vans at the same time, without any need to re-configure the microfactory layout or its operations.

We can Generalise as Follows:

1: A battery module configured to operate as part of a battery pack that includes multiple, identical such battery modules, in which each battery module (i) generates at least 300V nominal output and (ii) is electrically connected in parallel with at least 2 other substantially similar battery modules to form the battery pack.

2: Method of designing a low or zero emission vehicle, comprising the step of selecting a suitable number of battery modules to give the required performance and range for that vehicle, in which each battery module (i) generates at least 300V nominal output, and (ii) is electrically connected in parallel with at least 2 other substantially similar battery modules to form a battery pack.

3: Method of repairing or updating a low or zero emission vehicle, comprising the step of replacing a battery module in the vehicle that needs replacing, in which the battery module (i) generates at least 300V nominal output and (ii) is electrically connected in parallel with at least 2 other substantially similar battery modules to form a battery pack

4: A battery pack formed from a number of battery modules, each battery module configured to (i) generate at least 300V nominal output and (ii) be electrically connected in parallel with at least 2 other substantially similar battery modules to form the battery pack.

5: A vehicle including a battery module configured to operate as part of a battery pack that includes multiple, identical such battery modules, in which each battery module (i) generates at least 300V nominal output and (ii) is electrically connected in parallel with at least 2 other substantially similar battery modules to form the battery pack.

6: A fleet of vehicles, in which each vehicle includes a battery module configured to operate as part of a battery pack that includes multiple, identical such battery modules, in which each battery module (i) generates at least 300V nominal output modules to form the battery pack;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module is configured to generate between 300V and 450V at maximum charge when designed for use in a vehicle with an approx. 400V DC bus and other load components.
The battery module is configured to generate between 350V and 450V at maximum charge when designed for use in a vehicle with an approx. 400V DC bus and other load components.
The battery module is configured to deliver a nominal 350 volts, with a maximum of 450 volts, and a minimum of about 250 volts, and with a peak discharge rate of up to 1200 amps.
The battery module is configured to generate between 600V and 900V when designed for use in a vehicle with an approx. 800V DC bus and other load components.
The battery module is configured to output at least 300V nominal to enable a power harness or connector to be used, where the power harness or connector has a substantially lower weight than the harness or connector that would be needed if substantially lower voltages were used.
The battery module is configured to provide a direct HV output to the vehicle main DC Bus.
The electrical connection to the further, substantially similar, battery modules is only a parallel connection and not a series connection.
Two battery modules are is configured to be series connected together to form a unit designed for use in a vehicle with an approx. 800V DC bus and other load components.
A series connected pair of battery modules is configured to be connected in parallel to other series connected pairs of battery modules.
The electrical connection to the further, substantially similar, battery modules is a series connection to form a set of two or more series connected battery modules, and that set of modules is then electrically connected in parallel to a further, substantially similar, set of battery modules, to form a complete battery pack.
   The high voltage output by each set of battery modules is between 700V and 850V.
   The high voltage is anything under 1500V.
The battery module is configured to be connected over a data network to an external BMS.
The battery module is configured to generate one or more of: an estimate of each individual cell State of Charge (SOC), an estimate of the module State of Charge (SOC), an estimate of instantaneous available power, an estimate of total available power, an estimate of module remaining capacity, an estimate of module remaining energy, temperature data.
The battery module is configured to send state data to the BMS, such as one or more of: an estimate of each individual cell State of Charge (SOC), an estimate of the module State of Charge (SOC), an estimate of instantaneous available power, an estimate of total available power, an estimate of module remaining capacity, an estimate of module remaining energy, temperature data.
The battery module is configured to send state of health data to the BMS, such as one or more of: an individual cell resistance; individual cell capacitance; individual cell State of Health (SOH); the module's State of Health (SOH); contactor State of Health (SOH).
The battery module is configured to send connection data to the BMS, such as: status of the connector interface with the HV bus.
The battery module is configured to send warranty relevant data to the BMS.
The battery module includes an internally switched terminal output.
The battery module includes an internally switched terminal output for galvanic isolation and hence safe handling.
The battery module includes an internally switched terminal output for one or more of: preventing battery module use as power source in unauthorised applications/installations; protecting against module charging from unknown sources; enabling battery remote disablement.
   e.g., theft immobiliser or product safety recall.
   e.g., enforcing subscription/rental/leasing of battery module.
   e.g., enabling timed ‘shelf life’ expiration or cycle based ‘end of life’ control.
The battery module includes an internally switched terminal output to enable the battery module to behave as a pulse width modulated power inverter.
Three battery modules are configured to be used together to power a three phase AC induction motor. This removes the need for an external power inverter and associated efficiency losses.
The battery module is a 350×350×100 mm grid sized component.
The battery module has no functionality and is open circuit when no LV power is applied by an external BMS to a control board in the battery module.
The battery module is connected to a BMS and other battery modules on a communication channel.
The battery module includes a cell balancing system.
The battery module includes a pre-charge circuit which is activated prior to connecting to a HV bus to prevent a potentially dangerous current inrush.
The battery module includes an internal current sensor.
The battery module includes an internal current sensor configured to enable protection against over currents.
The battery module includes anti propagation materials between cells.
The battery module includes anti propagation materials above cells.
The battery module includes an internal gas sensor to detect if gas is released from a cell.
The battery module includes an internal contactor health monitoring system.
The battery module includes an internal isolation monitoring system.
The battery module includes a HVIL (high voltage interlock) system.
The battery module includes a low voltage power monitoring system.
The battery module includes an internal short circuit protection fuse.
The battery module is configured to operate with a sleep mode in which it is disconnected from supplying power but monitors only for an external wake up signal.
The battery module is configured to operate with a power saving mode in which it is disconnected from supplying power but monitors for switch requests and provides status information.
The battery module is configured with multiple, redundant networking capability.
The battery module includes intumescent material on some or all of its internal surfaces.
The battery module includes an external handle.
The battery module is configured to fit inside a carry box with an external handle.
The battery module is configured to fit inside a briefcase style carry box with an external handle.
The carry box includes an internal liquid cold plate.
The carry box includes a gas pressure relief valve.
The carry box includes intumescent material on some or all of its internal surfaces.
The battery module is configured to be connected directly or indirectly to a cloud-based system.
The battery module is configured for OTA software updates.
The battery module is configured for continuous or 24/7 cell monitoring.
The battery module is configured to automatically detect when a cell or cells disconnect from an internal circuit.
The battery module is configured with a MCU-based cell monitoring and cell balancing system.
The battery module is configured to estimate the degradation level of individual cells.
The battery module is configured to enable prediction of short-term and long-term battery performance prediction.
The battery module is configured with operational modes that differentially balance cell degradation and battery module performance.
The battery module includes a wireless connectivity system.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery module includes three main subsystems, namely a cell monitoring subsystem; a HV control subsystem; a LV control subsystem.
The cell monitoring subsystem measures cells voltage and temperatures; the HV control subsystem includes contactors and a precharge circuit to switch the HV output on/off as well as HV measurement and current sensing; the LV control subsystem includes a MCU with all the supporting components and a HW watchdog, power supplies, flash memory, communication chips, IsoSPI and CAN.
The battery pack comprises an array of battery modules arranged as a grid, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 2. Battery Module Operates as an Autonomous Module in a Battery Pack

We have also seen above that the Arrival HVBM 100 is a self-contained module capable of independent or autonomous operation; this feature results in considerable flexibility when designing a vehicle (e.g. using the automated Vehicle Builder to provision a broad range of numbers of HVBMs 100 to meet a specific customer's requirements for a specific vehicle 400 or fleet of vehicles) since it makes it much easier to use the optimal number of HVBMs for the specific customer requirements of range, cost and lifetime: the Arrival battery module 100 is modular and scalable and the control architecture of the battery pack 200 is decentralised (whether or not it is a HVBM or outputs a lower voltage and need to be series connected to other similar battery modules).

Without those attributes, it would be very difficult to be able to produce such a broad range of vehicles, at the same time and in the same Microfactory. Battery module provisioning for a specific vehicle at build time is made easier since each module is capable of independent or autonomous operation; this is especially important where your flexible Robofacturing system is able to scale to install any arbitrary number of battery modules into different vehicles, all of which could be being simultaneously produced in the same microfactory 1000.

We can Generalise as Follows:

1: A battery module that (i) includes an array of rechargeable cells and monitoring and control systems configured to enable the battery module to operate using autonomous monitoring and control; and (ii) is configured to be electrically connected to further battery modules, to form a complete battery pack.

2: Method of designing a low or zero emission vehicle, comprising the step of selecting a suitable number of battery modules, to give the required performance and range for that vehicle, in which each battery module is (i) a self-contained battery module that includes an array of rechargeable cells and monitoring and control systems configured to enable the battery module to operate using autonomous monitoring and control; and (ii) is configured to be electrically connected to further, substantially similar, battery modules, to form a complete battery pack.

3: Method of repairing or updating a low or zero emission vehicle, comprising the step of replacing a battery module in the vehicle that needs replacing, in which the battery module (i) is a self-contained module that includes an array of rechargeable cells and monitoring and control systems configured to enable the module to operate using autonomous monitoring and control; and (ii) is configured to be electrically connected to further, substantially similar, battery modules, to form a complete battery pack.

4: A low or zero emission vehicle including a battery module that (i) includes an array of rechargeable cells and monitoring and control systems configured to enable the battery module to operate using autonomous monitoring and control; and (ii) is configured to be electrically connected to further battery modules, to form a complete battery pack.

5: A fleet of a low or zero emission vehicles, in which each vehicle includes a battery module that (i) includes an array of rechargeable cells and monitoring and control systems configured to enable the battery module to operate using autonomous monitoring and control; and (ii) is configured to be electrically connected to further battery modules, to form a complete battery pack;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module is a self-contained battery module, with internal safety systems and an isolated output, capable of operating as an independent or autonomous power unit.
The battery module is an independent unit that determine for itself if it should be switched on and off, independently of other units, with no reliance on other modules.
The battery module is configured to be individually swapped out of a battery pack and replaced.
The battery module has an autonomous ability to switch its own output off and on, and to enter or emerge from sleep mode, to allow a vehicle to cope with modules in differing states of charge.
The battery module is configured to operate completely independently from other modules in the network.
The battery module has the capability to connect/disconnect itself to and from the network, but should only do so, without being instructed, for safety reasons.
The battery module can itself switch on/off network including under load, for example using solid state switching.
The battery module includes an internally switched terminal output.
The battery module includes an internally switched terminal output for galvanic isolation and hence safe handling.
The battery module does not hold the non-safety related strategy for HV network connection/disconnection and gets switching requests through a CAN/Ethernet connection from a BMS.
The battery module is capable of estimating its own operating state/status.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery module is configured to actively monitor individual cell voltages for the cells it contains.
The battery module is configured to actively monitor its discharge and charge current;
The battery module is configured to actively monitor and provide an estimate of individual cell State of Charge (SOC) for the cells it contains.
The battery module is configured to operate as an independent, autonomous unit and is a slave to an external BMS in that it can only be taken to an operational, connected state under the control of the BMS.
The battery module includes a control board that is powered by an external BMS, external to the module, and can only power itself up with a low voltage signal from the BMS.
The battery module is configured to actively monitor and provide an estimate of its State of Charge (SOC) to an external BMS or other system.
The battery module is configured to actively monitor and provides an estimate of its instantaneous available power to an external BMS or other system.
The battery module is configured to actively monitor and provide an estimate of its total available power to an external BMS or other system.
The battery module is configured to actively monitor and provide an estimate of its remaining capacity to an external BMS or other system.
The battery module is configured to actively monitor and provide an estimate of its remaining energy to an external BMS or other system.
The battery module is configured to communicate state data with an external BMS.
The battery module is configured to actively measure/estimate the temperature distribution within the module.
The battery module is configured to aggregate and communicate temperature data to an external BMS.
The battery module is configured to actively monitor cell resistance for individual cells, or pairs of cells, or other sub-groups of cells within the entire group of cells in the module.
The battery module is configured to actively monitor cell capacitance for individual cells, or pairs of cells, or other sub-groups of cells within the entire group of cells in the module.
The battery module is configured to actively estimate and monitor cell State of Health (SOH) for individual cells, or pairs of cells, or other sub-groups of cells within the entire group of cells in the module.
The battery module is configured to actively estimate and monitor its own State of Health (SOH).
The battery module is configured to actively estimate and monitor the State of Health (SOH) of a contactor in the module.
The battery module is configured to communicate State of Health data with an external BMS.
The battery module is configured to monitor its data connections.
The battery module is configured to actively monitor a connector interface with an HV bus.
The battery module is configured to actively monitor connector connection status and the interface with the HV bus.
The battery module is configured to have no functionality and to be open circuit when no LV power is applied by an external BMS to a control board in the battery module.
The battery module is configured to be connected to a BMS and other battery modules on a communication channel.
The battery module is autonomously able to cell balance.
The battery module communicates connector status with the external BMS.
The battery module collects module statistical data.
The battery module calculates and collects component data, warranty data; and it communicates collected data with the external BMS.
The battery module includes components or systems for each of: current monitoring, cell voltage monitoring, cell balancing, temperature monitoring, isolation contactors and solid state switches, and a HVIL (high voltage interlock) safety system.
The battery module includes a weld detection system, in which several voltage sensors allow the module to be aware if a contactor weld occurs using a special start up and shutdown routine.
The battery module includes a voltage measurement system, in which voltage is measured on every cell and at the output of all cells.
Voltage is also measured on the DC bus to allow effective pre-charging prior to connecting to the DC bus and enhanced safety algorithms.
The battery module includes a current measurement system, in which current is measured on a battery module level to enable accurate power flow mapping around the entire battery pack.
The battery module includes an internal pre-charge system, such as PTC resistors, to prevent current inrush when turning on voltage output.
The battery module includes a cell monitoring system in which, for every pair of cells the temperature is calculated and the current and voltage is measured, to allow a highly accurate determination of SOC, SOH, and capacity.
The battery module includes a cell balancing system in which cells are balanced inside the battery module independently of other battery modules to allow the battery pack to maintain optimal capacity throughout its life.
The battery module monitors all of its cells and runs an algorithm to assess and manage self-balancing.
The battery module can passively discharge individual cells to self-balance.
The battery module is configured to connect to other modules at a dissimilar state of charge, and the connected modules will then balance, due to parallel nature of the connection
The battery module provides for electrical isolation of battery cells using an anodised base plate and a thermally conductive adhesive layer.
The battery module includes an internal switching circuit for connecting cells in parallel for, amongst other possibilities, better charging.
The battery module includes a connector cap to provide connector interlock capability
The battery module includes: (i) cells; (ii) an inner casing, composed of lower and upper plastic cell carriers, holding the cells together; (iii) an outer casing, composed of a lid and lower cold plate, ensuring the thermal interface and seal of the HVBM from the environment; (iv) a cell connection board, which is a PCB connecting all the cells together in a given series/parallel arrangement and embedding the cell balancing circuit; (v) an interface board; (vi) an HV Board, which is a section of the PCB or a separate PCB containing all the HV power components between the cells and the HVBM external connection; (vii) a LV control board, which is a section of the PCB or a separate PCB containing the control electronics monitoring the module and communicating with external systems.
An array of battery modules is arranged in a grid to form a battery pack, and the number of battery modules used in the array is selected to give the required range or capacity for the pack.
the length of the grid of battery modules is selected to give the required range or capacity for the pack.
The grid is made up of a single layer of battery modules, or two or more layers of battery modules.
The battery module is configured to generate a high voltage output at a voltage magnitude that is used in a vehicle system powered by the module and that is at least 300V nominal.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Group B: Battery Module Physical Features

Feature 3. Battery Module with Standard Grid Sizing

The Arrival battery module 100 has a standard size of 350×350×100 mm; this size is defined by a size architecture number system (see Section A of PCT/GB2021/051519) that is a simple and compatible system to accurately cover size intervals defining a wide range of sizes for a wide variety of different components. The word ‘size’ should be interpreted broadly. In many cases it will refer to a dimension of length, but it may also refer to an area, weight, capacity to perform, rating and so forth.

By conforming the size of the battery module to the standard size architecture, which is used for many different components in the vehicle, it becomes much more reliable and also faster to design the packaging for those components, since all packaging and mounting interfaces conform to the standard size architecture. This is especially useful when the vehicle has a standard ‘skateboard’ platform 400, like the Arrival Car described in Section K of PCT/GB2021/051519.

It is also much easier to provide for machine position mounting holes on various structures in the vehicle, knowing that any component designed using the standard size architecture should fit into those mounting holes. Robotic handling and installation of components is also facilitated, since we have reduced significantly the possible sizes of different components and where they can be located or installed. The standard size architecture can also be used to define a regular grid such as a rectilinear grid; mounting interfaces for an array of battery modules can be positioned on a mounting plate, defining a rectilinear grid of these mounting interfaces. Each battery module 100 can then be positioned onto this grid; the array of battery modules is then known to be accurately positioned and other related components, such as the flexible PCB power bus, also conforming in size to the standard size architecture can then be neatly and accurately positioned on the battery modules.

The standard size architecture is an example of the physical modularity that is a consistent theme in the Arrival System: Using the standard size architecture across not just the battery modules but more generally across many other components; this family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; it can also include non-electronic components, such chassis beams, side panels, and even the overall vehicle dimensions.

This approach leads to simplicity, fast and efficient design (such as automated design using the Vehicle Builder system described in Section D of PCT/GB2021/051519 and more reliable robotic handling, as described above. It leads also to a consistent appearance for these components, which makes for easier and faster designing of the layout of those components, more efficient use of space, as well as a more aesthetic vehicle or other installation; the aesthetic value or design language of internal components in a vehicle, such as the HVBM 100 or MBMS 500, is not to be underestimated: where the individual internal components are themselves things of beauty, then the overall engineering quality of the total system will be higher; customers also appreciate quality and aesthetic design that is more than superficial and extends to even normally concealed components that are normally seen only at design and build time by engineers. The standard size architecture can also lead to better product quality for functional reasons: for example, computer vision systems can readily and rapidly determine whether a component complies exactly with the standard size architecture requirements and that can be part of the quality control that is applied when producing a vehicle or installing new components in a vehicle; poor quality counterfeit products that do not conform to these exacting requirements can be automatically detected.

We can Generalise as Follows:

1: A battery module configured to operate as part of a battery pack that includes multiple, identical such battery modules, in which each battery module has a size that conforms to a regular size interval scale and is part of a family of other types of components with sizing that also conforms to the same size interval scale.

2: An electrically powered device or system, including multiple vehicle components which each have a size that conforms to a regular size interval scale and is part of a family of other types of vehicle components with sizing that also conforms to the same size interval scale.

3: A vehicle including a battery module that is configured to operate as part of a battery pack that includes multiple, identical such battery modules, in which each battery module has a size that conforms to a regular size interval scale and is part of a family of other types of components with sizing that also conforms to the same size interval scale.

4: A fleet of vehicles, in which each vehicle includes a battery module that configured to operate as part of a battery pack that includes multiple, identical such battery modules, in which each battery module has a size that conforms to a regular size interval scale and is part of a family of other types of components with sizing that also conforms to the same size interval scale;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
Size means linear dimension.
Each battery module is a 350×350×100 mm grid sized component.
Size means area.
Size means shape.
Size means weight.
Size means volume.
Size means external size.
Weight is less than 20 kg.
Size intervals define a grid.
Grid is rectilinear.
Grid is rectilinear to enable reliable robotic placement and installation of the module.
Components are constrained to take up a volume that is a multiple of a unit volume, the space for housing components being divided into a grid of these unit volumes.
Size intervals define a standardised shape and size, or multiples of that standardised shape and size, to aid with automated vehicle design and/or robotic assembly.
The regular size intervals are chosen to facilitate consistent component design.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The regular size intervals are chosen to facilitate automated layout or design of a vehicle.
The regular size intervals are chosen to facilitate automated design of vehicles that are configured with differing numbers of battery modules.
The regular size intervals are chosen to facilitate reliable robotic handling of components.
The regular size intervals are chosen to facilitate reliable robotic installation of components.
The regular size intervals are chosen to facilitate calculation of the travel paths components take as they are being installed by a robot.
The regular size intervals are chosen to facilitate computer vision analysis of a component.
The regular size intervals are chosen to facilitate optimal use of space.
The family of other types of components includes one or more of the following: master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform.
Other components include: chassis beams, frame elements that support side and/or roof panels, exterior side panels, overall vehicle dimensions.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
An array of battery modules is arranged in a grid to form a battery pack, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 4: Modular Components Installed Using the Same Regular, Rectilinear Grid or Installation Pattern

As noted above, the standard size architecture is applied not just to the battery modules, but more generally throughout the vehicle, across many different components. This makes robotic handling and installation more reliable since you are limiting, for example, the possible physical layout variables, which makes an automated vehicle design system like Vehicle Builder, feasible. Further, it limits the possible locations of the multiple mounting points which have to be targeted for correct installation of a component, which again makes the automated vehicle design system Vehicle Builder, feasible, as well as robotic assembly. Also, when tracing the movement of components through the air, robots need to know the dimensions and full path through the air and to the final destination that those components will take, so that collisions can be avoided; by standardising component size, it makes computing these paths to avoid collisions much faster and more reliable. Arrival battery modules can be square e.g. 350 mm square) in plan view; a grid of substantially adjacent battery modules can readily be assembled and fixed into position. Because Arrival battery modules can be square, they can be assembled into rectangular arrays in the batter pack—e.g. 4 modules wide, and 4 long for a car, or 4 modules wide and 6 long for a van.

Other types of components include one or more of the following: battery modules; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform.

We can Generalise as Follows:

1: An electrically powered device or system, including multiple vehicle components configured for robotic installation or assembly into the device or system by virtue of being positioned in the device or system in a regular, rectilinear grid or installation pattern.

2: A vehicle including multiple components configured for robotic installation or assembly into a device or system of the vehicle by virtue of being positioned in the device or system in a regular, rectilinear grid or installation pattern.

3: A fleet of vehicles, in which each vehicle includes multiple components configured for robotic installation or assembly into a device or system of the vehicle by virtue of being positioned in the device or system in a regular, rectilinear grid or installation pattern;
and in which an operator of the fleet has defined one or more sets of performance and range requirements it has for the vehicles in the fleet, and those requirements have been used when selecting the number and type of these components to be included in each vehicle in the fleet.

Optional Sub-Features Include:
The electrically powered device or system corresponds to a battery module according to any of the other Features described herein.
Other types of components include one or more of the following: battery modules; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B, in particular Feature 3.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 5. Battery Module Configured for Robotic Assembly

We have touched above on how the standardised shape and size of components helps both automated design using Vehicle Builder and also robotic assembly. The Arrival battery module exemplifies this, with its 350×350×100 mm dimensions. The battery module also has other physical features, such as the shape of the battery module, which facilitate robotic handling. For example, it is packaged with a lid 110 that a large flat top: this enable reliable handling by a robotic suction cup end effector. It may also have chamfered edges for auto-alignment when being installed by a robot (1001, 1002); edges are rounded—there and no sharp edges that could otherwise jam on installation.

We can Generalise as Follows:

1: A battery module configured to operate as part of a battery pack that includes multiple, identical such battery modules, in which each battery module is configured for robotic installation or assembly to the battery pack by virtue of having a shape that is optimised for robotic installation or assembly.

2: A battery pack that includes multiple, identical battery modules, in which each battery module is configured for robotic installation or assembly to the battery pack by virtue of having a shape that is optimised for robotic installation or assembly.

3: A vehicle including a battery module configured to operate as part of a battery pack that includes multiple, identical such battery modules, in which each battery module is configured for robotic installation or assembly to the battery pack by virtue of having a shape that is optimised for robotic installation or assembly.

4: A fleet of vehicles, in which each vehicle includes a battery module configured to operate as part of a battery pack that includes multiple, identical such battery modules, in which each battery module is configured for robotic installation or assembly to the battery pack by virtue of having a shape that is optimised for robotic installation or assembly;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module has a flat top cover to enable reliable suction cup handling.
The battery module has chamfered edges for auto-alignment when being installed by a robot.
The battery module has rounded edges and no sharp edges that could otherwise jam on installation.
The battery module is shaped as a truncated square or rectangle, in plan view, with the truncated regions enabling access to fixing mechanisms that secure the module to an underlying or adjacent cold plate.
The battery module is installed in a host device or system in a position that conforms to a rectilinear grid or installation pattern, and all battery modules are installed in positions that conform to this rectilinear grid or installation pattern.
Components other than the battery module also conform to the same standardised shape and size or multiples of that standardised shape and size.
Components other than the battery module are also installed in a host device or system in a position that conforms to the rectilinear grid or installation pattern.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
An array of battery modules is arranged in a grid to form a battery pack, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 6. Battery Module that Sits on a Rigid Base Plate that in Turn Sits on a Liquid Cooled Plate

Battery modules typically have complex liquid cooling structures running past the upright, cylindrical faces of the rechargeable batteries (where cylindrical form factor batteries are used). This is inherently complex to scale since the liquid cooling structure has to be significantly re-designed for different arrangements of battery modules: it is an inherently complex and bespoke piece of engineering. Cooling the upright cylindrical surfaces is also inefficient because heat transfer radially out of an individual rechargeable battery is 25× less than the axial heat transfer.

The Arrival battery module 100 takes advantage of this because the supporting base 130 of the battery module (which is 6 mm thick) not only provide structural rigidity but also cooling functionality. For example, the supporting base 130 may be positioned in thermal contact with an external rigid base plate 260 that provides support for the entire battery pack 200, and a liquid cooled plate or system is then positioned under or integrated inside the external rigid base plate 260. High thermal conductivity gels may be used on all interface surfaces to enhance heat transfer. By providing a liquid cooling system that is wholly external to the battery module, but typically forms the integral base of the battery module, the construction of the battery module 100 and the battery pack 200 is simplified and robotic assembly (e.g. Robofactoring in a Microfactory 1000) becomes feasible.

This cooling approach is inherently scalable; no additional hard plumbing is needed as the number of battery modules increases. Also, repairs and upgrades to the liquid cooling system 260 are far easier since it is not inside the battery module or the battery pack, but instead forms the external base of the battery module. And the integrated metal cooling plate also reduces the risk of penetration.

All cells (166, 181) have their negative end contacting the supporting base 130 of the battery module 100 and a negative electrode leads from the rim or edge at the opposite end of the cell. This ensures maximum and consistent thermal contact between all cells and the base of the battery module. The supporting base 130 is hard anodised on both major surfaces to provide electrical insulation. Each battery module uses 4 mechanical mounting points in each of its corners, for minimum M6 bolts, with an 8 mm thru-hole.

We can Generalise as Follows:

1: A vehicle battery module including multiple cylindrical form-factor rechargeable cells, in which the battery module includes a base on which the rechargeable cells are positioned, in which the base provides a structurally rigid support for the cells and also provides thermal cooling for the cells.

2: A vehicle including a battery module including multiple cylindrical form-factor rechargeable cells, in which the battery module includes a base on which the rechargeable cells are positioned, in which the base provides a structurally rigid support for the cells and also provides thermal cooling for the cells.

3: A fleet of vehicles, in which each vehicle includes a battery module including multiple cylindrical form-factor rechargeable cells, in which the battery module includes a base on which the rechargeable cells are positioned, in which the base provides a structurally rigid support for the cells and also provides thermal cooling for the cells;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
Rechargeable cells are arranged perpendicular to the base and hence perpendicular to the base that provides thermal cooling, exploiting the high longitudinal thermal conductivity of cells in the battery module.
Rechargeable cells are arranged perpendicular to the base and hence perpendicular to the base that provides thermal cooling, and the arrangement uses the high thermal conductivity through the cell axis.
All cells have their negative end contacting the supporting base and a negative electrode leading from the rim or edge at the opposite end of the cell.
Rechargeable cells in a battery module are each 18650 form-factor batteries.
Rechargeable cells in a battery module are each 21700 form-factor batteries.
The base is a liquid cooled plate.
The base itself includes integral or internal liquid cooling channels.
The base does not itself include integral or internal liquid cooling channels but rests on an external rigid baseplate that provides support for the battery module, and the external rigid baseplate includes integral or internal liquid cooling channels.
The external rigid baseplate does not include integral or internal liquid cooling channels but rests on or sits over a liquid cooling system.
Thermal paste is used between the base and the external rigid baseplate.
The battery module does not include any cooling system that runs past or alongside the longitudinal sides of the cells.
The battery module is configured to operate as part of a battery pack that includes multiple, identical such battery modules.
The base is an aluminium base.
The base is a 6 mm thick aluminium base.
The base is configured to reduce the risk of penetration into the module.
The battery module has a cover or lid that is black in colour for optimised radiant heat dissipation.
The battery module includes fins or other high surface area structures, in thermal contact with the base, for enhanced air cooling.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are Li-ion or lithium polymer cells.
The rechargeable cells are solid state cells.
An array of battery modules is arranged in a grid to form a battery pack, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 7. Battery Module in which all Rechargeable Cells have the Same Polarity Orientation

We noted above that all cells (166, 181) in an Arrival battery module have their negative end contacting the supporting base plate and a negative electrode leading from the rim or edge at the opposite end of the cell; all cells in a battery module share the same polarity orientation. In a conventional battery module, adjacent cells generally have the opposite polarity orientation. But keeping the same polarity orientation facilitates fast and reliable construction of the battery module; this is especially important for robotic assembly (e.g. Robofactoring in a Microfactory 1000), since all battery cells are inserted in the same orientation; a robotic end effector can simply take a rack of 102 cells, all oriented in the same direction, and place them into a chassis or holder (165, 167) designed to retain all cells 166, and then position the entire chassis, with a complete set of cells, on to the base 130 of the battery module.

We can Generalise as Follows:

1: A vehicle battery module including multiple cylindrical form-factor rechargeable cells, in which the battery module includes a base on which the rechargeable cells are positioned, in which the base provides a structurally rigid support for the cells and in which all cells in the battery module are oriented with the same polarity orientation.

2: A vehicle including a battery module including multiple cylindrical form-factor rechargeable cells, in which the battery module includes a base on which the rechargeable cells are positioned, in which the base provides a structurally rigid support for the cells and in which all cells in the battery module are oriented with the same polarity orientation.

3: A fleet of vehicles, in which each vehicle includes a battery module including multiple cylindrical form-factor rechargeable cells, in which the battery module includes a base on which the rechargeable cells are positioned, in which the base provides a structurally rigid support for the cells and in which all cells in the battery module are oriented with the same polarity orientation;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
All cells have their negative end contacting a supporting base plate and a negative electrode leading from the rim or edge at the opposite end of the cell.
Rechargeable cells in the battery module are each 18650 form-factor batteries.
Rechargeable cells in the battery module are each 21700 form-factor batteries.
Supporting base plate provides thermal cooling.
Supporting base plate is positioned on a liquid-cooled cooling plate.
cells are oriented with the same polarity orientation to optimise thermal cooling.
battery module are oriented with the same polarity orientation to facilitate robotic installation of cells into the battery module.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are Li-ion or lithium polymer cells.
The rechargeable cells are solid state cells.
An array of battery modules is arranged in a grid to form a battery pack, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 8. Battery Module that has its Own Cover, and Connects to Other Similar Modules to Form a Battery Pack.

Because the Arrival battery module is designed to be readily configured in different arrangements (e.g. a set of five battery modules could form the complete battery back 200 for a vehicle; or a set of twenty five could be needed for the same vehicle) it is very useful if each individual battery module 100 can be safely stored, handled, and installed into a vehicle 400, whether by man or machine. Safe handling of each battery module 100 is also particularly important because each battery module includes safety-critical electronic components, including multiple microcontrollers, residing on one or more circuit boards (160a,b,c; 161, 163, 164) sitting over the rechargeable cells in each battery module. Neither of these constraints apply to conventional battery modules.

In order to protect these safety-critical electronic components, and to facilitate safe storage, handling, and installation of individual battery modules, each individual battery module is packaged in an outer shell or lid 110 that is configured to enclose the array of rechargeable cells 166 and the safety-critical electronic components inside each battery module 100. The lid 110 is made using a four gate valve system injection moulding system.

We can Generalise as Follows:

1: A vehicle battery module configured to generate at least 300V output at maximum charge, and (i) including a single outer shell or lid that is configured to enclose an array of rechargeable cells and seal against a rigid base of the module, and (ii) configured to be electrically connected to further, substantially similar, battery modules, to form a complete battery pack.

2: Method of designing a low or zero emission vehicle, comprising the step of selecting any arbitrary number of battery modules, e.g. from 1-100, to give the required performance and range for that vehicle, in which each battery module generates at least 300V nominal output, and (i) includes in a single outer shell or lid that is configured to enclose an array of rechargeable cells and seal against a rigid base of the module, and (ii) is configured to be electrically connected to further, substantially similar, battery modules, to form a complete battery pack.

3: Method of repairing or updating a low or zero emission vehicle, comprising the step of replacing a battery module in the vehicle that needs replacing, in which the battery module generates at least 300V nominal output, and (i) includes a single outer shell or lid that is configured to enclose an array of rechargeable cells and seal against a rigid base of the module, and (ii) is configured to be electrically connected to further, substantially similar, battery modules, to form a complete battery pack.

4: A vehicle including a battery module, the battery module configured to generate at least 300V nominal output, and (i) including a single outer shell or lid that is configured to enclose an array of rechargeable cells and seal against a rigid base of the module, and (ii) configured to be electrically connected to further, substantially similar, battery modules, to form a complete battery pack.

5: A fleet of vehicles, in which each vehicle includes a battery module, the battery module configured to generate at least 300V nominal output, and (i) including a single outer shell or lid that is configured to enclose an array of rechargeable cells and seal against a rigid base of the module, and (ii) is configured to be electrically connected to further, substantially similar, battery modules, to form a complete battery pack;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module includes a base to provide structural rigidity and the outer shell or lid is sealed to the base to provide environmental sealing to at least IP65.
The battery module includes a base to provide structural rigidity and the outer shell or lid is sealed to the base and also removable from the baseplate in ordinary maintenance use, to enable replacement or repair of components in the battery module.
The base is anodised to provide electrical insulation.
The outer shell or lid is configured to provide shock resistance.
The outer shell or lid is configured to fully enclose an array of rechargeable cells.
The outer shell or lid is configured to enable the module to be handled robotically.
The outer shell or lid is configured to enable safe manual handling.
The outer shell or lid is configured to enclose an array of rechargeable cells, power input and power output connections, a power management sub-system and a data connectivity sub-system.
The outer shell or lid is black in colour for efficient heat dissipation.
The outer shell or lid is capable of equalizing internal to an external pressure gradient through a pressure equalisation vent.
The outer shell or lid is configured to vent gases safely in the event of a thermal runaway through a gas escape vent.
The outer shell or lid is configured to protect and seal the battery module internal region and to enable stacking of multiple battery modules on top of each other.
The outer shell or lid is configured to provide flame resistance and is made from UL94.0 VO plastic.
The battery module includes a unique, traceable ID on the lid.
The battery module includes (i) a cell carrier or carriers occupying the entire area of the battery module, (ii) one or more boards, each occupying the entire area of the battery module, and the shell or lid is sized to fit securely over the carrier(s) and the boards.
The boards include: PCB, dielectric separator, cell balancing board, power output board.
The outer shell or lid includes electrical interface connectors for high voltage output; low voltage power; data (such as a pair of CAN terminals).
The outer shell or lid includes electrical interface connectors for ethernet connectivity.
The outer shell or lid includes electrical interface connectors for RS232 connectivity.
The outer shell or lid includes one or more recess having a radius of curvature that is greater than the radius of curvature of other edges of the outer shell or lid.
A recess of the outer shell or lid includes the electrical interface connectors.
The outer shell or lid is formed by injection moulding of molten material via a plurality of gate valves, each gate valve being sequenced to control curing of the material.
The outer shell or lid is made using a four gate valve system injection moulding system.
The outer shell or lid is, during production, vertically lowered over the cell carrier or carriers and the boards, onto the base.
The battery module has a square cross-section.
The battery module and the shell or lid is 350 mm×350 mm in area.
The base is a solid aluminium base.
The battery module includes intumescent material on some or all of its internal surfaces.
The battery module includes an external handle.
The battery module is configured to fit inside a carry box with an external handle.
The battery module is configured to fit inside a briefcase style carry box with an external handle.
The carry box includes an internal liquid cold plate.
The carry box includes a gas pressure relief valve.
The carry box includes intumescent material on some or all of its internal surfaces.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
An array of battery modules is arranged in a grid to form a battery pack, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 9. Battery Module that Slides into Chassis Void

Because each battery module is packaged with a flat topped, rigid lid 110, and a flat rigid base 130, it is possible to readily insert battery modules 100, either individually or when part of a battery pack 200, into a void sitting over a substantially flat chassis base of the vehicle 400.

We can Generalise as Follows:

1: A vehicle battery module, configured to operate as part of a battery pack that includes multiple, identical such battery modules, in which one or more battery modules are configured to be inserted, either individually or when part of a battery pack, into a void sitting over a substantially flat chassis base of the vehicle.

2: A vehicle including a battery module, configured to operate as part of a battery pack that includes multiple, identical such battery modules, in which one or more battery modules are configured to be inserted, either individually or when part of a battery pack, into a void sitting over a substantially flat chassis base of the vehicle.

3: A fleet of vehicles, in which each vehicle includes a battery module, configured to operate as part of a battery pack that includes multiple, identical such battery modules, in which one or more battery modules are configured to be inserted, either individually or when part of a battery pack, into a void sitting over a substantially flat chassis base of the vehicle; and in which an operator of the fleet has defined one or more sets of performance and range requirements it has for the vehicles in the fleet, and those requirements have been used when selecting the number of battery modules to be included in each vehicle in the fleet.

Optional Sub-Features Include:
Each battery module includes a substantially flat supporting base and a substantially flat topped outer shell or lid configured to be received by the void.
The substantially flat supporting base is configured to act as a thermal conductor, drawing heat from the modules.
The substantially flat supporting base is configured to sit over or include a liquid cooling system.
The substantially flat supporting base is a solid aluminium base.
The substantially flat chassis base includes a liquid cooling system.
Each battery module is configured to generate high voltage at the voltage magnitude used in a system powered by the module.
Each battery module is a self-contained module that includes an array of rechargeable cells and all monitoring and control systems needed to enable the battery module to operate autonomously.
The lid is sealed to the base to provide environmental sealing to at least IP65.
The battery module includes a base to provide structural rigidity and the outer shell or lid is sealed to the base and also removable from the baseplate in ordinary maintenance use. This enables replacement or repair of components in the battery module.
The base is anodised to provide electrical insulation.
The outer shell or lid is configured to provides shock resistance.
The outer shell or lid is configured to fully enclose an array of rechargeable cells.
The outer shell or lid is configured to enable the module to be handled robotically.
The outer shell or lid is configured to enable safe manual handling.
The outer shell or lid is configured to enclose an array of rechargeable cells, power input and power output connections, a power management sub-system and a data connectivity sub-system.
The outer shell or lid is black in colour for efficient heat dissipation.
The outer shell or lid is capable of equalizing internal to an external pressure gradient
The outer shell or lid is configured to vent gases safely in the event of a thermal runaway
The outer shell or lid is configured to protect and seal the battery module internal region and to enable stacking of multiple battery modules on top of each other.
The outer shell or lid is configured to provide flame resistance and is made from UL94.0 VO plastic.
The each battery module includes a unique, traceable ID on the lid.
The battery module includes (i) a cell carrier or carriers occupying the entire area of the battery module, (ii) one or more boards, each occupying the entire area of the battery module, and the shell or lid is sized to fit securely over the carrier(s) and the boards.
The boards include: PCB, dielectric separator, cell balancing board, power output board.
The outer shell or lid includes electrical interface connectors for high voltage output; low voltage power; data (such as a pair of CAN terminals).
The outer shell or lid includes electrical interface connectors for ethernet connectivity.
The outer shell or lid includes electrical interface connectors for RS232 connectivity.
The ethernet and RS232 connectivity provide or replicate CAN functionality.
The outer shell or lid is made using a four gate valve system injection moulding system.
The outer shell or lid is, during production, vertically lowered over the cell carrier or carriers and the boards, onto the base.
The battery module has a square cross-section.
The battery module and the shell or lid is 350 mm×350 mm in area.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery pack comprises an array of battery modules arranged as a grid, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Group C: Battery Module Internal Component Features

Feature 10. Battery Module with Internal Isolation Switch

Safety is designed into each battery module 100 through a number of features. Each battery module is an integrated battery module safely delivering e.g. high voltage (nominally 450 VDC) for electric vehicles (EV), domestic energy storage and renewable generation. Switches integrated into the battery module decouple cell string(s) from module terminals, rendering the module safe for handling and transportation and removing the need for external contactors.

Isolation of individual battery modules allows for safe switch out and hot-swap of battery modules within an array. Example switching devices (184, 186, 187) include but are not limited to transistor, FET, MOSFET, IGBT, relay or contactor. The switching devices offer galvanic isolation and rapid switching capability. Control of internal switching device(s) may be by any or a combination of the following mechanisms:

1. Data signal from ‘intelligent’ load (e.g. EV on-board-controller): module only delivers voltage output after successful two-way data handshake.

2. Voltage from connector interlock loop (akin to HVIL), holding closed the internal switch whilst module is connected.

3. Bridging loop within module terminal connector, using internal signal voltage to detect connector mating; disabling module output upon decoupling.

Isolation of the battery module, except for after a successful data handshake, allows for control of module use, protecting against abuse and disabling module in the event of removal from intended installation/vehicle:
Preventing module use as power source in unauthorised applications/installations.
Protecting against module charging from unknown sources.
Enabling battery remote disablement; e.g. theft immobiliser or product safety recall.
Enforcing subscription/rental/leasing of battery module.
Enabling timed ‘shelf life’ expiration or cycle based ‘end of life’ control.

We can Generalise as Follows:

1: A vehicle battery module configured to operate as part of a battery pack that includes multiple, identical such battery modules, in which each battery module (i) includes rechargeable cells configured to generate, at a pair of output terminals, an output voltage, and (ii) includes an internal isolation switch system, configured to isolate all cells from one or both of the output terminals.

2: A vehicle including a battery module, module configured to operate as part of a battery pack that includes multiple, identical such battery modules, in which each battery module (i) includes rechargeable cells configured to generate, at a pair of output terminals, an output voltage, and (ii) includes an internal isolation switch system, configured to isolate all cells from one or both of the output terminals.

3: A fleet of vehicles, in which each vehicle includes a battery module configured to operate as part of a battery pack that includes multiple, identical such battery modules, in which each battery module (i) includes rechargeable cells configured to generate, at a pair of output terminals, an output voltage, and (ii) includes an internal isolation switch system, configured to isolate all cells from one or both of the output terminals;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module is configured to generate an output voltage of at least 300V nominal.
The internal switch system is configured to only connect the cells to the output terminals after a successful handshake between the battery module and an external system, such as a BMS.
The battery module includes a control board that is powered by a master BMS, external to the module, and cannot power itself from itself, i.e. the battery module.
The battery module has no functionality and is open circuit when no LV power is applied.
The battery module is connected to the BMS and other battery modules on the communication channel.
The battery module will receive switch on/off requests and provide status/faults information, as well as broadcast estimated available power to the network for the BMS to use.
Control of internal safety system isolation switch is by any or a combination of the following mechanisms: 1. Data signal from ‘intelligent’ load (e.g. EV on-board-controller): module only delivers voltage output after successful two-way data handshake; 2. Voltage from connector interlock loop (akin to HVIL), holding closed the internal switch whilst module is connected; 3. Bridging loop within module terminal connector, using internal signal voltage to detect connector mating; disabling module output upon decoupling.
The internal switch system is configured for one or more of: preventing battery module use as power source in unauthorised applications/installations; protecting against module charging from unknown sources; enabling battery remote disablement; e.g. theft immobiliser or product safety recall; enforcing subscription/rental/leasing of battery module; enabling timed ‘shelf life’ expiration or cycle based ‘end of life’ control.
The internal switch system is configured for solid state switching and includes at least one transistor, FET, MOSFET, IGBT.
The internal switch system includes a relay or contactor configured to provide galvanic isolation.
One contactor is on a negative output of the battery module and one contactor is on the positive output, to ensure the battery module can achieve galvanic isolation when in its off state.
Contactors are PWM controlled.
A voltage sensor system in the battery module detects if a contactor weld occurs during a start-up and shutdown routine.
Each battery module includes three subsystems:
   Cells monitoring: Measuring cells voltage and temperatures.
   HV control, including contactors and precharge circuit to switch the HV output on/off as well as HV measurement and current sensing.
   LV controls, comprised of the MCU with all the supporting components and a HW watchdog, power supplies, flash memory, communication chips, IsoSPI and CAN.
The current sensor is a Hall effect based sensor.
The voltage sensor is placed after the contactors, nearer to the external circuit, in order to be able to measure external voltage, compare to the sum of the cells voltage for the pre-charge and main switch management.
The battery module includes a pre-charge circuit which is activated prior to connecting to the DC bus to prevent a potentially dangerous current inrush.
The pre-charge circuit includes a third contactor and PTC (Positive Temperature Coefficient) devices limiting the current and preventing overheating if the pre-charge is used too often.
The resistance of the PTC can be estimated in situ from the HV and cells voltage sum measurement, as well as from a current sensor, giving an indication of the PTC temperature.
The battery module is configured to switch on and off independently of other modules using the internal isolation switch system.
The battery module has no functionality and is open circuit when no LV power is applied by an external BMS to a control board in the battery module.
The battery module is connected to a BMS and other battery modules on a communication channel.
The battery module includes a cell balancing system.
The battery module includes a pre-charge circuit which is activated prior to connecting to a HV bus to prevent a potentially dangerous current inrush.
The battery module includes an internal current sensor.
The battery module includes an internal current sensor configured to enable protection against over currents.
The battery module includes anti propagation materials between cells.
The battery module includes anti propagation materials above cells.
The battery module includes an internal gas sensor to detect if gas is released from a cell.
The battery module includes an internal contactor health monitoring system.
The battery module includes an internal isolation monitoring system.
The battery module includes a HVIL (high voltage interlock) system.
The battery module includes a low voltage power monitoring system.
The battery module includes an internal short circuit protection fuse.
The battery module is configured to operate with a sleep mode in which it is disconnected from supplying power but monitors only for an external wake up signal.
The battery module is configured to operate with a power saving mode in which it is disconnected from supplying power but monitors for switch requests and provides status information.
The battery module is configured with multiple, redundant networking capability.
The battery module is configured to be connected directly or indirectly to a cloud-based system.
The battery module is configured for OTA software updates.
The battery module is configured for continuous or 24/7 cell monitoring.
The battery module is configured to automatically detect when a cell or cells disconnect from an internal circuit.
The battery module is configured with a MCU-based cell monitoring and cell balancing system.
The battery module is configured to estimate the degradation level of individual cells.
The battery module is configured to enable prediction of short-term and long-term battery performance prediction.
The battery module is configured with operational modes that differentially balance cell degradation and battery module performance.
The battery module includes a wireless connectivity system.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery pack comprises an array of battery modules arranged as a grid, and the number of battery modules used in the array is selected to give the required range or capacity for the pack.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 11. Battery Module with a Bypass Series Switch

In the Arrival battery module 100, cells (166, 181) are connected in series, each with a ‘double throw’ switch, controlled by a switchable signal. When the signal is high, the switch closes the circuit through the cell, connecting the cell in series. When the signal is low, the switch opens on the cell closing the bypass loop and isolating the cell. By varying the duty of each cell (the ratio of time each cell is in use compared to the time the cell is in bypass), this technique can be used to balance the charge between cells. For example, cells with a higher state of charge (SOC) can be used for a greater portion of time than cells with lower SOC; bringing all cells closer to equilibrium. This same technique can be used to take care of cells with lower state of health (SOH) or which have a higher temperature.

We can Generalise as Follows:

1: A vehicle battery module configured to operate as part of a battery pack that includes multiple, identical such battery modules, in which each battery module (i) includes rechargeable cells configured to generate, at a pair of output terminals, an output voltage, and where at least some of the cells are connectable in series to form a string of cells, and the battery module includes a switch that is configured to either connect two or more cells in series or to bypass those cells.

2: A vehicle including a battery module, module configured to operate as part of a battery pack that includes multiple, identical such battery modules, in which each battery module (i) includes rechargeable cells configured to generate, at a pair of output terminals, an output voltage, and where at least some of the cells are connectable in series to form a string of cells, and a switch that is configured to either connect one or more cells in series or to bypass those cells.

3: A fleet of vehicles, in which each vehicle includes a battery module configured to operate as part of a battery pack that includes multiple, identical such battery modules, in which each battery module (i) includes rechargeable cells configured to generate, at a pair of output terminals, an output voltage, and where at least some of the cells are connectable in series to form a string of cells, and a switch that is configured to either connect one or more cells in series or to bypass those cells;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module is configured to generate an output voltage of at least 300V nominal.
The switch is configured to either connect one or more groups of parallel connected cells into the string or to bypass those parallel connected cells.
The bypass switch operates to change the voltage that is output by each string of cells.
The bypass switch operates to change the voltage that is output by each string of cells, for load balancing between strings.
The bypass switch operates to change the voltage that is output by each string of cells, to provide redundancy within a string.
The bypass switch operates to change the voltage that is output by each string of cells, to shape the output voltage.
The bypass switch operates to match cell string capacity for optimal charging.
By varying the duty of each cell, namely the ratio of time each cell is in use compared to the time the cell is in bypass, the bypass switch is used to balance the charge between cells.
The bypass switch operates so that cells with a higher state of charge (SOC) are used for a greater portion of time than cells with lower SOC, bringing all cells closer to equilibrium.
The bypass switch operates so that cells with lower state of health (SOH) are used for a lesser portion of time than cells with a higher SOC.
The bypass switch operates so that cells with a higher temperature are used for a lesser portion of time than cells with a lower temperature.
Each switch includes a microcontroller, and each microcontroller is configured to report to an internal performance monitoring and management sub-system in the battery module that is configured to autonomously manage the battery module.
Array is a 102S2P array and there are 100 switches.
each switch measures the voltage and current delivered by its associated pair of cells.
each switch measures or calculates the temperature of its associated pair of cells.
each switch is a pair of P and N channel transistors.
each switch is implemented or formed on a printed circuit board (PCB) power conductor (see Feature 13 below).
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C, in particular Feature 10.
   The battery module includes one or more Feature or Sub-Feature disclosed by any of Features 13-16 of Group D.
   The battery module includes one or more Feature or Sub-Feature disclosed by any of Features 17-25 of Group E.

Feature 12. Battery Module with Layered Component Architecture

We have seen above that each Arrival battery module 100 is able to manage its internal operation independently of any control system external to the module. That requires various control components inside each module. In the Arrival battery module, we adopt a layer construction in which, sitting over the battery cells, are one or more separate full width layers with these components or systems. For example, there may be a single PCB layer 161 providing (i) power handling; (ii) cell balancing within each module; (iii) performance monitoring (voltage (including contactor weld detection), current and temp). By placing these components onto a layer 161, it becomes much easier to service or replace the battery module 100; the lid 110 is removed and that exposes the main PCB layer 161; individual components can then be readily tested, or replaced. Equally, the entire PCB layer 161 can be removed for testing or replacement with a new or upgraded PCB layer.

FIG. 1C shows the HVBM, indicated generally at 100, in an exploded view, exposing the layer structure: moving from the top down, there is a lid 110, a PCB 161, a dielectric separator 163, a balancing flex 164, an upper cell carrier 165, the Li-Ion cells 166, a lower cell carrier 167, and a base plate 133.

The layered component construction is also faster and easier to robotically assemble since all components can be vertically raised or lowered into the battery module as it is being constructed. Thus, the HVBM 100 is configured for robofacturing in a robotic production environment (e.g., a microfactory) 1000.

We can Generalise as Follows:

1: A vehicle battery module with a layer construction in which, sitting over battery cells, are one or more separate layers with components or systems that enable the battery module to manage its internal operation, each layer occupying substantially the entire width or cross-section area of the battery module.

2: A vehicle including a battery module with a layer construction in which, sitting over battery cells, are one or more separate layers with components or systems that enable the battery module to manage its internal operation, each layer occupying substantially the entire width or cross-section area of the battery module.

3: A fleet of vehicles, in which each vehicle includes a battery module with a layer construction in which, sitting over battery cells, are one or more separate layers with components or systems that enable the battery module to manage its internal operation, each layer occupying substantially the entire width or cross-section area of the battery module and in which an operator of the fleet has defined one or more sets of performance and range requirements it has for the vehicles in the fleet, and those requirements have been used when selecting the number of battery modules to be included in each vehicle in the fleet.

Optional Sub-Features Include:
There is a single PCB layer including all components for (i) a power handling PCB; (ii) a cell balancing PCB; (iii) a performance monitoring (voltage (incl contactor weld detection), current and temp) PCB.
The single PCB layer is immediately underneath the lid of the battery module.
At least one layer in the battery module includes (i) a power handling PCB; (ii) a cell balancing PCB; and (iii) a performance monitoring PCB (voltage (incl contactor weld detection), current and temp).
There are several layers over which are distributed (i) a power handling PCB; (ii) a cell balancing PCB; (iii) a performance monitoring (voltage (incl contactor weld detection), current and temp) PCB.
Layer construction enables or facilitates vertical robotic assembly of the battery.
Layer construction enables or facilitates separation of different functions into different layers.
The layered architecture facilitates not only initial manufacture of the battery module, but also later removal of layers and upgrades with enhanced layers.
Layer construction enables a specific layer to be replaced with a new layer including updated or improved components, firmware, software, performance and/or features.
Layer construction enables a specific layer to be replaced with a new layer that provides one or more of the following: increased charging speed, reduced battery cell ageing, better call balancing, better cell monitoring or other improved battery management features.
Layer construction enables some or all battery cells to be removed from the battery module and replaced with new battery cells.
Each battery module includes a main PCB that forms one complete layer, occupying substantially the entire internal cross-section of a battery module, and that can be lowered vertically into the battery module.
The main PCB is grounded to the battery module base plate.
voltage measurements are in an additional PCB layer, either on a reverse side of a power flex PCB or a separate flex PCB.
Each string has cells or group of parallel connected cells connected in series and the measurement PCB provides a voltage measurement connection across each cell or group of cell.
The battery module has no functionality and is open circuit when no LV power is applied by an external BMS to a control board in the battery module.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C, in particular Feature 10.
   The battery module includes one or more Feature or Sub-Feature disclosed by any of Features 13-16 of Group D.
   The battery module includes one or more Feature or Sub-Feature disclosed by any of Features 17-25 of Group E.

Group D: Battery Module and the Complete Power System, Including BMS and the Battery Pack

Feature 13. Battery Module with Flex™ PCB Power Cable

Because each HVBM 100 outputs at least 300V nominal, it is possible to connect all HVBMs together, and also all HVBMs directly to the main DC power bus, using a light weight, low profile, printed circuit board (PCB) type electrical connector 300. Because each HVBM 100 outputs at least 300V, the current supplied by each HVBM 100 is much lower than the current that would be supplied by a conventional battery module, generating say 50V or 70V.

Consequently, the parallel electrical connections between HVBMs 100 carry much lower current than would flow between conventional, series connected modules generating say 50V or 70V. This opens up the possibility of using light weight, low profile, printed circuit board (PCB) type electrical connector 300; these would be unsuitable for the levels of current delivered by conventional modules; instead, conventional modules are typically connected using bulky and heavy cable harnesses.

PCB connectors offer significant advantages over conventional cable harnesses in terms of packaging, weight and design freedom: We refer to the PCB power connector used in the Arrival system as the Flex™ connector 300. Flex connectors 300 can be used not just to connect HVBMs 100 together and for the DC power bus, but can also be used inside a HVBM 100 to connect cells to each other, provided by one or more layer (161, 163, 164). Thus, the functionality of a connection board 160a, a HV board 160b, and the control board 160c is conferred by one or more layer of the HVBM 100. Advantageously, because Flex PCB (300, 161, 163, 134) connectors have a large flat surface, they can be readily gripped by robotic grippers and, because they are flexible, they can be positioned and fixed in place robotically.

FIG. 4A is a top-down view of the end of a Flex connector that connected to an HVBM. The Flex connector, indicated generally at 300, includes a pair of printed high voltage conductors 320, a data connection path (330, 340), and a low profile, standardised electrical interface 310 to the HVBM.

FIG. 2C shows this PCB connector 300 mounted on an HVBM 100; four additional PCB connectors, from parallel connected HVBMs, are shown laid on top of HVBM 100. The five Flex connectors terminate in connections 350 to the HV bus at one end, and at their other end at an HVBM at standardised interface 310.

FIG. 2B is a top down view of this entire group of five parallel connected HVBMs, showing how each of the five separate Flex PCB conductors 300 are connected to a single HVBM 100, and the entire high voltage connection is laid over the top of the five HVBMs 100. The shape of each Flex connector 300 can be seen to be the same, the only difference being in their length; this simplifies Flex production, logistics and handling. FIG. 2A is a perspective view of this arrangement, showing how low profile the PCB conductors are.

We can Generalise as Follows:

1: A battery module for a vehicle, the battery module configured to operate as part of a battery pack that includes a number of battery modules, and to deliver power over a substantially low profile, printed circuit board (PCB) flexible electrical conductor.

2: A battery pack formed from a number of battery modules, each battery module being configured to deliver power over a substantially low profile, printed circuit board (PCB) flexible electrical conductor.

3: A vehicle including a battery module configured to operate as part of a battery pack that includes a number of battery modules, each battery module being configured to deliver power over a substantially low profile, printed circuit board (PCB) flexible electrical conductor.

4: A fleet of vehicles, in which each vehicle includes a battery module configured to operate as part of a battery pack that includes a number of battery modules, each battery module being configured to deliver power over a substantially low profile, printed circuit board (PCB) flexible electrical conductor;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module includes rechargeable cells configured to generate, at a pair of output terminals, at least 300V nominal.
The PCB conductor is configured to electrically connect multiple battery modules in a parallel network.
Each battery module of the battery pack is substantially similar to the other battery modules.
The PCB conductor is configured to electrically connect multiple battery modules directly into a DC power bus.
Each battery module is configured to deliver HV output directly into the HV power bus without any PDU.
A high voltage DC power bus is made using the substantially low profile, flexible PCB conductor.
The conductor is a PCB conductor with substantially flat sections.
The conductor is a PCB conductor with sections that are folded to accommodate available space.
Two or more of power, signal, data, low voltage power are combined on a shared PCB substrate.
The PCB conductor includes one or more of: splicing, bus, and daisy chain configurations.
The PCB conductor includes one or more of: integrated or embedded sensors, devices, laminated bus bars and connectors.
The PCB conductor includes one or more of: selective shielding, reinforcement, and bonding.
The PCB conductor includes selective shielding using silver polymer screens encapsulated with a screen-printed or photo-imagable covercoat.
The PCB conductor includes selective shielding using a layer of copper.
The PCB conductor includes selective shielding using copper layers etched in a cross hatch pattern.
The PCB conductor includes bonded rigid layers configured to provide additional support.
The PCB conductor includes a thermally conductive heat sink.
The PCB conductor is configured for robotic handling.
The PCB conductor is configured for robotic handling by including stiffening support layers.
The PCB conductor is configured for robotic handling by including flat external surfaces that are configured to be gripped by a robotic end effector.
The PCB conductor includes connector boots, sealing, and/or strain relief using low pressure moulding (such as of thermoplastic elastomers, TPE), compression moulding (eg silicone rubber), injection (e.g. liquid silicone rubber) or cold cast (for example two part resin).
The PCB conductor includes a connector that forms one half or side of a card edge connector.
The PCB conductor integrates a voltage measurement system in an additional PCB layer, either on a reverse side of the PCB conductor or a separate PCB conductor.
Cells in the module are electrically connected using a flexible PCB conductor.
Cells are electrically connected using a flexible PCB connection into their series/parallel connection, such as a 102S2P arrangement.
Each string has cells or group of parallel connected cells connected in series and a measurement PCB provides a voltage measurement connection across each cell or group of cell.
Battery module includes a PCB or PCB part between cell pairs that is responsible for cell balancing and is directly connected to the main PCB in the module.
Battery module includes a housing, shell or lid that is shaped to receive the flexible PCB conductor at one or more recess in the housing, shell or lid.
The one or more recess includes a terminal configured to be connected to a corresponding terminal of the PCB conductor.
The one or more recess is positioned along one side of the module, so that the flexible PCB conductor is distant from any corner of the module, which could otherwise damage the flexible PCB conductor.
The battery module has no functionality and is open circuit when no LV power is applied by an external BMS to a control board in the battery module.
The battery module is connected to a BMS and other battery modules on a communication channel.
The battery module includes a cell balancing system.
The battery module includes a pre-charge circuit which is activated prior to connecting to a HV bus to prevent a potentially dangerous current inrush.
The battery module includes an internal current sensor.
The battery module includes an internal current sensor configured to enable protection against over currents.
The battery module includes anti propagation materials between cells.
The battery module includes anti propagation materials above cells.
The battery module includes an internal gas sensor to detect if gas is released from a cell.
The battery module includes an internal contactor health monitoring system.
The battery module includes an internal isolation monitoring system.
The battery module includes a HVIL (high voltage interlock) system.
The battery module includes a low voltage power monitoring system.
The battery module includes an internal short circuit protection fuse.
The battery module is configured to operate with a sleep mode in which it is disconnected from supplying power but monitors only for an external wake up signal.
The battery module is configured to operate with a power saving mode in which it is disconnected from supplying power but monitors for switch requests and provides status information.
The battery module is configured with multiple, redundant networking capability.
The battery module is configured to be connected directly or indirectly to a cloud-based system.
The battery module is configured for OTA software updates.
The battery module is configured for continuous or 24/7 cell monitoring.
The battery module is configured to automatically detect when a cell or cells disconnect from an internal circuit.
The battery module is configured with a MCU-based cell monitoring and cell balancing system.
The battery module is configured to estimate the degradation level of individual cells.
The battery module is configured to enable prediction of short-term and long-term battery performance prediction.
The battery module is configured with operational modes that differentially balance cell degradation and battery module performance.
The battery module includes a wireless connectivity system.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery pack comprises an array of battery modules arranged as a grid, and the number of battery modules used in the array is selected to give the required range or capacity for the pack.
The battery pack comprises one or more printed circuit board (PCB) flexible electrical conductor configured to connect the battery modules.
The length of the grid of battery modules is selected to give the required range or capacity for the pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 14. Battery Module that Delivers HV Direct to the HV Bus

We have seen above how each individual battery module 100 can output high voltage (HV) at the voltage magnitude used in a system powered by the battery module, e.g. each outputs current at between 350V and 450V for a 400V typical automotive traction system. Consequently, each battery module 100 can be connected directly to the 400V DC power bus. Power distribution to the DC bus can be over the Flex connection 300 described earlier.

We can Generalise as Follows:

1: A vehicle battery module configured to deliver HV output directly into the HV power bus of a vehicle.

2: A vehicle including a battery module configured to delivers HV output directly into the HV power bus of a vehicle.

3: A fleet of vehicles, in which each vehicle includes a battery module configured to delivers HV output directly into the HV power bus of a vehicle;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
Each battery module is configured to deliver HV output directly into the HV power bus over a substantially low profile, flexible PCB electrical conductor.
No PDU (power distribution unit) is used.
The flexible PCB electrical conductor is as defined above (see Feature 13).
The battery module has no functionality and is open circuit when no LV power is applied by an external BMS to a control board in the battery module.
The battery module is connected to a BMS and other battery modules on a communication channel.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D, in particular Feature 13.
   The battery module includes one or more Feature or Sub-Feature disclosed by any of Features 17-25 of Group E.

Feature 15. Battery Module that Connects to Integrated Power Cables

We have described the Flex connector 300 being formed on a flexible substrate; this is possible using continuous reel to reel production, which enables the Flex connector 300 to be laid over battery modules 100 and folded around corners etc. It is also possible to add the electrical conduction paths (for HV power, data, as well as low voltage) not to a conventional PCB substrate but instead directly to a component or other structure that has a purpose in addition to conducting power, such as a structural component or panel. Hence, for example, a bus might include an array of these panels 300 running along the entire length of both the outside and internal sides, just below the roof. Power and data for these LCD panels could be delivered using separate Flex connectors 300 running along and up the side body panels. But alternatively, the body panels themselves could include integrated power and data tracks, for example printed directly on to the interior surface of the body panels.

We can Generalise as Follows:

1: A vehicle battery module configured to electrically engage with a conductor that is integrated into a vehicle component or other vehicle structure that has a purpose in addition to conducting power, such as a structural component or panel.

2: A vehicle component, such as a panel, chassis or other structure or sub-structure, including an integrated high voltage power conductor track or system, arranged to transfer power from one or more battery modules in the vehicle to one or more motors or other vehicle systems.

3: A vehicle including a battery module or other component configured to electrically engage with a conductor that is integrated into a vehicle component or other vehicle structure that has a purpose in addition to conducting power, such as a structural component or panel.

4: A fleet of vehicles, in which each vehicle includes a battery module or other component configured to electrically engage with a conductor that is integrated into a vehicle component or other vehicle structure that has a purpose in addition to conducting power, such as a structural component or panel;
and in which an operator of the fleet has defined one or more sets of performance and range requirements it has for the vehicles in the fleet, and those requirements have been used when selecting the number of battery modules and/or the other components to be included in each vehicle in the fleet.

Optional Sub-Features Include:
The integrated high voltage power conductor track or system is a substantially low profile, flexible PCB electrical conductor.
The flexible PCB electrical conductor is as defined above (see Feature 14).
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D, in particular selected from Feature 13 or Feature 14.
   The battery module includes one or more Feature or Sub-Feature disclosed by any of Features 17-25 of Group E.

Feature 16. Battery Pack Including Battery Modules and BMS

The Arrival battery pack 200 includes a battery management system that is distributed across each individual battery module (100, 161) and is also in a master BMS 500 that is external to all battery modules. Each individual battery module is able to galvanically isolate itself 187, and the master BMS 500 is also able to independently galvanically isolate any battery module. This approach increases the safety of the overall battery pack 200.

We can generalise as follows:

1: A battery pack comprising multiple battery modules, where the battery pack is configured to be assembled from multiple parallel connected battery modules; and a battery management system that is distributed across each individual battery module and is also in a master BMS that is external to all battery modules, so that each individual battery module is able to galvanically isolate itself, and the master BMS is also able to independently galvanically isolate any battery module.

2: A vehicle including a battery pack comprising multiple battery modules, where the battery pack is configured to be assembled from multiple parallel connected self-contained battery modules;
and a battery management system that is distributed across each individual battery module and is also in a master BMS that is external to all battery modules, so that each individual battery module is able to galvanically isolate itself, and the master BMS is also able to independently galvanically isolate any battery module.

3: A fleet of vehicles, in which each vehicle includes a battery pack comprising multiple battery modules, where the battery pack is configured to be assembled from multiple parallel connected self-contained battery modules;
and a battery management system that is distributed across each individual battery module and is also in a master BMS that is external to all battery modules, so that each individual battery module is able to galvanically isolate itself, and the master BMS is also able to independently galvanically isolate any battery module;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
Battery pack is configured to be assembled from multiple parallel connected self-contained or independent battery modules.
Battery pack is a grid of battery modules in any of the following arrangements: 1×2, 1×3, 1×4 . . . 1×N; 2×2, 2×3, 2×4 . . . 2×N, N×M, where N and M are integers from 2 to 50.
Battery pack capacity can be optimised for vehicle range, cost and lifetime by selecting an appropriate number of self-contained battery modules to include in the battery pack.
Battery pack is configured to enable individual battery modules to be removed and replaced in normal use (e.g. if faulty; or to upgrade components).
Battery pack is configured to enable individual battery modules to be added to the battery pack, e.g. to increase range.
Battery pack is configured to be extensible, in that additional battery modules can be added to the battery pack and these battery modules will then automatically work, e.g. by establishing communication with a BMS.
Battery modules are each connected in parallel and each provide the working voltage of the vehicle, so that range, power and rate can be varied by varying the number of parallel connected battery modules.
Each module is configured to generate a high voltage output at a voltage magnitude that is used in a system powered by the module and that is at least 300V nominal.
Battery pack is a scalable and highly redundant distributed system made up of multiple battery modules, where a battery module can be added or removed for different capacity battery packs, so that battery pack capacity can be optimised for range, cost and lifetime simply be connecting more of fewer battery modules in parallel.
Each battery module is controlled with just a single master BMS (MBMS or BMS) that controls all battery modules in a battery pack, in a low-cost, reliable way and so that each battery module can provide power selectively in order to optimise overall battery pack power output, thermal management and module longevity.
The BMS is the interface from the battery pack to the rest of the vehicle and automatically discovers and manages connected battery modules.
The BMS operates completely independently from battery modules in the network and uses a separate CAN Network for communicating with the EVC and the battery modules, gathers information and data from the battery modules to compute battery level status and the BMS monitors the battery module connectors status using HVIL loop(s).
The BMS is a 100×200 mm grid sized component (8×CAN networks for up to 72 battery modules (more with CAN-FD).
BMS is configured to provide low voltage power control for battery modules.
BMS is configured to communicate with an isolation monitor.
BMS has automatic module discovery and management.
BMS is configured for analysis for state of charge and available power.
BMS includes an Ethernet/CAN vehicle network interface and gateway.
BMS includes an Ethernet vehicle network interface and gateway.
BBMS includes an accelerometer.
BMS is configured to manage over the air updates for battery modules.
BMS is black in colour for effective and predictable heat dissipation.
BMS is configured to report the High Level Status Functions values (HLSF) of the aggregated battery pack as follows:
   Available power in charge in kW (e.g. every second).
   Available power in discharge in kW (e.g. every second).
   SOC in % (e.g. every second).
   NAC—Number actively connected modules to the network (contactors and MOSFET enabled) (e.g. every second).
   SOA status including: safety flag level (Normal Operation, Caution, Warning, Safety Critical) (e.g. every second).
   Min/max range (e.g. every second).
   The BMS is configured to broadcast the connector locking status of all the battery modules on the network, providing the battery module number and the connector status (0 for disengaged or 1 for engaged) accordingly.
   The BMS is configured to broadcast the state of health of the aggregated pack, for energy (SOHE) in % and for power (SOUP) in %, regularly. For example, every 10 min or every time the value changes by more than a set amount, e.g. 1%, compared to the previously broadcasted value, whichever of the two happens first.
The battery module has no functionality and is open circuit when no LV power is applied by an external BMS to a control board in the battery module.
The battery module is connected to a BMS and other battery modules on a communication channel.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery pack comprises an array of battery modules arranged as a grid, and the number of battery modules used in the array is selected to give the required range or capacity for the pack.
The length of the grid of battery modules is selected to give the required range or capacity for the pack.
The battery pack is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D, in particular Feature 13.
   The battery module includes one or more Feature or Sub-Feature disclosed by any of Features 17-25 of Group E.

Group E: Battery Module Operational Features

Feature 17. Battery Module Implementing Plug and Play Software Components

The modular software components described in Section B of PCT/GB2021/051519 are deployed to the vehicle ECUs. But in addition, the same software modularity approach can be used in other vehicle hardware devices, including in a battery module 100.

We can Generalise as Follows:

1: A vehicle battery module, configured to operate as part of a battery pack that includes multiple, identical such battery modules, in which each battery module is provisioned with modular software components that monitor and control battery systems, and the modular software components include (i) an application layer and (ii) a basic software layer, or middleware layer, that insulates or separates the application layer from hardware specific features of the battery module and presents a standardised interface to the application layer.

2: A vehicle including a battery module configured to operate as part of a battery pack that includes multiple, identical such battery modules, in which each battery module is provisioned with modular software components that monitor and control battery systems, and the modular software components include (i) an application layer and (ii) a basic software layer, or middleware layer, that insulates or separates the application layer from hardware specific features of the battery module and presents a standardised interface to the application layer.

3: A fleet of vehicles, in which each vehicle includes a battery module configured to operate as part of a battery pack that includes multiple, identical such battery modules, in which each battery module is provisioned with modular software components that monitor and control battery systems, and the modular software components include (i) an application layer and (ii) a basic software layer, or middleware layer, that insulates or separates the application layer from hardware specific features of the battery module and presents a standardised interface to the application layer;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module has no functionality and is open circuit when no LV power is applied by an external BMS to a control board in the battery module.
The battery module is connected to a BMS and other battery modules on a communication channel.
The battery module includes a cell balancing system.
The battery module includes a pre-charge circuit which is activated prior to connecting to a HV bus to prevent a potentially dangerous current inrush.
The battery module includes an internal current sensor.
The battery module includes an internal current sensor configured to enable protection against over currents.
The battery module includes anti propagation materials between cells.
The battery module includes anti propagation materials above cells.
The battery module includes an internal gas sensor to detect if gas is released from a cell.
The battery module includes an internal contactor health monitoring system.
The battery module includes an internal isolation monitoring system.
The battery module includes a HVIL (high voltage interlock) system.
The battery module includes a low voltage power monitoring system.
The battery module includes an internal short circuit protection fuse.
The battery module is configured to operate with a sleep mode in which it is disconnected from supplying power but monitors only for an external wake up signal.
The battery module is configured to operate with a power saving mode in which it is disconnected from supplying power but monitors for switch requests and provides status information.
The battery module is configured with multiple, redundant networking capability.
The battery module is configured to be connected directly or indirectly to a cloud-based system.
The battery module is configured for OTA software updates.
The battery module is configured for continuous or 24/7 cell monitoring.
The battery module is configured to automatically detect when a cell or cells disconnect from an internal circuit.
The battery module is configured with a MCU-based cell monitoring and cell balancing system.
The battery module is configured to estimate the degradation level of individual cells.
The battery module is configured to enable prediction of short-term and long-term battery performance prediction.
The battery module is configured with operational modes that differentially balance cell degradation and battery module performance.
The battery module includes a wireless connectivity system.
The battery module is configured to enable modular, scalable, decentralised battery pack design.
The battery module is configured to enable a battery pack for a specific vehicle or fleet of vehicles to be optimised across factors including one or more of: initial cost, residual value, total cost of ownership, range, performance, recharging costs, recharging times.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery pack comprises an array of battery modules arranged as a grid, and the number of battery modules used in the array is selected to give the required range or capacity for the pack.
The length of the grid of battery modules is selected to give the required range or capacity for the battery pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 18. Battery Module with Decentralised Autonomy, Operating in a Distributed Architecture

The general principle of decentralised autonomy is described in detail by Section B of PCT/GB2021/051519, and also in relation to vehicle ECUs. This general principle of decentralised autonomy also applies to other vehicle hardware devices, including in a battery module 100.

We can Generalise as Follows:

1: A vehicle battery module, configured to operate as part of a battery pack that includes multiple, identical such battery modules, in which each battery module is provisioned with modular software components that monitor and control battery systems to enable the battery module to operate autonomously, and individual modular software components are configured to exchange data with modular software components on other battery modules to provide a distributed architecture.

2: A vehicle including a battery module configured to operate as part of a battery pack that includes multiple, identical such battery modules, in which each battery module is provisioned with modular software components that monitor and control battery systems to enable the battery module to operate autonomously, and individual modular software components are configured to exchange data with modular software components on other battery modules to provide a distributed architecture.

3: A fleet of vehicles, in which each vehicle includes a battery module configured to operate as part of a battery pack that includes multiple, identical such battery modules, in which each battery module is provisioned with modular software components that monitor and control battery systems to enable the battery module to operate autonomously, and individual modular software components are configured to exchange data with modular software components on other battery modules to provide a distributed architecture;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E, in particular Feature 17.

Feature 19 Battery Module with Performance Reporting

Decentralised autonomy for a hardware device (like an HVBM 100) can be based on an internal performance monitoring and management sub-system in the device that autonomously manages the device and reports data to an external monitoring system.

We can Generalise as Follows:

1: A battery module configured to operate as part of a battery pack that includes multiple, identical such battery modules, in which each battery module is part of a data-network that establishes a network of modules, and each battery module includes an internal performance monitoring and management sub-system that is configured to autonomously manage the battery module and reports data to an external BMS.

2: A vehicle including a battery module configured to operate as part of a battery pack that includes multiple, identical such battery modules, in which each battery module is part of a data-network that establishes a network of modules, and each battery module includes an internal performance monitoring and management sub-system that is configured to autonomously manage the battery module and reports data to an external BMS.

3: A fleet of vehicles, in which each vehicle includes a battery module configured to operate as part of a battery pack that includes multiple, identical such battery modules, in which each battery module is part of a data-network that establishes a network of modules, and each battery module includes an internal performance monitoring and management sub-system that is configured to autonomously manage the battery module and reports data to an external BMS;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The internal performance monitoring and management sub-system is configured to autonomously determine whether the module should deliver power or not.
The internal performance monitoring and management sub-system is configured to provide module performance data to the data network.
The internal performance monitoring and management sub-system is configured to measure or determine the cell charge/discharge state of all rechargeable cells in the module
The internal performance monitoring and management sub-system is configured to measure or determine the cell degradation of all rechargeable cells in the module.
The internal performance monitoring and management sub-system is configured to perform balancing across all rechargeable cells in the module.
The internal performance monitoring and management sub-system is configured to balance rechargeable cells inside the module independently of other modules to allow the battery to maintain optimal capacity throughout its life.
The internal performance monitoring and management sub-system is configured to control an internal fuse.
The internal performance monitoring and management sub-system is configured to independently monitor the electrical connection with the electrical load.
The internal performance monitoring and management sub-system is configured to detect whether any electrical faults have occurred.
The internal performance monitoring and management sub-system is configured to detect whether any electrical faults have occurred, and only to permit the module to deliver or receive power while it is functioning as expected.
The internal performance monitoring and management sub-system is implemented at least partly in software.
The internal performance monitoring and management sub-system is configured to report data to an external BMS over a standardised communications physical interface and standardised communications protocol.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E, in particular Feature 17.

Feature 20. Battery Module that Autonomously Negotiates with Other Battery Modules

Decentralised autonomy also applies to how battery modules 100 negotiate with other modules to determine power or performance compatibility.

We can Generalise as Follows:

1: A battery module configured to operate as part of a battery pack that includes multiple, identical such battery modules, in which each battery module is part of a data-connected network of modules, and each module is configured to autonomously negotiate with other modules to determine power or performance compatibility.

2: A vehicle including a battery module configured to operate as part of a battery pack that includes multiple, identical such battery modules, in which each battery module is part of a data-connected network of modules, and each module is configured to autonomously negotiate with other modules to determine power or performance compatibility.

3: A fleet of vehicles, in which each vehicle includes a battery module configured to operate as part of a battery pack that includes multiple, identical such battery modules, in which each battery module is part of a data-connected network of modules, and each module is configured to autonomously negotiate with other modules to determine power or performance compatibility;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
Each module is configured to autonomously negotiate with other modules over a standardised communications physical interface and standardised communications protocol.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E, in particular Feature 17.

Feature 21. Battery Module with Crypto-Network

Following Plug and Play principles (see Section B of PCT/GB2021/051519) of the Arrival system and components, once an Arrival component is plugged into an Arrival vehicle, device or system, it will start functioning easily and automatically without configuration or modification of the existing system. As mentioned above, this is fully applicable to an Arrival battery module 100 and its functioning once it is plugged into an Arrival vehicle 400. Cyber security requirements might conflict with providing Plug and Play functionality for vehicle components. The Arrival system envisages a unique approach to cyber security of Arrival vehicles and vehicle components (see Section C of PCT/GB2021/051519).

The conventional approach is based on a vehicle network being treated as a trusted environment, whilst everything outside the vehicle is treated as untrusted. The Arrival system, instead, treats the vehicle network as untrusted one. Thereby, all communications between components using the vehicle network are encrypted, and components do not accept commands from other components without verification or authentication. As a result, vehicles and vehicle components are prevented from an unauthorized use, and personal data as well as valuable analytics or diagnostics data of the vehicle are prevented from an unauthorized access.

We can Generalise as Follows:

1: A battery module configured to operate as part of a battery pack that includes multiple, identical such battery modules, in which each battery module is part of a data-connected network of modules configured for two-way verification or authentication, and where each module (i) is itself verified or authenticated, using a secure protocol, by a sub-system in the device that the battery module is installed in and (ii) each battery module verifies or authenticates a sub-system in the device that the battery module is installed in.

2: A vehicle including a battery module configured to operate as part of a battery pack that includes multiple, identical such battery modules, in which each battery module is part of a data-connected network of modules configured for two-way verification or authentication, and where each module (i) is itself verified or authenticated, using a secure protocol, by a sub-system in the device that the battery module is installed in and (ii) each battery module verifies or authenticates a sub-system in the device that the battery module is installed in.

3: A fleet of vehicles, in which each vehicle includes a battery module configured to operate as part of a battery pack that includes multiple, identical such battery modules, in which each battery module is part of a data-connected network of modules configured for two-way verification or authentication, and where each module (i) is itself verified or authenticated, using a secure protocol, by a sub-system in the device that the battery module is installed in and (ii) each battery module verifies or authenticates a sub-system in the device that the battery module is installed in;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
Each battery module is verified or authenticated by an authentication system external to the module before the battery module is permitted to be fully operational.
The authentication system external to the battery module is configured to check the status of safety or performance records for the vehicle or other environment before the battery module is permitted to be fully operational.
Each module is configured to be verified or authenticated by an authentication system internal to the module before the battery module is permitted to be fully operational.
Verification or authentication uses a secure two-way handshake.
Verification or authentication disables the battery module in the event of removal from intended installation, such as specific vehicle.
Verification or authentication prevents the battery module from being used as power source in unauthorised applications/installations.
Verification or authentication protects against the battery module being charged from unknown sources.
Verification or authentication enables battery remote disablement. For example, theft immobiliser or product safety recall.
Verification or authentication enables the enforcement of subscription/rental/leasing of the battery module.
Verification or authentication enables a timed ‘shelf life’ expiration or cycle based ‘end of life’ control.
There is a mutual 2-way authentication in which the HVBM (i) is itself authenticated by something external to the HVBM (e.g. the vehicle asks whether this HVBM is known and safe to work with) and the HVBM (ii) authenticates the system it is installed in (e.g. the HVBM asks whether the other modules/rest of vehicle is known and safe to work with).
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E, in particular Feature 17.

And we can Generalise Further as Follows:

1: A vehicle component configured to operate on a vehicle data network, and where the component treats the vehicle data network as an untrusted one and all communications from and to the component using the vehicle network are encrypted, and the component does not accept commands from other components without verification or authentication.

2: A vehicle including a component configured to operate on a vehicle data network, and where the component treats the vehicle data network as an untrusted one and all communications from and to the component using the vehicle network are encrypted, and the component does not accept commands from other components without verification or authentication.

Optional Sub-Features Include:
The vehicle is configured to be connected to a remote or cloud-based system.
The component, vehicle and cloud-based system each comprise an input/output unit (I/O), a memory, and a control, each of which is configured to communicate via a bus.
The component is a HVBM.
The component memory stores identity information including one or more of: a unique name; configuration information; blockchain data.
the component memory stores an indication of whether that component is authorised to be used by a specific vehicle.
The cloud-based system stores a record of which components are authorised to be used, e.g authorised to be used by a specific vehicle.
The component is configured to determine if it is authorised for use on a specific vehicle, e.g a specific vehicle in which it is installed, by itself checking the data held on the cloud-based system.
The cloud-based system is configured to determine if a component is authorised for use on a specific vehicle, by checking the data held on the cloud-based system and sending an authorisation signal to the component if it is authorised, and sending a non-authorisation signal if it is not authorised.
The component is configured to determine the level of functionality it will provide to the vehicle.
The component is configured to determine the level of functionality it will provide, based on a confidence or trust level it determines.
The component is configured to determine the level of functionality it will provide, based on a confidence or trust level related to the operation or environment of the vehicle.
The level of functionality includes operation of the component being completely prevented; operation of the component being reduced; an alarm being triggered allowing a remote user to intervene in operation of the vehicle or the component.
The component includes a hardware security module (HSM) for verification or authentication.
The component is subject to verification or authentication by one or more components in the vehicle and/or the cloud-based system and the outcome of that verification or authentication determines the level of functionality the component is permitted to provide to the vehicle.
The component is subject to verification or authentication by a distributed set of components in the vehicle and/or the cloud-based system, constituting an authentication base, and the outcome of that verification or authentication determines the level of functionality the component is permitted to provide to the vehicle.
The authentication base varies depending on the component being authenticated or verified.
The authentication base varies depending on the functionality of the component being activated.
A component is pre-configured or bound to a specific installation or vehicle and is automatically disabled in the event of removal from intended installation or vehicle.
The component includes one or more Feature or Sub-Feature disclosed by the remainder of this document (e.g., selected from any of Groups A-E). In particular, disclosure is provided that:
   The component includes one or more Feature or Sub-Feature disclosed by any of Features 1-2 of Group A.
   The component includes one or more Feature or Sub-Feature disclosed by any of Features 3-9 of Group B.
   The component includes one or more Feature or Sub-Feature disclosed by any of Features 10-12 of Group C.
   The component includes one or more Feature or Sub-Feature disclosed by any of Features 13-16 of Group D.
   The component includes one or more Feature or Sub-Feature disclosed by any of Features 17-25 of Group E.

Feature 22. Battery Module that Self-Initialises

Another facet of decentralised autonomy is that components, like battery modules 100, must form part of the vehicle data network so that they can send and receive data across that network. Instead of passively configuring or initialising when instructed to do so by an external device, each battery module 100 instead autonomously self-initialises to operate on the network.

We can Generalise as Follows:

1: A vehicle battery module configured to operate as part of a battery pack that includes multiple, identical such battery modules, in which each battery module is part of a data-connected network of vehicle battery modules, and in which each battery module configures itself or otherwise self-initialises to operate with the network when it is added to the network or is turned on.

2: A vehicle including a battery module configured to operate as part of a battery pack that includes multiple, identical such battery modules, in which each battery module is part of a data-connected network of vehicle battery modules, and in which each battery module configures itself or otherwise self-initialises to operate with the network when it is added to the network or is turned on.

3: A fleet of vehicles, in which each vehicle includes a battery module configured to operate as part of a battery pack that includes multiple, identical such battery modules, in which each battery module is part of a data-connected network of vehicle battery modules, and in which each battery module configures itself or otherwise self-initialises to operate with the network when it is added to the network or is turned on;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module is configured to send data over the network declaring it has configured itself to the network or has otherwise self-initialised, and does so over a standardised communications physical interface and standardised communications protocol.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E, in particular Feature 17.

Feature 23: Battery Module with Ambient Pressure Equalisation Vent

Each battery module 100 includes at least one air pressure vent that ensures that the air pressure inside the battery module can rapidly equalise to ambient air pressure; hence changes in ambient air pressure that arise in normal use, for example associated with changes in ambient air temperature, or environmental factors, such as changes in altitude or entering or exiting a tunnel, do not lead to damage to the battery module, such as damage to environmental seals that may occur if the pressure differential between air pressure internal to the module and ambient exceeds a threshold.

The air vent is made from an air permeable, oleophobic membrane that also keeps water, dust and dirt out of the battery module and preserves the IP 65 ingress protection rating of the sealed battery module and hence protects the sensitive electronics inside the battery module; Gove Vent PolyVent AS 200 is suitable. The air pressure equalisation vent can be positioned in a side wall of the battery module, typically below one of the main PCBs and above, and in between the cell contactors. A second air pressure equalisation vent can be positioned in the battery module lid 110.

We can Generalise as Follows:

1: A battery module with ingress protection of at least IP 65, in which the battery module includes an air pressure equalisation vent configured to enable air pressure equalisation inside the module to ambient or external air pressure whilst maintaining ingress protection.

2: A vehicle including a battery module with ingress protection of at least IP 65, in which the module includes an air pressure equalisation vent configured to enable air pressure equalisation inside the module to ambient or external air pressure.

3: A fleet of vehicles, in which each vehicle includes a battery module with ingress protection of at least IP 65, in which the module includes an air pressure equalisation vent configured to enable air pressure equalisation inside the module to ambient or external air pressure;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The air pressure equalisation vent is configured to enable air pressure equalisation during normal use, such as changes in ambient air pressure associated with changes in ambient air temperature, or environmental factors, such as changes in altitude or entering or exiting a tunnel.
The air pressure equalisation vent is an air permeable, oleophobic membrane that also keeps water, dust and dirt out of the battery module and preserves the IP 65 ingress protection rating.
The air pressure equalisation vent is positioned in a side wall of the battery module.
The air pressure equalisation vent is positioned in a lid of the battery module.
The battery module includes anti propagation materials between cells.
The battery module includes anti propagation materials above cells.
The battery module includes an internal gas sensor to detect if gas is released from a cell.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery pack comprises an array of battery modules arranged as a grid, and the number of battery modules used in the array is selected to give the required range or capacity for the pack.
The length of the grid of battery modules is selected to give the required range or capacity for the battery pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 24: Battery Module with Gas Escape Vents

In a serious failure of one or more cells (166, 181) in a battery module 100, gases can be released and can rapidly build to dangerous pressures; even where the battery module includes an ambient air pressure equalisation valve, gases can build to pressures that can ultimately cause the entire module to fail in an uncontrolled manner. To avoid this, each battery module lid 110 includes multiple small holes through which high pressure gases caused e.g. by cell failure can rapidly vent. A label 112 covers all of these holes to preserve the IP 65 ingress protection rating of the sealed battery module 100 in normal use and operation of the battery module. The label 12 is releasably secured to the lid 110, for example stuck to the lid with adhesive around its perimeter, so that the portion of the label lying directly over the gas escape vents has no adhesive. In the event of a failure leading to the build up of pressurised gases inside the module, the adhesive label 112 balloons outward over the gas escape vents, and this causes the adhesive to rapidly de-bond; the label 112 no longer covers the gas escape vents and hence gases can rapidly escape from the gas escape vents.

The battery module includes an internal gas sensor 182. Thus, in the event of gas being released, this gas is detected. This provides an opportunity for the failure to be mitigated, with the HVBM being automatically switched off, and a warning being automatically transmitted. battery module

We can Generalise as Follows:

1: A battery module with a case or lid that provides ingress protection of at least IP 65, in which the battery module includes gas escape vents in the case or lid, and in which one or more labels cover the gas escape vents in normal use, and the labels are configured to release to enable pressurised gases, arising from cell failure, inside the module to escape from the battery module.

2: A vehicle including a battery module with a case or lid that provides ingress protection of at least IP 65, in which the battery module includes gas escape vents in the case or lid, and in which one or more labels cover the gas escape vents in normal use, and the labels are configured to release to enable pressurised gases, arising from cell failure, inside the module to escape from the battery module.

3: A fleet of vehicles, in which each vehicle includes a battery module with a case or lid that provides ingress protection of at least IP 65, in which the battery module includes gas escape vents in the case or lid, and in which one or more labels cover the gas escape vents in normal use, and the labels are configured to release to enable pressurised gases, arising from cell failure, inside the module to escape from the battery module;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The label is configured to cover the gas escape vents during normal use and operation of the battery module to maintain IP 65 ingress protection.
The label is releasably secured to the case or lid.
The label is releasably secured to the case or lid using adhesive which is configured to de-bond in the event of pressurised gas being released.
The adhesive is applied to the perimeter of the label in a region not overlying any gas escape vents.
The gas escape vents are positioned in the case or lid of the battery module.
The gas escape vents are cylindrical holes running perpendicular to the main face of the case or lid.
The gas escape vents are formed in an array.
The gas escape vents are formed in an array and at least 2.5 mm of lid wall thickness separates each vent.
An air pressure equalisation vent is configured to enable air pressure equalisation during normal use, such as changes in ambient air pressure associated with changes in ambient air temperature, or environmental factors, such as changes in altitude or entering or exiting a tunnel.
The air pressure equalisation vent is an air permeable, oleophobic membrane that also keeps water, dust and dirt out of the battery module and preserves the IP 65 ingress protection rating.
The air pressure equalisation vent is positioned in a side wall of the battery module.
The air pressure equalisation vent is positioned in a case or lid of the battery module.
The battery module includes anti propagation materials between cells.
The battery module includes anti propagation materials above cells.
The battery module includes intumescent material on some or all of its internal surfaces.
The battery module includes an internal gas sensor to detect if gas is released from a cell.
The battery module includes multiple, individual rechargeable cells.
The rechargeable cells are cylindrical cells, pouch cells or prismatic cells.
The rechargeable cells are Li-ion or lithium polymer cells.
The rechargeable cells are solid state cells.
The battery pack comprises an array of battery modules arranged as a grid, and the number of battery modules used in the array is selected to give the required range or capacity for the pack.
The length of the grid of battery modules is selected to give the required range or capacity for the battery pack.
The grid is made up of a single layer of battery modules, or two or more layers of battery modules.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

Feature 25: Battery Module with Internal Monitoring or Control Systems

For some of the above features, the battery module 100 is disclosed as a high voltage (HV) module (e.g. delivering 300V+). For example, Feature 1 describes various features that make this form of high voltage module especially useful. Many of these features can be usefully used in battery modules 100 that are not high voltage modules as such, but more conventional modules outputting a voltage that is significantly less than 100V and hence have to be series connected with other similar modules to reach the typical 300V-400V operational voltage required for traction power in an electric vehicle 400.

In this Feature 25, we define those features that can be usefully deployed in a battery module that can form part of a decentralised battery pack architecture, i.e. an architecture in which there is an element (ranging from partial to complete) of monitoring and/or control distributed down to the battery module level.

We can Generalise as Follows:

1: A battery module configured to operate as part of a battery pack that includes multiple, identical such battery modules, in which each battery module (i) includes an array of rechargeable cells and also monitoring or control systems configured to enable the battery module to monitor or control itself, and (ii) is configured to be electrically connected in series and/or parallel to an array of further battery modules, to form a complete battery pack with a decentralised monitoring or control architecture.

2: A vehicle including a battery module configured to operate as part of a battery pack that includes multiple, identical such battery modules, in which each battery module (i) includes an array of rechargeable cells and also monitoring or control systems configured to enable the battery module to monitor or control itself, and (ii) is configured to be electrically connected in series and/or parallel to an array of further battery modules, to form a complete battery pack with a decentralised monitoring or control architecture.

3: A fleet of vehicles, in which each vehicle includes a battery module configured to operate as part of a battery pack that includes multiple, identical such battery modules, in which each battery module (i) includes an array of rechargeable cells and also monitoring or control systems configured to enable the battery module to monitor or control itself, and (ii) is configured to be electrically connected in series and/or parallel to an array of further battery modules, to form a complete battery pack with a decentralised monitoring or control architecture;
and in which an operator of the fleet has defined one or more sets of performance and range requirements it has for the vehicles in the fleet, and those requirements have been used when selecting the number of battery modules to be included in each vehicle in the fleet.

Optional Sub-Features Include:
The battery module includes an internal precharge capability.
The battery module includes a current sensor.
The battery module includes a current sensor and over current protection system.
The battery module includes a gas sensor.
The battery module includes a contactor health monitoring system.
The battery module includes a connector cap integrity monitoring system.
The battery module includes an isolation monitoring system.
The battery module includes a HVIL system.
The battery module includes a low voltage power monitoring system.
The battery module includes an internal short circuit protection fuse.
The battery module includes redundant networking capability.
The battery module is configured to be connected directly or indirectly to a cloud-based system.
The battery module is configured for OTA software updates.
The battery module is configured for continuous or 24/7 cell monitoring.
The battery module is configured to automatically detect when a cell or cells disconnect from an internal circuit.
The battery module is configured with a MCU-based cell monitoring and cell balancing system.
The battery module is configured to estimate the degradation level of individual cells.
The battery module is configured to enable prediction of short-term and long-term battery performance prediction.
The battery module is configured with operational modes that differentially balance cell degradation and battery module performance.
The battery module includes a wireless connectivity system.
The battery module includes one or more Feature or Sub-Feature disclosed by the remainder of this document (e.g., selected from any of Groups A-E). In particular, disclosure is provided that:
   The battery module includes one or more Feature or Sub-Feature disclosed by any of Features 1-2 of Group A.
   The battery module includes one or more Feature or Sub-Feature disclosed by any of Features 3-9 of Group B.
   The battery module includes one or more Feature or Sub-Feature disclosed by any of Features 10-12 of Group C.
   The battery module includes one or more Feature or Sub-Feature disclosed by any of Features 13-16 of Group D.
   The battery module includes one or more Feature or Sub-Feature disclosed by any of Features 17-25 of Group E.

1. A battery module for a vehicle, the battery module configured to operate as part of a battery pack that includes a number of battery modules, and to deliver power over a substantially low profile, printed circuit board (PCB) flexible electrical conductor.

2. The battery module according to claim 1, the vehicle battery module being configured to generate at least 300V output at maximum charge.

3. The battery module according to claim 1, the battery module being configured to be electrically connected in parallel with at least two other substantially similar battery modules to form the battery pack.

4. The battery module according to claim 1, wherein the battery module is configured:
to include an array of rechargeable cells and monitoring and control systems configured to enable the battery module to operate using autonomous monitoring and control; and
to be electrically connected to further battery modules, to form a complete battery pack.

5. The battery module according to claim 1, the battery module being configured to operate as part of a battery pack that includes multiple, identical such battery modules, in which each battery module has a size that conforms to a regular size interval scale and is part of a family of other types of components with sizing that also conforms to the same size interval scale.

6. The battery module according to claim 1, the battery module including multiple components configured for robotic installation or assembly into the device or system by virtue of being positioned in the device or system in a regular, rectilinear grid or installation pattern.

7. The battery module according to claim 1, the battery module being configured for robotic installation or assembly to the battery pack by virtue of having a shape that is optimised for robotic installation or assembly.

8. The battery module according to claim 1, the battery module including multiple cylindrical form-factor rechargeable cells, wherein the battery module includes a base on which the rechargeable cells are positioned, the base being configured to provide a structurally rigid support for the cells.

9. The battery module according to claim 8, the battery module being configured to provide thermal cooling for the cells.

10. The battery module according to claim 8, wherein all cells in the battery module are oriented with the same polarity orientation.

11. The battery module according to claim 1, wherein the battery module:
includes a single outer shell or lid that is configured to enclose an array of rechargeable cells and seal against a rigid base of the module, and
is configured to be electrically connected to further, substantially similar, battery modules, to form a complete battery pack.

12. The battery module according to claim 1, wherein the battery module is configured to be inserted, either individually or when part of a battery pack, into a void sitting over a substantially flat chassis base of the vehicle.

13. The battery module according to claim 1, wherein the battery module includes a number of rechargeable cells configured to generate, at a pair of output terminals, an output voltage.

14. The battery module according to claim 13, wherein the battery module includes an internal isolation switch system, configured to isolate all cells from one or both of the output terminals.

15. The battery module according to claim 13, wherein at least some of the cells are connectable in series to form a string of cells, and the module includes a switch that is configured to either connect two or more cells in series or to bypass those cells.

16. The battery module according to claim 1, wherein the battery module has a layer construction in which, sitting over battery cells, are one or more separate layers with components or systems that enable the battery module to manage its internal operation, each layer occupying substantially the entire width or cross-section area of the battery module.

17. The battery module according to claim 1, the battery module being configured to deliver high voltage output directly into the high voltage power bus of a vehicle.

18. The battery module according to claim 1, the battery module being configured to electrically engage with a conductor that is integrated into a vehicle component or other vehicle structure that has a purpose in addition to conducting power, such as a structural component or panel.

19. The battery module according to claim 1, the battery module being configured to operate as part of a battery pack that includes multiple, identical such battery modules, in which each battery module is provisioned with modular software components that monitor and control battery systems.

20. The battery module according to claim 19, wherein the modular software components include (i) an application layer and (ii) a basic software layer, or middleware layer, that insulates or separates the application layer from hardware specific features of the battery module and presents a standardised interface to the application layer.

21. The battery module according to claim 19, wherein the modular software components are configured to enable the battery module to operate autonomously, and individual modular software components are configured to exchange data with modular software components on other battery modules to provide a distributed architecture.

22. The battery module according to claim 1, wherein the battery module is part of a data-network that establishes a network of modules.

23. The battery module according to claim 22, wherein each battery module includes an internal performance monitoring and management sub-system that is configured to autonomously manage the battery module and reports data to an external BMS.

24. The battery module according to claim 22, wherein each module is configured to autonomously negotiate with other modules to determine power or performance compatibility.

25. The battery module according to claim 22, wherein the battery module configures itself or otherwise self-initialises to operate with the network when it is added to the network or is turned on.

26. The battery module according to claim 22, wherein each module (i) is itself verified or authenticated, using a secure protocol, by a sub-system in the device that the battery module is installed in and (ii) each battery module verifies or authenticates a sub-system in the device that the battery module is installed in.

27. The battery module according to claim 1, wherein the battery module is a vehicle component configured to operate on a vehicle data network, and where the component treats the vehicle data network as an untrusted one and all communications from and to the component using the vehicle network are encrypted, and the component does not accept commands from other components without verification or authentication.

28. The battery module according to claim 1, wherein the battery module is configured to have ingress protection of at least IP 65.

29. The battery module according to claim 28, the battery module including an air pressure equalisation vent configured to enable air pressure equalisation inside the module to ambient or external air pressure whilst maintaining ingress protection.

30. The battery module according to claim 28, the battery module including gas escape vents in the case or lid, and in which one or more labels cover the gas escape vents in normal use, and the labels are configured to release to enable pressurised gases, arising from cell failure, inside the module to escape from the battery module.

31. The battery module according to claim 1, wherein the battery module is configured to perform decentralised monitoring or control.

32. A battery pack comprising a number of battery modules, each battery module being configured to deliver power over a substantially low profile, printed circuit board (PCB) flexible electrical conductor.

33. The battery pack according to claim 32, wherein the battery pack comprises a number of battery modules that are connected in series and/or parallel.

34. The battery pack according to claim 32, the battery pack further including one or more printed circuit board (PCB) flexible electrical conductor configured to connect the battery modules.

35. The battery pack according to claim 32, the battery pack having a monitoring or control architecture that is decentralised over each of the number of battery modules.

36. The battery pack according to claim 32, the battery pack including a battery management system that is distributed across each individual battery module and is also in a master BMS that is external to all battery modules, so that each individual battery module is able to galvanically isolate itself, and the master BMS is also able to independently galvanically isolate any battery module.

37. The battery pack according to claim 32, the battery pack including multiple, identical battery modules, in which each battery module is configured for robotic installation or assembly to the battery pack by virtue of having a shape that is optimised for robotic installation or assembly.

38. A vehicle including a number of battery modules, each battery module being configured to deliver power over a substantially low profile, printed circuit board (PCB) flexible electrical conductor.

39. The vehicle according to claim 38, the number of battery modules being installed in a chassis of the vehicle.

40. The vehicle according to claim 39, the vehicle having a floor that is substantially low.

41. A fleet of vehicles, in which each vehicle includes a number of battery modules, each battery module being configured to deliver power over a substantially low profile, printed circuit board (PCB) flexible electrical conductor.

42. A fleet of vehicles according to claim 41, wherein an operator of the fleet has defined one or more sets of performance and range requirements it has for the vehicles in the fleet, and those requirements have been used when selecting the number of battery modules to be included in each vehicle in the fleet.
